(19) United States
(12) Patent Application Publication
(10) Pub. No.: US 2024/0337785 A1
(43) Pub. Date: Oct. 10, 2024

(54) SWITCHABLE STRUCTURED ILLUMINATION GENERATOR, LIGHT GUIDE DISPLAY SYSTEM WITH STRAY LIGHT REDUCTION, AND STRESS-NEUTRAL OPTICAL COATING

(71) Applicant: Meta Platforms Technologies, LLC, Menlo Park, CA (US)

(72) Inventor: Kai-Han CHANG, Troy, MI (US)

(21) Appl. No.: 18/607,458

(22) Filed: Mar. 16, 2024

Related U.S. Application Data
(60) Provisional application No. 63/494,100, filed on Apr. 4, 2023.

(51) Int. Cl. F21V 8/00; G02B 1/11; G02B 5/00; G02B 27/00

(52) U.S. Cl. CPC G02B 6/0055; G02B 1/11; G02B 5/003; G02B 6/0053; G02B 27/0093

(57) ABSTRACT

A device includes a light guide configured to guide a light to propagate inside the light guide via total internal reflection. The device also includes a reflective lens disposed at a first surface of the light guide. The device further includes a light absorption layer disposed at a second surface of the light guide that is non-parallel to the first surface. The device further includes an out-coupling element configured to couple a first portion of the light out of the light guide as one or more output lights, a second portion of the light that is not coupled out of the light guide becoming a stray light propagating inside the light guide toward the second surface. The reflective lens is configured to reflect the stray light toward the light absorption layer. The light absorption layer is configured to substantially absorb the stray light.

### CROSS REFERENCE TO RELATED APPLICATION

This application claims the benefit of priority to U.S. Provisional Application No. 63/494,100, filed on Apr. 4, 2023. The content of the above-referenced application is incorporated by reference in their entirety.

### TECHNICAL FIELD

The present disclosure relates generally to optical systems and, more specifically, to a switchable structured illumination generator, a light guide display system with stray light reduction, and a stress-neutral optical coating.

### BACKGROUND

Object tracking devices, such as devices for tracking eyes and/or faces, have been implemented in a variety of technical fields, e.g., near-eye displays (“NEDs”), head-up displays (“HUDs”), head-mounted displays (“HMDs”), smart phones, laptops, televisions, vehicles, etc. For example, object tracking devices have been implemented in augmented reality (“AR”), virtual reality (“VR”), and/or mixed reality (“MR”) applications. Through monitoring an eye, the surrounding region of the eye, and/or the face of a user, a three-dimensional (“3D”) head pose, facial expressions, pupil positions, and eye gazes of the user may be tracked in real time, which can be used for various purposes, including, for example, adjusting display of content to the user, monitoring user's attention, physical and/or psychological status, etc.

### SUMMARY OF THE DISCLOSURE

One aspect of the present disclosure provides a device that includes a light guide configured to guide a light to propagate inside the light guide via total internal reflection. The device also includes a reflective lens disposed at a first surface of the light guide. The device further includes a light absorption layer disposed at a second surface of the light guide that is non-parallel to the first surface. The device further includes an out-coupling element configured to couple a first portion of the light out of the light guide as one or more output lights, a second portion of the light that is not coupled out of the light guide becoming a stray light propagating inside the light guide toward the second surface. The reflective lens is configured to reflect the stray light toward the light absorption layer. The light absorption layer is configured to substantially absorb the stray light.

Another aspect of the present disclosure provides a device that includes a light guide configured to guide a light to propagate inside the light guide via total internal reflection, the light guide having a first surface and a second surface having a predetermined tilt angle with respect to the first surface. The device also includes an out-coupling element disposed at the first surface and configured to couple a first portion of the light out of the light guide as one or more output lights, wherein a second portion of the light that is not coupled out of the light guide is a stray light propagating inside the light guide toward the second surface. The device further includes an anti-reflection coating and a light absorption layer disposed at the second surface of the light guide. The anti-reflection coating is configured to substantially transmit the stray light toward the light absorption layer, and the light absorption layer is configured to substantially absorb the stray light received from the anti-reflection coating.

Other aspects of the present disclosure can be understood by those skilled in the art in light of the description, the claims, and the drawings of the present disclosure.

### BRIEF DESCRIPTION OF THE DRAWINGS

The following drawings are provided for illustrative purposes according to various disclosed embodiments and are not intended to limit the scope of the present disclosure.

FIGS. 1A and 1B illustrate schematic diagrams of a switchable structured illumination generator configured to provide various illumination patterns, according to an embodiment of the present disclosure;

FIGS. 2A-2D illustrate schematic diagrams of a switchable structured illumination generator configured to provide various illumination patterns, according to an embodiment of the present disclosure;

FIGS. 3A-3D illustrate schematic diagrams of a switchable structured illumination generator configured to provide various illumination patterns, according to an embodiment of the present disclosure;

FIG. 4 illustrates a schematic diagram of a switchable structured illumination generator configured to provide various illumination patterns, according to an embodiment of the present disclosure;

FIGS. 5A and 5B illustrate schematic diagrams of a switchable structured illumination generator configured to provide various illumination patterns, according to an embodiment of the present disclosure;

FIG. 6A illustrates a schematic diagram of an object tracking system, according to an embodiment of the present disclosure;

FIG. 6B illustrates a schematic diagram of an object tracking system, according to an embodiment of the present disclosure;

FIG. 7 illustrates a schematic diagram of a Pancharatnam-Berry phase (“PBP”) grating, according to an embodiment of the present disclosure;

FIG. 8A illustrates a schematic diagram of a polarization hologram, according to an embodiment of the present disclosure;

FIGS. 8B-8E schematically illustrate various diagrams of a portion of the polarization hologram shown in FIG. 8A, showing in-plane orientations of optically anisotropic molecules in the polarization hologram, according to various embodiments of the present disclosure;

FIGS. 8F and 8G schematically illustrate various diagrams of a portion of the polarization hologram shown in FIG. 8A, showing out-of-plane orientations of optically anisotropic molecules in the polarization hologram, according to various embodiments of the present disclosure;

FIG. 9A illustrates a schematic diagram of an artificial reality device, according to an embodiment of the present disclosure;

FIG. 9B schematically illustrates a cross-sectional view of half of the artificial reality device shown in FIG. 9A, according to an embodiment of the present disclosure;

FIG. 10A schematically illustrates a diagram of a conventional light guide display system;

FIG. 10B illustrates a diagram of an artificial reality device including the conventional light guide display shown in FIG. 10A;

FIGS. 11A and 11B illustrate schematic diagrams of a display system with stray light reduction and enhanced contrast ratio, according to an embodiment of the present disclosure;

FIGS. 12A and 12B illustrate schematic diagrams of a display system configured with stray light reduction and enhanced contrast ratio, according to an embodiment of the present disclosure;

FIG. 13A illustrates a schematic diagram of a display system configured with stray light reduction and enhanced contrast ratio, according to an embodiment of the present disclosure;

FIG. 13B illustrates a schematic diagram of a display system configured with stray light reduction and enhanced contrast ratio, according to an embodiment of the present disclosure;

FIG. 14A illustrates a three-dimensional (“3D”) view of a polarization volume hologram (“PVH”) element, according to an embodiment of the present disclosure;

FIGS. 14B-14E illustrate various schematic diagrams of a portion of the PVH element shown in FIG. 14A, showing in-plane orientations of optically anisotropic molecules in the PVH element, according to various embodiments of the present disclosure;

FIG. 14F illustrates a schematic diagram of a portion of the PVH element shown in FIG. 14A, showing out-of-plane orientations of optically anisotropic molecules in the PVH element, according to various embodiments of the present disclosure;

FIG. 15A schematically illustrates the PVH element shown in FIG. 14A functioning as an on-axis focusing PVH lens, according to an embodiment of the present disclosure;

FIG. 15B schematically illustrates the PVH element shown in FIG. 14A functioning as an off-axis focusing PVH lens, according to an embodiment of the present disclosure;

FIG. 16 illustrates a schematic diagram of an optical device, according to an embodiment of the present disclosure;

FIG. 17 illustrates a schematic diagram of a physical vapor deposition chamber system;

FIG. 18 illustrates a relationship between an ion energy level and a stress in a deposited film, according to an embodiment of the present disclosure;

FIG. 19 illustrates simulation results showing a relationship between a stress and two process variables (Process Variable 1 and Process Variable 2) for a low refractive index target material that forms a deposited film, according to an embodiment of the present disclosure;

FIG. 20 illustrates simulation results showing a relationship between a stress and two process variables (Process Variable 1 and Process Variable 2) for a high refractive index target material that forms a deposited film, according to an embodiment of the present disclosure;

FIG. 21 illustrates a temperature profile with a pre-heat cycle used by a physical vapor deposition chamber system, according to an embodiment of the present disclosure;

FIG. 22 illustrates a temperature profile without a pre-heat cycle used by a physical vapor deposition chamber system, according to an embodiment of the present disclosure;

FIG. 23A illustrates a relationship showing a reflectance and a wavelength for a multilayer thin film stack that is an anti-reflection coating fabricated based on a disclosed fabrication method, according to an embodiment of the present disclosure; and

FIG. 23B illustrates a relationship between a reflectance and a wavelength for a multilayer thin film stack that is a beam splitter fabricated based on disclosed fabrication method, according to an embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The term “film plane” refers to a plane in the film, layer, coating, or plate that is perpendicular to the thickness direction or a normal of a surface of the film, layer, coating, or plate. The film plane may be a plane in the volume of the film, layer, coating, or plate, or may be a surface plane of the film, layer, coating, or plate. The term “in-plane” as in, e.g., “in-plane orientation,” “in-plane direction,” “in-plane pitch,” etc., means that the orientation, direction, or pitch is within the film plane. The term “out-of-plane” as in, e.g., “out-of-plane direction,” “out-of-plane orientation,” or “out-of-plane pitch” etc., means that the orientation, direction, or pitch is not within a film plane (i.e., non-parallel with a film plane). For example, the direction, orientation, or pitch may be along a line that is perpendicular to a film plane, or that forms an acute or obtuse angle with respect to the film plane. For example, an “in-plane” direction or orientation may refer to a direction or orientation within a surface plane, an “out-of-plane” direction or orientation may refer to a thickness direction or orientation non-parallel with (e.g., perpendicular to) the surface plane. In some embodiments, an “out-of-plane” direction or orientation may form an acute or right angle with respect to the film plane.

The term “orthogonal” as in “orthogonal polarizations” or the term “orthogonally” as in “orthogonally polarized” means that an inner product of two vectors representing the two polarizations is substantially zero. For example, two lights or beams with orthogonal polarizations (or two orthogonally polarized lights or beams) may be two linearly polarized lights (or beams) with two orthogonal polarization directions (e.g., an x-axis direction and a y-axis direction in a Cartesian coordinate system) or two circularly polarized lights with opposite handednesses (e.g., a left-handed circularly polarized light and a right-handed circularly polarized light).

The wavelength ranges, spectra, or bands mentioned in the present disclosure are for illustrative purposes. The disclosed optical device, system, element, assembly, and method may be applied to a visible wavelength band, as well as other wavelength bands, such as an ultraviolet (“UV”) wavelength band, an infrared (“IR”) wavelength band, or a combination thereof. The term “substantially” or “primarily” used to modify an optical response action, such as transmit, reflect, diffract, deflect, block or the like that describes processing of a light means that a major portion, including all, of a light is transmitted, reflected, diffracted, deflected, or blocked, etc. The major portion may be a predetermined percentage (greater than 50%) of the entire light, such as 100%, 98%, 90%, 85%, 80%, etc., which may be determined based on specific application needs. It is understood that when a light is transmitted, the propagation direction of the light is not affected. When a light is deflected (e.g., reflected, diffracted), the propagation direction is usually changed.

The term “optic axis” may refer to a direction in a crystal. A light propagating in the optic axis direction may not experience birefringence (or double refraction). An optic axis may be a direction rather than a single line: lights that are parallel to that direction may experience no birefringence.

Structured illumination is a widely used technique for enhancing tracking accuracy and facilitating the depth reconstruction of tracked objects. The structured illumination (or structured light pattern) may include at least one of an intensity-based structured illumination or a polarization-based structured illumination. An intensity-based structured illumination (or structured light pattern) may have a spatially varying intensity pattern, which may include a series of striped lines, grids, dots corresponding to different intensities, or other suitable patterns. A polarization-based structured illumination (or structured light pattern) may have a spatially varying polarization pattern with a substantially uniform intensity.

A conventional object tracking method based on structured illumination often involves projecting a static structured illumination (or structured light pattern) onto the object within each frame, followed by single-shot imaging of the object illuminated under the static structured light pattern. The image including distortions of the structured light pattern may be processed, and depth information of the object may be extracted. Conventional methods have limitations in obtaining accurate depth information of the object.

In view of the limitations of the conventional technologies, the present disclosure provides a structured illumination generator for object tracking, an object tracking system including the structured illumination generator disclosed herein, and an object tracking method based on the structured illumination generator disclosed herein. The structured illumination generator may include a polarization hologram. In some embodiments, the structured illumination generator may include a polarization switch coupled with the polarization hologram. The structured illumination generator disclosed herein may be switchable between providing different structured light patterns (or fringe patterns) via switching the polarization hologram between operating at a neutral state and a non-neutral state and/or switching the polarization switch between operating at a switching state or a non-switching state. The object tracking method based on the structured illumination generator disclosed herein may facilitate advanced multi-shot imaging techniques that capture comprehensive information of the object. As a result, an object tracking system including the disclosed illumination system can provide an enhanced tracking range and an increased tracking accuracy.

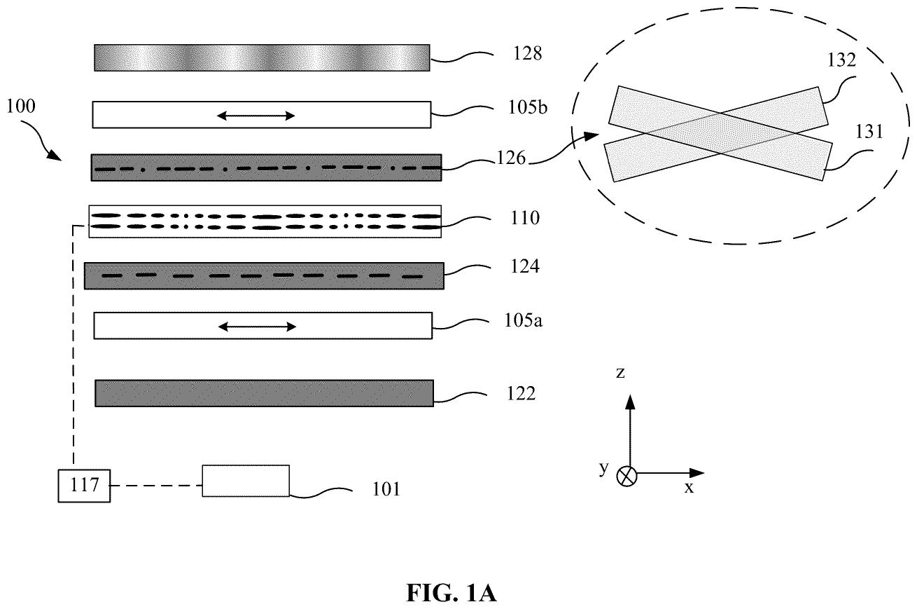

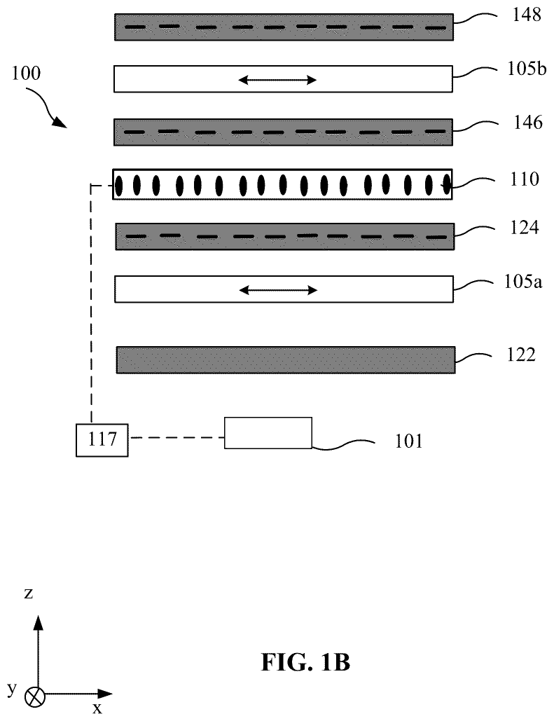

FIGS. 1A and 1B illustrate x-z sectional views of a switchable structured illumination generator 100, according to an embodiment of the present disclosure. As shown in FIGS. 1A and 1B, the structured illumination generator 100 may include a first polarizer 105a, a polarization hologram 110, and a second polarizer 105b arranged in an optical series. The polarization hologram 110 may be disposed between the first polarizer 105a and the second polarizer 105b. For discussion purposes, in FIGS. 1A and 1B, various elements included in the structured illumination generator 100 are shown as spaced apart from one another with a gap. In some embodiments, the various elements included in the structured illumination generator 100 may be stacked without a gap therebetween.

The structured illumination generator 100 may also include a controller 117 communicatively connected with the polarization hologram 110 and configured to control an optical state of the polarization hologram 110. The controller 117 may include a processor or processing unit and a storage device. The processor may be any suitable processor, such as a central processing unit (“CPU”), a graphic processing unit (“GPU”), etc. The storage device may be a non-transitory computer-readable medium, such as a memory, a hard disk, etc. The storage device may be configured to store data or information, including computer-executable program instructions or codes, which may be executed by the processor to perform various controls or functions of the methods or processes disclosed herein.

In some embodiments, each of the first polarizer 105a and the second polarizer 105b may be a linear polarizer configured to substantially transmit a linearly polarized light having a predetermined polarization direction, and substantially block, a linearly polarized light having a polarization direction that is orthogonal to the predetermined polarization direction. For discussion purposes, FIGS. 1A and 1B show that the first polarizer 105a and the second polarizer 105b have the polarization axes (or transmission axes) oriented in the same direction, e.g., an x-axis direction. That is, the first polarizer 105a and the second polarizer 105b may substantially transmit a p-polarized light (e.g., a linearly polarized light having a polarization direction along the x-axis direction), and substantially block, via absorption, an s-polarized light (e.g., a linearly polarized light having a polarization direction along the y-axis direction). In some embodiments, the first polarizer 105a and the second polarizer 105b may have the polarization axes (or transmission axes) oriented in different directions. For example, the polarization axes (or transmission axes) of the first polarizer 105a and the second polarizer 105b may be orthogonal.

The polarization hologram 110 may be a suitable polarization selective element configured to provide a polarization selective optical response. In some embodiments, the polarization hologram 110 may be circularly polarization selective configured to provide different optical responses to a left-handed circularly polarized (“LHCP”) light and a right-handed circularly polarized (“RHCP”) light. For example, the polarization hologram 110 may include a Pancharatnam-Berry phase (“PBP”) element, or a polarization volume hologram (“PVH”) element, etc. In some embodiments, the polarization hologram 110 may be formed by a thin layer of a birefringent medium with an intrinsic or induced (e.g., photo-induced) optical anisotropy, such as liquid crystals (“LC”), a liquid crystal polymer, or an amorphous polymer, etc. In some embodiments, the polarization hologram 110 may be formed by a meta material. A phase profile of the polarization hologram 110 may be determined, in part, by the local orientations of the optic axis of the polarization hologram (or the birefringent medium). Different patterns of the local orientations of the optic axis of the polarization hologram 110 may result in different phase profiles. Thus, through configuring the local orientations of the optic axis of the polarization hologram, the phase profile of the polarization hologram 110 may be configurable. The polarization hologram 110 may function as various optical elements, e.g., a grating, a lens (e.g. a spherical lens, a cylindrical lens, an aspherical lens, an on-axis lens, or an off-axis lens, etc.), or a freeform phase plate, etc.

The polarization hologram 110 may be fabricated based on various methods, such as holographic interference (e.g., holographic polarization interference), laser direct writing, ink-jet printing, and various other forms of lithography. For example, the laser direct writing may “write” a polarization hologram with desirable local orientations of the optic axis. Accordingly, the polarization hologram may be configured to have a desirable predetermined phase profile. Thus, a “hologram” described herein is not limited to creation by holographic interference, or “holography.”

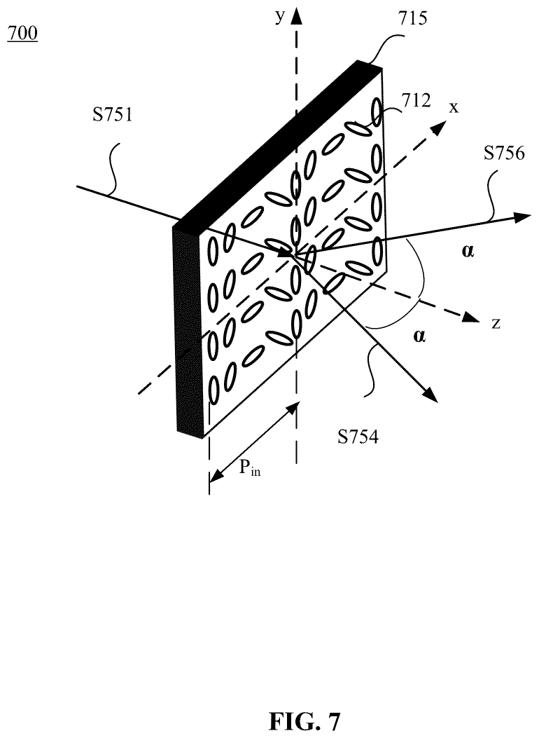

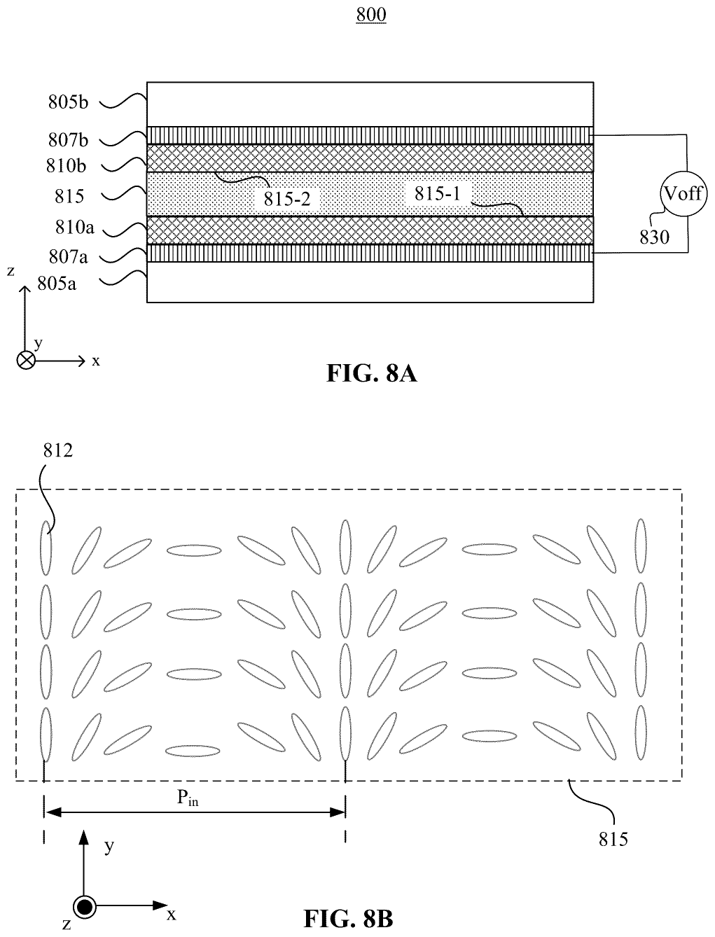

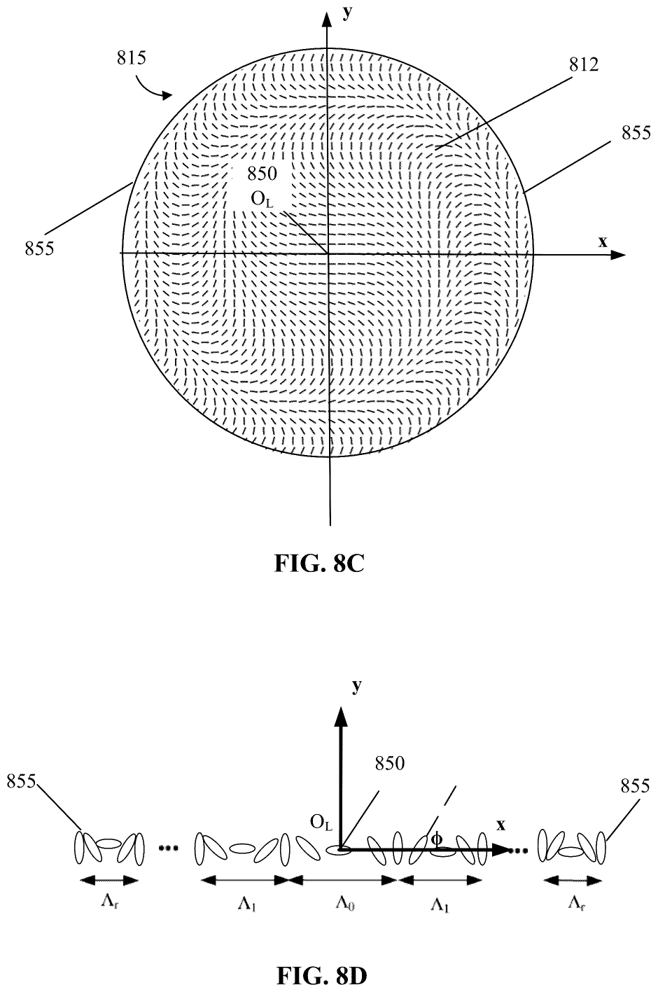

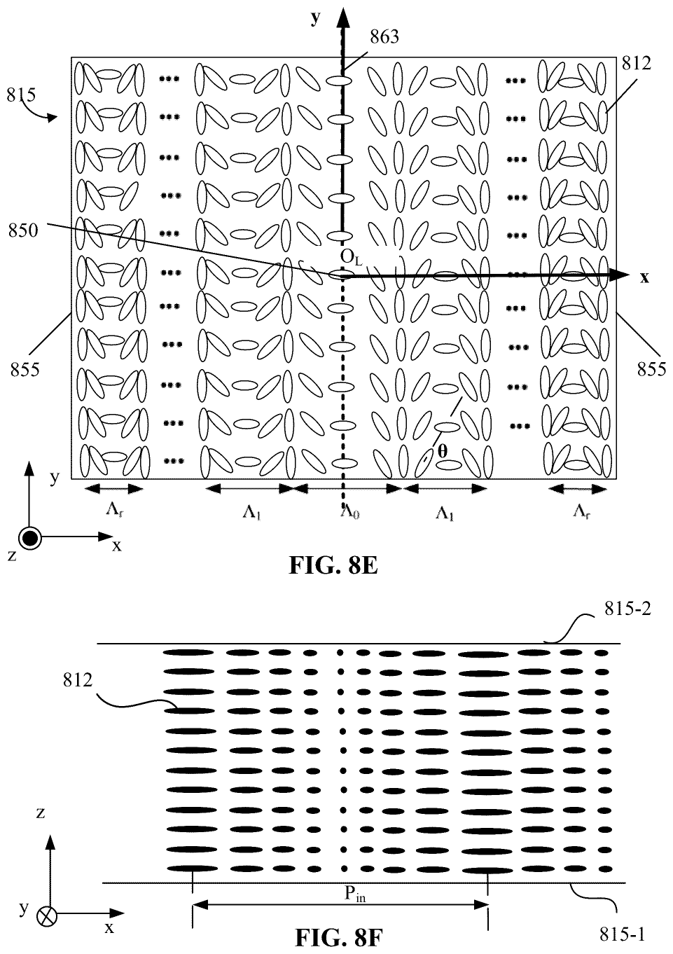

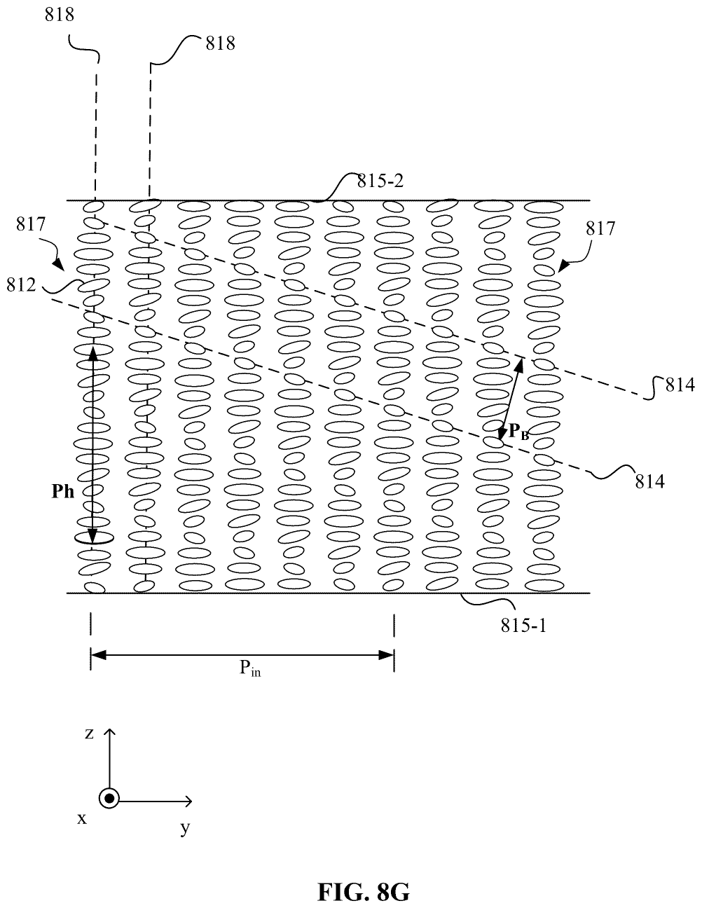

The details of the polarization hologram 110 will be discussed FIGS. 8A-8G. For discussion purposes, in the following descriptions, a PBP grating (also referred to as 110) is used as an example of the polarization hologram 110. FIG. 7 schematically illustrates a diagram of a PBP grating 700, according to an embodiment of the present disclosure. The PBP grating 700 may be an embodiment of the polarization hologram 110 shown in FIGS. 1A and 1B. The PBP grating 700 may include a birefringent medium layer 715. The PBP grating 700 may be configured with a constant in-plane pitch Pᵢₙ in a predetermined in-plane direction (e.g., an x-axis direction). The predetermined in-plane direction may be any suitable in-plane direction along the surface (or in a plane parallel with the surface) of the birefringent medium layer 715. For illustrative purposes, FIG. 7 shows that the predetermined in-plane direction is an x-axis direction. The in-plane pitch Pᵢₙ is defined as a distance along the in-plane direction (e.g., the x-axis direction) over which directors of LC molecules 712 rotate by a predetermined value (e.g., 180°) from a predetermined initial state (or reference state). In some embodiments, the thickness of the birefringent medium layer 715 may be configured as d=λ/(2*Δn), where λ is a design wavelength, Δn is the birefringence of the LC material of the birefringent medium layer 715, and Δn=nₑ−nₒ, nₑ and nₒ are the extraordinary and ordinary refractive indices of the LC material, respectively. In some embodiments, a design wavelength range of the PBP grating 700 may be within an infrared (“IR”) wavelength range. In some embodiments, the PBP grating 700 may substantially transmit, with negligible deflection, a visible light.

For an input light having a wavelength range within a design wavelength range of the PBP grating 700, the PBP grating 700 may be configured to operate in a positive state to forwardly diffract the input light in a positive diffraction angle when the input light has a first handedness, and operate in a negative state to the input light in a negative diffraction angle when the input light has a second handedness opposite to the first handedness. The PBP grating 700 operating in the positive or negative state may reverse a handedness of a diffracted light. For example, as shown in FIG. 7, an input light S751 of the PBP grating 700 may be a linearly polarized light including an RHCP component and an LHCP component. For discussion purpose, in FIG. 7, the PBP grating 700 may operate in the positive state for the RHCP component to forwardly diffract the RHCP component in a positive diffraction angle as an LHCP light S754 (e.g., +1^{st} order diffracted light having a positive diffraction angle +α), and operate in the negative state for the LHCP component to forwardly the LHCP component in a negative diffraction angle as an RHCP light S756 (e.g., −1^{st} order diffracted light having a negative diffraction angle −α). The diffraction angles are defined with respect to the normal of the light outputting surface of the PBP grating 700.

In some embodiments, the PBP grating 700 may be configured to provide a substantially high diffraction efficiency, e.g., equal to or greater than 98%. For example, 98% (or more) of the energy of the input light S751 may be output to the RHCP light S756 (e.g., −1^{st} order diffracted light) and the LHCP light S754 (e.g., +1^{st} order diffracted light). The in-plane pitch Pᵢₙ may determine, in part, the optical properties of the PBP grating 700. In some embodiments, as the in-plane pitch Pᵢₙ decreases, the diffraction angle of the ±1^{st} order diffracted light may increase, whereas the diffraction efficiency of the PBP grating 700 for the ±1^{st} order diffracted light may decrease. In some embodiments, the PBP grating 700 may operate in the positive state for the LHCP component to forwardly diffract the LHCP component in a positive diffraction angle (e.g., as a +1^{st} order diffracted light), and operate in the negative state for the RHCP component forwardly the RHCP component in a negative diffraction angle (e.g., as a −1^{st} order diffracted light).

In some embodiments, the PBP grating 700 may be a passive element that operates in the positive state or the negative state. In some embodiments, the PBP grating 700 may be an active element, which may also operate in a neutral state in addition to the positive state or the negative state. The positive state or the negative state may also be referred to as a non-neutral state. For example, when a sufficiently high voltage is applied to the PBP grating 700 to generate an electric field, the LC molecules 712 may be reoriented by the electric field such that the LC molecules 712 are aligned in the same direction, the PBP grating 700 may operate in the neutral state to substantially transmit, with negligible or zero diffraction, both the first circularly polarized light having the first predetermined handedness and the second circularly polarized light having the second predetermined handedness. The PBP grating 700 operating in the neutral state may reverse the handedness of a transmitted light or maintain the handedness of a transmitted light, depending on the orientations of the LC molecules 712 under the sufficiently high voltage. For example, when the LC directors of the LC molecules 712 are reoriented to be parallel with a thickness direction of the birefringent medium layer 715 (e.g., a z-axis direction), the PBP grating 700 operating in the neutral state may function as an isotropic medium for an input light, without changing the handedness of the transmitted light. When the LC directors of the LC molecules 712 are reoriented to be perpendicular to the thickness direction of the birefringent medium layer 715, the PBP grating 700 operating in the neutral state may function as a half-wave plate for an input light, reversing the handedness of the transmitted light.

Referring back to FIG. 1A, the controller 117 may control a power source (not shown) electrically coupled with the PBP grating 110. The controller 117 may control the voltage output from the power source to the PBP grating 110, thereby controlling the PBP grating 110 to operate in the non-neutral state or the neutral state for an input light having a wavelength range within a design wavelength range of the PBP grating 110. In some embodiments, a light source 101 may be coupled with the structured illumination generator 100 to emit an input light 122 that is output to the structured illumination generator 100. The input light 122 may have a wavelength range within a design wavelength range of the PBP grating 110. In some embodiments, the light source 101 may be an IR light source, and the input light 122 may be an IR light having a wavelength range within a design wavelength range of the PBP grating 110. The structured illumination generator 100 may process the input light 122 to generate a predetermined illumination pattern for a tracked object. In some embodiments, a system including the light source 101 and the structured illumination generator 100 may be referred to as an illumination system for the tracked object.

In some embodiments, a lens (not shown) may be disposed between the light source 101 and the first polarizer 105a, or between the first polarizer 105a and the polarization hologram 110. The lens may be configured to expand the input light output from the light source 101. In some embodiments, the input light output from the light source 101 may be a divergent light. That is, the light source 101 may be a divergent light source. In some embodiments, the polarization hologram 110 may be configured to correct the distortion caused by the divergent input light. For example, in some embodiments, the divergent input light may degrade the contrast ratio of the structured illumination pattern output from the structured illumination generator 100. The polarization hologram 110 may be configured to have a non-uniform thickness in one or more directions within a film plane of the polarization hologram, to improve the contrast ratio of the structured illumination pattern. In some embodiments, the lens may also be configured to collimate the input light output from the light source 101. In some embodiments, the controller 117 may be communicatively connected with the light source 101, and may control the operation of the light source 101.

FIG. 1A shows that the switchable structured illumination generator 100 is configured to operate at a first operation state to provide a first illumination pattern. As shown in FIG. 1A, the controller 117 may control the PBP grating 110 to operate in the non-neutral state. The input light 122 may be a polarized light or an unpolarized light. The first polarizer 105a may transmit the input light 122 as a p-polarized light 124 propagating toward the PBP grating 110. In some embodiments, when the input light 122 is a linearly polarized light, the first polarizer 105a may be omitted. The PBP grating 110 operating in the non-neutral state may forwardly diffract an RHCP component and an LHCP component of the p-polarized light 124 as an LHCP light 131 and an RHCP light 132 propagating toward the second polarizer 105b, respectively. The LHCP light 131 and the RHCP light 132 may include a −1^{st} order diffracted light and a +1^{st} order diffracted light.

The LHCP light 131 and the RHCP light 132 may interfere with one another in a spatial region to generate a superimposed wave (or light) 126, which may have a substantially uniform intensity (as denoted by the same grey color in 126) and a spatially varying linear polarization (as denoted by dash-dotted lines in 126). In other words, the superimposed wave (or light) 126 of the LHCP light 131 and the RHCP light 132 may be a linear polarization with an orientation (or a polarization direction) that is spatially varying within the spatial region. A pattern of the spatially varying orientation (or polarization direction) of the linear polarization of the superimposed wave (or light) 126 may correspond to a polarization interference pattern. That is, the LHCP light 131 and the RHCP light 132 may interfere with one another in the spatial region to generate a polarization interference pattern.

The configuration of the polarization interference pattern generated by the interference (or superposition) of the LHCP light 131 and the RHCP light 132 may be determined by the configuration of the polarization hologram 110. For discussion purposes, FIG. 1A shows that when the polarization hologram 110 is a PBP grating, the orientation of the linear polarization of the superimposed wave (or light) 126 may periodically vary within the spatial region. When the polarization hologram 110 is configured as a PBP element having a different in-plane orientation pattern, the orientation of the linear polarization of the superimposed wave (or light) 126 may vary in a different way.

The second polarizer 105b may be configured to transmit the superimposed wave (or light) 126 of the LHCP light 131 and the RHCP light 132 as a p-polarized light 128. The p-polarized light 128 may have a substantially uniform linear polarization (i.e., p-polarization) and a spatially varying intensity (as denoted by different grey scales in 128, in which the darker grey indicates a higher intensity, and the lighter grey indicates a lower intensity). A pattern of the spatially varying intensity of the p-polarized light 128 may correspond to an intensity interference pattern having a plurality of interference fringes of varying intensities. That is, the second polarizer 105b may be configured to convert the polarization interference pattern generated by the interference (or superposition) of the LHCP light 131 and the RHCP light 132 into the intensity interference pattern, which may provide a structured light pattern (or fringe pattern, or structured illumination) for a tracked object.

FIG. 1B illustrates an x-z sectional view of the switchable structured illumination generator 100 configured to operate at a second operation state to provide a second illumination pattern, according to an embodiment of the present disclosure. As shown in FIG. 1B, the controller 117 may control the PBP grating 110 to operate in the neutral state. The first polarizer 105a may transmit the input light 122 as the p-polarized light 124 propagating toward the PBP grating 110. For discussion purposes, FIG. 1B shows that the PBP grating 110 operating in the neutral state may function as an isotropic medium for the p-polarized light 124 incident thereon, and may transmit the p-polarized light 124 as a p-polarized light 146 propagating toward the second polarizer 105b. The second polarizer 105b may transmit the p-polarized light 146 as a p-polarized light 148, which may have a spatially uniform intensity and a spatially uniform polarization (i.e., p-polarization). That is, the p-polarized light 148 having the spatially uniform intensity may provide a spatially uniform illumination (referred to as a flood pattern) for the tracked object.

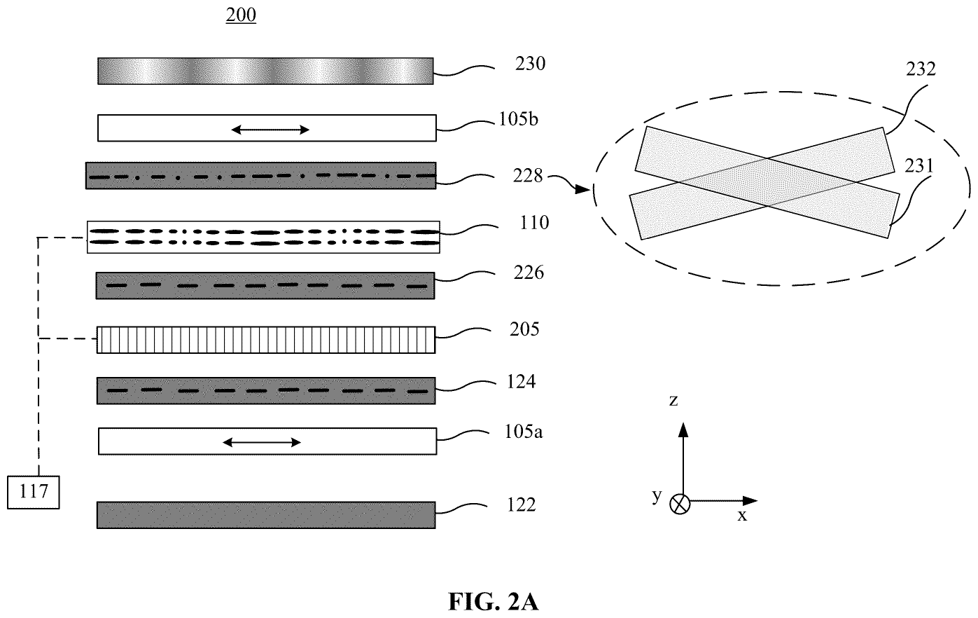

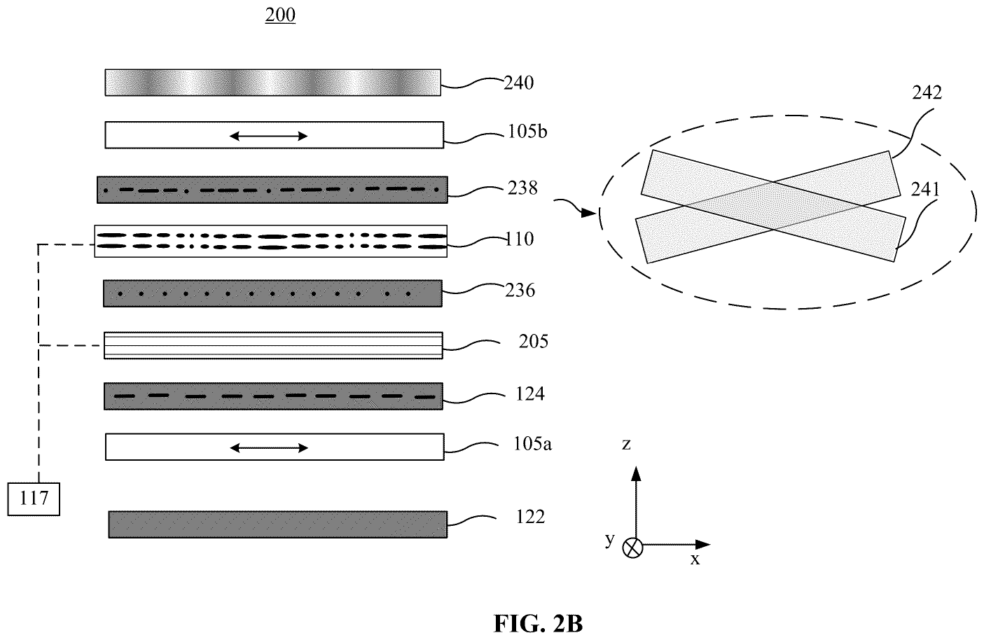

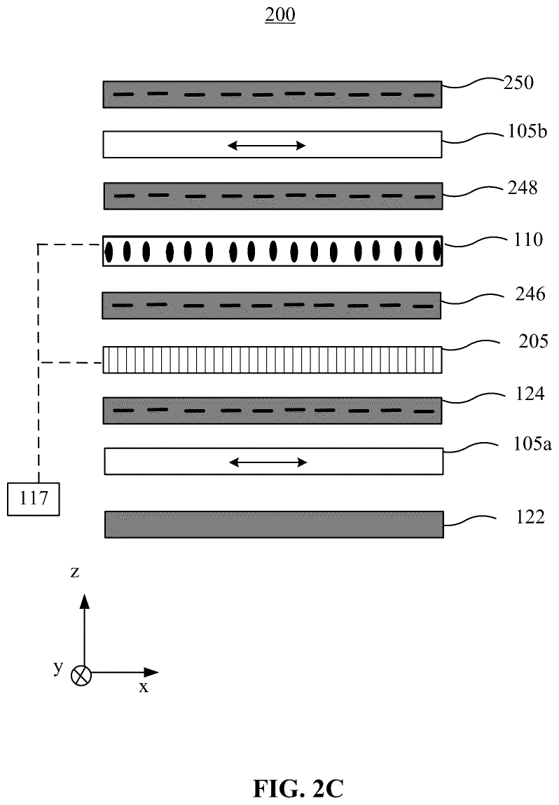

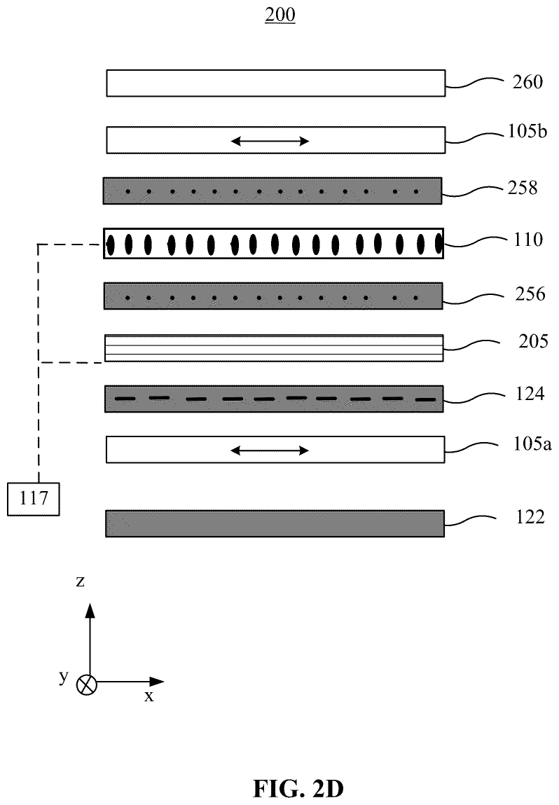

FIG. 2A illustrates an x-z sectional view of a switchable structured illumination generator 200, according to an embodiment of the present disclosure. The structured illumination generator 200 may include elements, structures, and/or functions that are the same as or similar to those included in the structured illumination generator 100 shown in FIGS. 1A and 1B. Detailed descriptions of the same or similar elements, structures, and/or functions may refer to the above descriptions rendered in connection with FIGS. 1A and 1B. The structured illumination generator 200 may be switchable between operating in four different operation states to provide four different illumination patterns.

As shown in FIG. 2A, the structured illumination generator 200 may include a first polarizer 105a, a polarization switch 205, the polarization hologram (e.g., PBP grating) 110, and the second polarizer 105b arranged in an optical series. The polarization switch 205 may be disposed between the first polarizer 105a and the polarization hologram 110. The polarization hologram 110 may be disposed between the polarization switch 205 and the second polarizer 105b. For discussion purposes, FIG. 2A shows that the various elements included in the structured illumination generator 200 are spaced apart from one another with a gap. In some embodiments, the various elements included in the structured illumination generator 200 may be disposed without a gap therebetween. The structured illumination generator 200 may also include the controller 117 communicatively connected with the polarization hologram 110 and the polarization switch 205. The controller 117 may control an optical state of the polarization hologram 110 and an operation state of the polarization switch 205, thereby controlling an operation state of the structured illumination generator 200.

The polarization switch 205 may be configured to control the polarization of an input light of the polarization hologram 110. In some embodiments, a design wavelength range (or an operation wavelength range) of the polarization switch 205 may at least partially overlap with the design wavelength range of the PBP grating 110. In some embodiments, the design wavelength range (or operation wavelength range) of the polarization switch 205 may substantially overlap with the design wavelength range of the PBP grating 110. In some embodiments, the polarization switch 205 may be a narrow band polarization switch having a relatively narrow operation wavelength range. In some embodiments, the polarization switch 205 may be a broadband polarization switch having a relatively broad operation wavelength range.

In some embodiment, the controller 117 may control the polarization switch 205 to switch between operating in a switching state and a non-switching state. For a linearly polarized input light having a wavelength range within the design wavelength range of the PBP grating 110, the polarization switch 205 operating in the switching state may change the polarization of the linearly polarized input light to an orthogonal polarization while transmitting the linearly polarized input light. That is, the linearly polarized input light and the linearly polarized output light of the polarization switch 205 may have orthogonal linear polarizations. The polarization switch 205 operating in the non-switching state may maintain the polarization of the linearly polarized input light while transmitting the linearly polarized input light. That is, the linearly polarized input light and the linearly polarized output light of the polarization switch 205 may have the same polarization.

In some embodiments, the polarization switch 205 may include a switchable half-wave plate. In some embodiments, the polarization switch 205 may include a twisted-nematic liquid crystal (“TNLC”) cell. For example, when the TNLC cell operates at a voltage-on state, the TNLC cell may rotate a polarization direction of a linearly polarized input light by about 90°, while transmitting the linearly polarized input light. When the TNLC cell operates at a voltage-off state, the TNLC cell may maintain the polarization direction of the linearly polarized input light, while transmitting the linearly polarized input light. In some embodiments, the switchable half-wave plate may be a suitable liquid crystal (“LC”)-based switchable half-wave plate that includes one or more LC cells, e.g., a Pi cell, a ferroelectric cell, an electronically controlled birefringence (“ECB”) cell, a dual ECB cell, etc., or a combination thereof. In some embodiments, the switchable half-wave plate may be electrically driven. For example, the switchable half-wave plate may be electrically coupled with a power source, and the controller 117 may be communicatively coupled with the power source to control an output of the power source. For example, when the switchable half-wave plate operates at a voltage-off state, the switchable half-wave plate may change a polarization direction of a linearly polarized input light to an orthogonal polarization direction, while transmitting the linearly polarized input light. When the switchable half-wave plate operates at a voltage-on state, the switchable half-wave plate may maintain the polarization direction of the linearly polarized input light, while transmitting the linearly polarized input light.

The structured illumination generator 200 may be switchable between operating in four different operation states via switching the polarization hologram 110 between operating at a neutral state and a non-neutral state and switching the polarization switch 205 between operating at a switching state and a non-switching state. FIG. 2A shows that the switchable structured illumination generator 200 is configured to operate at a first operation state to provide a first illumination pattern. As shown in FIG. 2A, the controller 117 may control the PBP grating 110 to operate in the non-neutral state, and control the polarization switch 205 to operate in the non-switching state. The first polarizer 105a may transmit the input light 122 as the p-polarized light 124 propagating toward the polarization switch 205. The polarization switch 205 operating in the non-switching state may transmit the p-polarized light 124 as a p-polarized light 226 propagating toward the PBP grating 110. The PBP grating 110 operating in the non-neutral state may forwardly diffract an RHCP component and an LHCP component of the p-polarized light 226 as an LHCP light 231 and an RHCP light 232 propagating toward the second polarizer 105b, respectively. The LHCP light 231 and the RHCP light 232 may include a −1^{st} order diffracted light and a +1^{st} order diffracted light.

The LHCP light 231 and the RHCP light 232 may interfere with one another in a spatial region to generate a superimposed wave (or light) 228, which may have a substantially uniform intensity (as denoted by the same grey color in 228) and a spatially varying linear polarization (as denoted by dash-dotted lines in 228). That is, the LHCP light 231 and the RHCP light 232 may interfere with one another in the spatial region to generate a first polarization interference pattern. The second polarizer 105b may be configured to transmit the superimposed wave (or light) 228 as a p-polarized light 230. The p-polarized light 230 may have a substantially uniform linear polarization (i.e., p-polarization) and a spatially varying intensity (as denoted by different grey scales in 230, in which the darker grey indicates a higher intensity, and the lighter grey indicates a lower intensity). A pattern of the spatially varying intensity of the p-polarized light 230 may correspond to a first intensity interference pattern having a plurality of interference fringes of varying intensities. That is, the second polarizer 105b may be configured to convert the first polarization interference pattern generated by the interference (or superposition) of the LHCP light 231 and the RHCP light 232 into the first intensity interference pattern, which may provide the first illumination pattern for a tracked object. For example, FIG. 2A shows that the first illumination pattern may be a first structured light pattern (or fringe pattern, or structured illumination) including striped lines (or fringes) of various intensities interposed according to a first predetermined pattern.

FIG. 2B shows that the switchable structured illumination generator 200 is configured to operate at a second operation state to provide a second illumination pattern. As shown in FIG. 2B, the controller 117 may control the PBP grating 110 to operate in the non-neutral state, and control the polarization switch 205 to operate in the switching state. The first polarizer 105a may transmit the input light 122 as the p-polarized light 124 propagating toward the polarization switch 205. The polarization switch 205 operating in the switching state may convert the p-polarized light 124 into an s-polarized light 236 propagating toward the PBP grating 110. The PBP grating 110 operating in the non-neutral state may forwardly diffract an RHCP component and an LHCP component of the s-polarized light 236 as an LHCP light 241 and an RHCP light 242 propagating toward the second polarizer 105b, respectively. The LHCP light 241 and the RHCP light 242 may include a −1^{st} order diffracted light and a +1^{st} order diffracted light.

The LHCP light 241 and the RHCP light 242 may interfere with one another in a spatial region to generate a superimposed wave (or light) 238, which may have a substantially uniform intensity (as denoted by the same grey color in 238) and a spatially varying linear polarization (as denoted by dash-dotted lines in 238). That is, the LHCP light 241 and the RHCP light 242 may interfere with one another in the spatial region to generate a second polarization interference pattern. The second polarizer 105b may be configured to transmit the superimposed wave (or light) 238 as a p-polarized light 240. The p-polarized light 240 may have a substantially uniform linear polarization (i.e., p-polarization) and a spatially varying intensity (as denoted by different grey scales in 240, in which the darker grey indicates a higher intensity, and the lighter grey indicates a lower intensity). A pattern of the spatially varying intensity of the p-polarized light 240 may correspond to a second intensity interference pattern having a plurality of interference fringes of varying intensities. That is, the second polarizer 105b may be configured to convert the second polarization interference pattern generated by the interference (or superposition) of the LHCP light 241 and the RHCP light 242 into the second intensity interference pattern, which may provide the second illumination pattern for the tracked object. For example, FIG. 2B shows that the second illumination pattern may be a second structured light pattern (or fringe pattern, or structured illumination) including striped lines (or fringes) of various intensities interposed according to a second predetermined pattern.

Referring to FIGS. 2A and 2B, as the p-polarized light 226 and the s-polarized light 236 incident onto the PBP grating 110 have different linear polarizations, the first polarization interference pattern generated by the interference (or superposition) of the LHCP light 231 and the RHCP light 232 may be different from the second polarization interference pattern generated by the interference (or superposition) of the LHCP light 241 and the RHCP light 242. Thus, the first intensity interference pattern may be different from the second intensity interference pattern. Thus, the first structured light pattern including striped lines (or fringes) of various intensities interposed according to the first predetermined pattern may be different from the second structured light pattern including striped lines (or fringes) of various intensities interposed according to the second predetermined pattern. For discussion purpose, the first structured light pattern may be referred to as a positive fringe pattern, and the second structured light pattern may be referred to as a negative fringe pattern. The first structured light pattern and the second structured light pattern may be inversed fringe patterns.

FIG. 2C shows that the switchable structured illumination generator 200 is configured to operate at a third operation state to provide a third illumination pattern. As shown in FIG. 2C, the controller 117 may control the PBP grating 110 to operate in the neutral state, and control the polarization switch 205 to operate in the non-switching state. The first polarizer 105a may transmit the input light 122 as the p-polarized light 124 propagating toward the polarization switch 205. The polarization switch 205 operating in the non-switching state may transmit the p-polarized light 124 as a p-polarized light 246 propagating toward the PBP grating 110. For discussion purposes, FIG. 2C shows that the PBP grating 110 operating in the neutral state may function as an isotropic medium for the p-polarized light 246 incident thereon, and may transmit the p-polarized light 246 as a p-polarized light 248 propagating toward the second polarizer 105b. The second polarizer 105b may transmit the p-polarized light 248 as a p-polarized light 250, which may have a spatially uniform intensity and a spatially uniform polarization (i.e., p-polarization). The p-polarized light 250 may provide a third illumination pattern for a tracked object. The third illumination pattern may be a flood pattern having the spatially uniform intensity and the spatially uniform polarization (i.e., p-polarization).

FIG. 2D shows that the switchable structured illumination generator 200 is configured to operate at a fourth operation state to provide a fourth illumination pattern. As shown in FIG. 2D, the controller 117 may control the PBP grating 110 to operate in the neutral state, and control the polarization switch 205 to operate in the switching state. The first polarizer 105a may transmit the input light 122 as the p-polarized light 124 propagating toward the polarization switch 205. The polarization switch 205 operating in the switching state may transmit the p-polarized light 124 into an s-polarized light 256 propagating toward the PBP grating 110. For discussion purposes, FIG. 2D shows that the PBP grating 110 operating in the neutral state may function as an isotropic medium for the s-polarized light 256 incident thereon, and may transmit the s-polarized light 256 into an s-polarized light 258 propagating toward the second polarizer 105b. The second polarizer 105b may substantially block the s-polarized light 258 via absorption, and a transmitted light 260 of the second polarizer 105b may have a negligible or substantially weak light intensity. That is, a fourth illumination pattern provided by the transmitted light 260 for a tracked object may have a negligible or substantially weak light intensity and, thus, may be referred to as a black pattern.

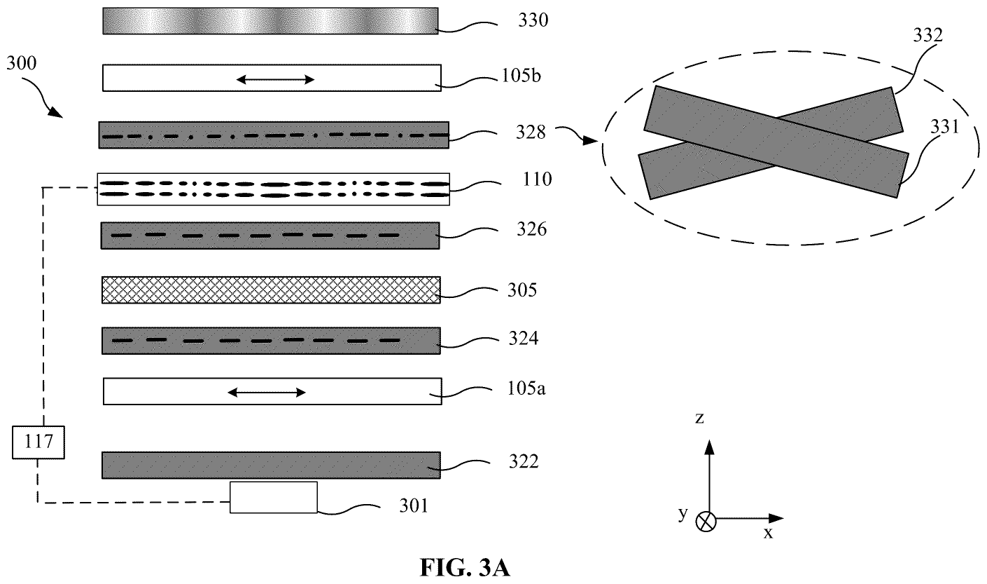

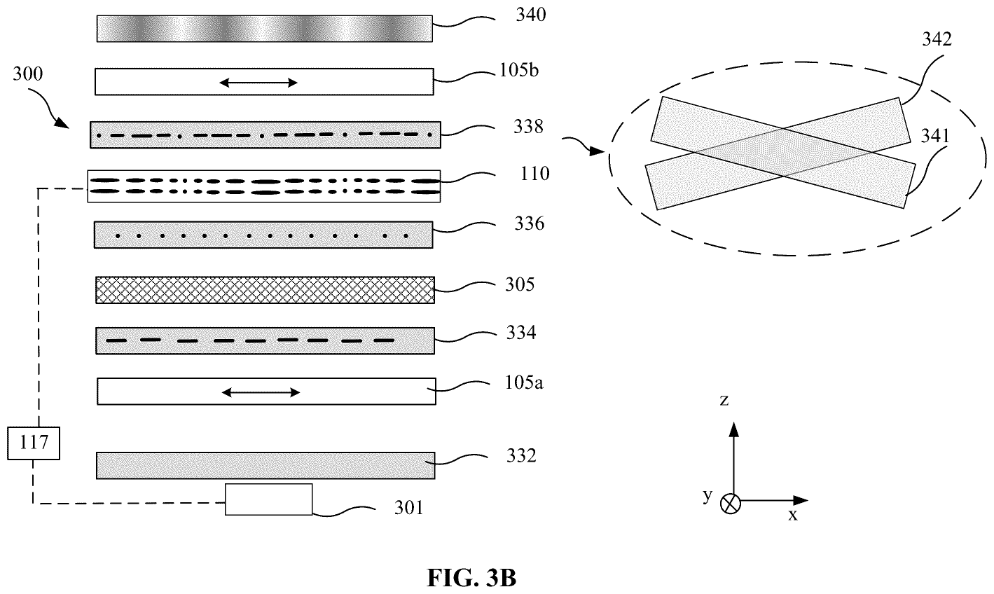

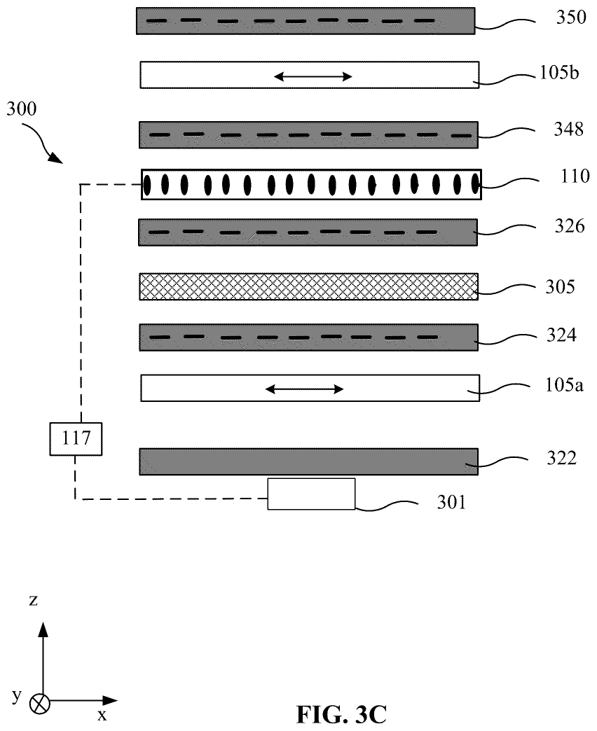

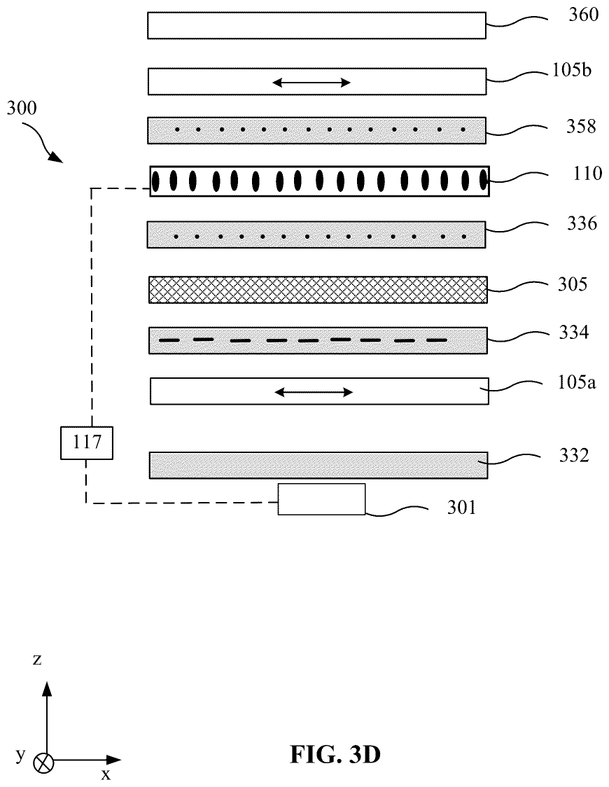

FIG. 1A-FIG. 2D illustrate various switchable structured illumination generators configured to provide structured light patterns (or fringe patterns) of a single wavelength (or single wavelength range). FIG. 3A-FIG. 5B illustrate various switchable structured illumination generators configured to provide structured light patterns (or fringe pattern) of multiple wavelengths or wavelength ranges, which may enable detection of objects at greater depths and simplify the calculation of depth information for tracked objects. For discussion purposes, FIG. 3A-FIG. 5B illustrate various switchable structured illumination generators, each of which is configured to provide a structured light pattern (or fringe pattern) of two wavelengths (or wavelength ranges). Such a structured light pattern may be referred to as a dual-fringe pattern. The mechanisms and design principles disclosed herein for generating the dual-fringe pattern may be applied to other structured illumination generators for generating fringe patterns of more than two wavelengths (or wavelength ranges).

FIGS. 3A and 3B illustrate x-z sectional views of a switchable structured illumination generator 300, according to an embodiment of the present disclosure. The structured illumination generator 300 may include elements, structures, and/or functions that are the same as or similar to those included in the structured illumination generator 100 shown in FIGS. 1A and 1B, or the structured illumination generator 200 shown in FIGS. 2A-2D. Detailed descriptions of the same or similar elements, structures, and/or functions may refer to the above descriptions rendered in connection with FIGS. 1A and 1B or FIGS. 2A-2D. The structured illumination generator 300 may be wavelength multiplexed to generate structured illumination of different wavelengths or different wavelength ranges.

As shown in FIGS. 3A and 3B, the structured illumination generator 300 may include a first polarizer 105a, a color-selective waveplate 305, the polarization hologram (e.g., PBP grating) 110, and the second polarizer 105b arranged in an optical series. The color-selective waveplate 305 may be disposed between the first polarizer 105a and the polarization hologram 110. The polarization hologram 110 may be disposed between the color-selective waveplate 305 and the second polarizer 105b. For discussion purposes, FIG. 3A shows that the various elements included in the structured illumination generator 300 are spaced apart from one another with a gap. In some embodiments, the various elements included in the structured illumination generator 300 may be disposed without a gap therebetween.

The color-selective waveplate 305 may be configured to control the polarization of a linearly polarized input light of the polarization hologram 110. In some embodiments, the color-selective waveplate 305 may be configured to operate as a full-wave plate (e.g., one-wave plate) for a first predetermined wavelength range, and operate as a half-wave plate for a second, different predetermined wavelength range. For a linearly polarized input light having a wavelength range within the second predetermined wavelength range and outside of the first predetermined wavelength range, the color-selective waveplate 305 may change the polarization of the linearly polarized input light to an orthogonal polarization while transmitting the linearly polarized input light. That is, for the linearly polarized input light having a wavelength range within the second predetermined wavelength range and outside of the first predetermined wavelength range, the linearly polarized input light and the linearly polarized output light of the color-selective waveplate 305 may have orthogonal linear polarizations.

For a linearly polarized input light having a wavelength range within the first predetermined wavelength range and outside of the second predetermined wavelength range, the color-selective waveplate 305 may maintain the polarization of the linearly polarized input light while transmitting the linearly polarized input light. That is, for the linearly polarized input light having a wavelength range within the first predetermined wavelength range and outside of the second predetermined wavelength range the linearly polarized input light and the linearly polarized output light of the color-selective waveplate 305 may have the same polarization. In some embodiments, the color-selective waveplate 305 may be configured as a multi-layer birefringent film.

In some embodiments, a light source 301 may be coupled with the structured illumination generator 300 to provide an input light, and the structured illumination generator 300 may process the input light to generate a predetermined illumination pattern for a tracked object. The light source 301 may be an IR light source, which may be configured to emit a first light 322 (as shown in FIG. 3A) having a wavelength range within the first predetermined wavelength range and outside of the second predetermined wavelength range, and a second light 332 (as shown in FIG. 3B) having a wavelength range within the second predetermined wavelength range and outside of the first predetermined wavelength range. For example, the first light 322 may have a wavelength of about 850 nm, and the second light 332 may have a wavelength of about 940 nm. In some embodiments, a lens (not shown) may be disposed between the light source 301 and the first polarizer 105a, or between the first polarizer 105a and the color-selective waveplate 305. The lens (not shown) may be configured to expand the input light output from the light source 301. In some embodiments, the input light output from the light source 301 may be a divergent light. In some embodiments, the lens may also be configured to collimate the input light output from the light source 301.

The controller 117 may be communicatively connected with the light source 301, and may control an operation of the light source 301. In some embodiments, the controller 117 may be configured to control the light source 301 to emit the first light 322 and the second light 332 during a same time period (e.g., simultaneously), for example, during a same frame (or a same sub-frame of a frame) of the light source 301 (a same frame or a same sub-frame of a frame determined by the controller 117). In some embodiments, the controller 117 may be configured to control the light source 301 to emit the first light 322 and the second light 332 during different time periods, for example, during a first sub-frame and a second sub-frame of a same sub-frame or during different frames of the light source 301 (or during a first sub-frame and a second sub-frame of a same sub-frame or during different frames determined by the controller 117).

In some embodiments, although not shown, two light sources (e.g., IR light sources) may be coupled with the structured illumination generator 300, and may provide the first light 322 and the second light 332, respectively. The controller 117 may be communicatively connected with the two light sources and may control the operation of the two light sources. In some embodiments, the controller 117 may be configured to control the two IR light sources to emit the first light 322 and the second light 332 during a same time period (e.g., simultaneously), for example, during a same frame (or a same sub-frame of a frame) of the two light sources (or during a same frame or a same sub-frame of a frame determined by the controller 117). In some embodiments, the controller 117 may be configured to control the two light sources to emit the first light 322 and the second light 332 during different time periods, for example, during a first sub-frame and a second sub-frame of a same sub-frame or during different frames of the two light sources (or during a first sub-frame and a second sub-frame of a same sub-frame or during different frames determined by the controller 117).

FIG. 3A shows that the switchable structured illumination generator 300 is configured to operate at a first operation state to provide a first illumination pattern. FIG. 3B shows that the switchable structured illumination generator 300 is configured to operate at a second operation state to provide a second illumination pattern. For discussion purpose, FIGS. 3A and 3B show that the controller 117 is configured to control the light source 301 to emit the first light 322 and the second light 332 during a first sub-frame and a second sub-frame of a same frame of the light source 301. The structured illumination generator 300 may be switchable between operating in the first operation state and operating in the second operation state. The controller 117 may be configured to switch the structured illumination generator 300 between operating in the first operation state and operating in the second operation state via switching the light source 301 between outputting the first input light 322 and outputting the second input light 332.

As shown in FIG. 3A, during the first sub-frame, the controller 117 may control the PBP grating 110 to operate in the non-neutral state, and control the light source 301 to output the first input light 322 toward the first polarizer 105a. The first polarizer 105a may transmit the first input light 322 as a p-polarized light 324 propagating toward the color-selective waveplate 305. As the color-selective waveplate 305 operates as a full-wave plate for the first predetermined wavelength range, the color-selective waveplate 305 may transmit the p-polarized light 324 as a p-polarized light 326 propagating toward the PBP grating 110.

The PBP grating 110 may be configured to have a design wavelength range covering both the first predetermined wavelength range and the second predetermined wavelength range. The PBP grating 110 operating in the non-neutral state may forwardly diffract an RHCP component and an LHCP component of the p-polarized light 326 as an LHCP light 331 and an RHCP light 332 propagating toward the second polarizer 105b, respectively. The LHCP light 331 and the RHCP light 332 may include a −1^{st} order diffracted light and a +1^{st} order diffracted light.

The LHCP light 331 and the RHCP light 332 may interfere with one another in a spatial region to generate a superimposed wave (or light) 328, which may have a substantially uniform intensity (as denoted by the same grey color in 328) and a spatially varying linear polarization (as denoted by dash-dotted lines in 328). That is, the LHCP light 331 and the RHCP light 332 may interfere with one another in the spatial region to generate a first polarization interference pattern. The second polarizer 105b may be configured to transmit the superimposed wave (or light) 328 as a p-polarized light 330. The p-polarized light 330 may have a substantially uniform linear polarization (i.e., p-polarization) and a spatially varying intensity (as denoted by different grey scales in 330, in which the darker grey indicates a higher intensity, and the lighter grey indicates a lower intensity). A pattern of the spatially varying intensity of the p-polarized light 330 may correspond to a first intensity interference pattern having a plurality of interference fringes of varying intensities. That is, the second polarizer 105b may be configured to convert the first polarization interference pattern generated by the interference (or superposition) of the LHCP light 331 and the RHCP light 332 into the first intensity interference pattern, which may provide the first illumination pattern for a tracked object. For example, FIG. 3A shows that the first illumination pattern may be a first structured light pattern (or fringe pattern, or structured illumination) including striped lines (or fringes) of various intensities interposed according to a first predetermined pattern. The first structured light pattern may be in the wavelength range within the first predetermined wavelength range and outside of the second predetermined wavelength range.

As shown in FIG. 3B, during the second sub-frame, the controller 117 may control the PBP grating 110 to operate in the non-neutral state, and control the light source 301 to output the second input light 332 toward the first polarizer 105a. The first polarizer 105a may transmit the second input light 332 as a p-polarized light 334 propagating toward the color-selective waveplate 305. As the color-selective waveplate 305 operates as a half-wave plate for the second predetermined wavelength range, the color-selective waveplate 305 may convert the p-polarized light 334 into an s-polarized light 336 propagating toward the PBP grating 110. The PBP grating 110 operating in the non-neutral state may forwardly diffract an RHCP component and an LHCP component of the s-polarized light 336 as an LHCP light 341 and an RHCP light 342 propagating toward the second polarizer 105b, respectively. The LHCP light 341 and the RHCP light 342 may include a −1^{st} order diffracted light and a +1^{st} order diffracted light.

The LHCP light 341 and the RHCP light 342 may interfere with one another in a spatial region to generate a superimposed wave (or light) 338, which may have a substantially uniform intensity (as denoted by the same grey color in 338) and a spatially varying linear polarization (as denoted by dash-dotted lines in 338). That is, the LHCP light 341 and the RHCP light 342 may interfere with one another in the spatial region to generate a second polarization interference pattern. The second polarizer 105b may be configured to transmit the superimposed wave (or light) 338 as a p-polarized light 340. The p-polarized light 340 may have a substantially uniform linear polarization (i.e., p-polarization) and a spatially varying intensity (as denoted by different grey scales in 340, in which the darker grey indicates a higher intensity, and the lighter grey indicates a lower intensity). A pattern of the spatially varying intensity of the p-polarized light 340 may correspond to a second intensity interference pattern having a plurality of interference fringes of varying intensities. That is, the second polarizer 105b may be configured to convert the second polarization interference pattern generated by the interference (or superposition) of the LHCP light 341 and the RHCP light 342 into the second intensity interference pattern, which may provide the second illumination pattern for the tracked object. For example, FIG. 3B shows that the second illumination pattern may be a second structured light pattern (or fringe pattern, or structured illumination) including striped lines (or fringes) of various intensities interposed according to a second predetermined pattern. The second structured light pattern may be in the wavelength range within the second predetermined wavelength range and outside of the first predetermined wavelength range.

Referring to FIGS. 3A and 3B, as the p-polarized light 326 and the s-polarized light 336 incident onto the PBP grating 110 have different linear polarizations, the first polarization interference pattern generated by the interference (or superposition) of the LHCP light 331 and the RHCP light 332 may be different from the second polarization interference pattern generated by the interference (or superposition) of the LHCP light 341 and the RHCP light 342. Thus, the first intensity interference pattern may be different from the second intensity interference pattern. Accordingly, the first structured light pattern including striped lines (or fringes) of various intensities interposed according to the first predetermined pattern may be different from the second structured light pattern including striped lines (or fringes) of various intensities interposed according to the second predetermined pattern. For discussion purpose, the first structured light pattern may be referred to as a positive fringe pattern, and the second structured light pattern may be referred to as a negative fringe pattern. The first structured light pattern and the second structured light pattern may be inversed fringe patterns.

In some embodiments, the controller 117 may also be configured to control the structured illumination generator 300 to operate at a third operation state to provide a third illumination pattern (as shown in FIG. 3C) or operate at a fourth operation state to provide a fourth illumination pattern (as shown in FIG. 3D). For example, as shown in FIG. 3C, during a third sub-frame, the controller 117 may control the PBP grating 110 to operate in the neutral state, and control the light source 301 to output the first input light 322 toward the first polarizer 105a. The first polarizer 105a may transmit the first input light 322 as the p-polarized light 324 propagating toward the color-selective waveplate 305. As the color-selective waveplate 305 operates as a full-wave plate for the first predetermined wavelength range, the color-selective waveplate 305 may transmit the p-polarized light 324 as a p-polarized light 326 propagating toward the PBP grating 110. The PBP grating 110 operating in the neutral state may function as an isotropic medium for the p-polarized light 326 incident thereon, and may transmit the p-polarized light 326 as a p-polarized light 348 propagating toward the second polarizer 105b. The second polarizer 105b may transmit the p-polarized light 348 as a p-polarized light 350, which may have a spatially uniform intensity and a spatially uniform polarization (i.e., p-polarization). The p-polarized light 350 may provide a third illumination pattern for a tracked object. The third illumination pattern may be a flood pattern having the spatially uniform intensity and the spatially uniform polarization (i.e., p-polarization). The third illumination pattern (or the flood pattern) may be in the wavelength range within the first predetermined wavelength range and outside of the second predetermined wavelength range.

As shown in FIG. 3D, during a fourth sub-frame, the controller 117 may control the PBP grating 110 to operate in the neutral state, and control the light source 301 to output the second input light 332 toward the first polarizer 105a. The first polarizer 105a may transmit the second input light 332 as the p-polarized light 334 propagating toward the color-selective waveplate 305. As the color-selective waveplate 305 operates as a half-wave plate for the second predetermined wavelength range, the color-selective waveplate 305 may convert the p-polarized light 334 into the s-polarized light 336 propagating toward the PBP grating 110. The PBP grating 110 operating in the neutral state may function as an isotropic medium for the s-polarized light 336 incident thereon, and may transmit the s-polarized light 336 into an s-polarized light 358 propagating toward the second polarizer 105b. The second polarizer 105b may substantially block the s-polarized light 358 via absorption. A transmitted light 360 of the second polarizer 105b may have a negligible or substantially weak light intensity. That is, a fourth illumination pattern provided by the transmitted light 360 for a tracked object may have a negligible or substantially weak light intensity and, thus, may be referred to as a black pattern. The fourth illumination pattern (or the black pattern) may be in the wavelength range within the second predetermined wavelength range and outside of the first predetermined wavelength range.

In some embodiments, although not shown, during the first sub-frame, the controller 117 may control the PBP grating 110 to operate in the non-neutral state, and control the light source 301 to output the first input light 322 and the second input light 332 toward the first polarizer 105a. An illumination pattern provided by the structured illumination generator 300 may be a superposition of the first structured light pattern in the first wavelength range (shown in FIG. 3A) and the second structured light pattern 340 shown in FIG. 3B. During the second sub-frame, the controller 117 may control the PBP grating 110 to operate in the neutral state, and control the light source 301 to output the first input light 322 and the second input light 332 toward the first polarizer 105a. An illumination pattern provided by the structured illumination generator 300 may be a superposition of the third structured light pattern (or the flood pattern) in the p-polarized light 350 shown in FIG. 3C and the second structured light pattern (or the black pattern) in the transmitted light 360 shown in FIG. 3D.

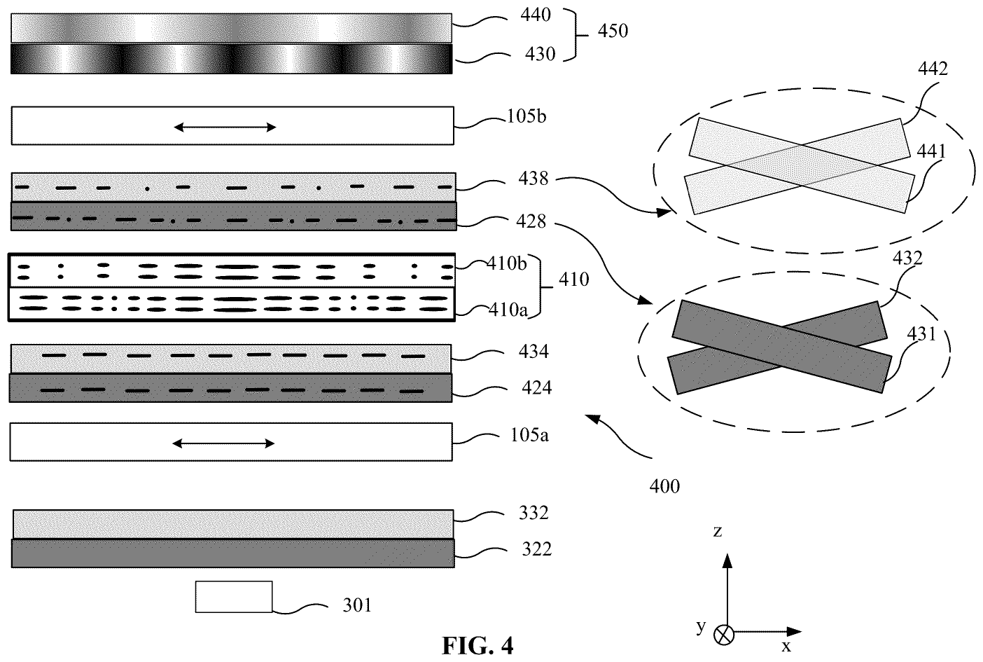

FIG. 4 illustrates an x-z sectional view of a switchable structured illumination generator 400, according to an embodiment of the present disclosure. The structured illumination generator 400 may include elements, structures, and/or functions that are the same as or similar to those included in the structured illumination generator 100 shown in FIGS. 1A and 1B, the structured illumination generator 200 shown in FIGS. 2A-2D, or the structured illumination generator 300 shown in FIGS. 3A-3D. Detailed descriptions of the same or similar elements, structures, and/or functions may refer to the above descriptions rendered in connection with FIGS. 1A and 1B, FIGS. 2A-2D, or FIGS. 3A-3D.

The structured illumination generator 400 may be wavelength multiplexed to generate structured illumination of different wavelengths or different wavelength ranges. As shown in FIG. 4, the structured illumination generator 400 may include the first polarizer 105a, a polarization hologram stack 410, and the second polarizer 105b arranged in an optical series. The polarization hologram stack 410 may be disposed between the first polarizer 105a and the second polarizer 105b. For discussion purposes, FIG. 4A shows that the various elements included in the structured illumination generator 400 are spaced apart from one another with a gap. In some embodiments, the various elements included in the structured illumination generator 400 may be disposed without a gap therebetween.

The polarization hologram stack 410 may be a wavelength multiplexed polarization hologram configured to deflect lights of multiple color channels (or multiple predetermined wavelength ranges). For example, as shown in FIG. 4, the polarization hologram stack 410 may include a plurality of polarization holograms 410a and 410b stacked together. The polarization holograms 410a and 410b may be color-selective or wavelength-selective. Each of the polarization holograms 410a and 410b may be configured to operate as a half-wave plate for one of the multiple color channels (or multiple predetermined wavelength ranges), and operate as a full-wave plate (e.g., one-wave plate, two-wave plate, three-wave plate, etc.) for each of the remaining color channels (or remaining predetermined wavelength ranges). Thus, each of the polarization holograms 410a and 410b may be configured to deflect one of the multiple color channels (or multiple predetermined wavelength ranges), and transmit, with negligible deflection, each of the remaining color channels (or remaining predetermined wavelength ranges).

For discussion purposes, FIG. 4 shows that the polarization hologram stack 410 includes a first polarization hologram 410a configured with a first design wavelength range (e.g., a first IR wavelength range) and a second polarization hologram 410b configured with a second, different, design wavelength range (e.g., a second IR wavelength range). The first polarization hologram 410a may operate as a half-wave plate for the first design wavelength range to provide a maximum diffraction efficiency for a light of the first design wavelength range, and operate as a full-wave plate (e.g., one-wave plate) for the second predetermined wavelength range to provide a minimum diffraction efficiency for a light of the second predetermined wavelength range. The second polarization hologram 410b may operate as a half-wave plate for the second design wavelength range to provide a maximum diffraction efficiency for a light of the second design wavelength range, and operate as a full-wave plate (e.g., one-wave plate) for the first predetermined wavelength range to provide a maximum diffraction efficiency for a light of the first predetermined wavelength range.

The first polarization hologram 410a and the second polarization hologram 410b may be configured to have the same in-plane orientation pattern or different in-plane orientation patterns. For example, one of the first polarization hologram 410a and the second polarization hologram 410b may be configured with an in-plane orientation pattern that is a grating pattern, and the other of the first polarization hologram 410a and the second polarization hologram 410b may be configured with an in-plane orientation pattern that is a lens pattern. In some embodiments, when the first polarization hologram 410a and the second polarization hologram 410b are configured to have the same in-plane orientation pattern, the first polarization hologram 410a and the second polarization hologram 410b may be configured to have the same in-plane pitch or different in-plane pitches, and have the same in-plane direction or different in-plane directions.

For discussion purposes, FIG. 4 shows that the first polarization hologram 410a is a first PBP grating 410a configured with the first design wavelength range, and the second polarization hologram 410b is a second PBP grating 410b configured with the second design wavelength range. The first PBP grating 410a and the second PBP grating 410b may be similar to the PBP grating 110 shown in FIGS. 1A-3D. The first PBP grating 410a and the second PBP grating 410b may be configured to have the same in-plane pitch or different in-plane pitches. The in-plane directions along which the in-plane pitches of the first PBP grating 410a and the second PBP grating 410b are respectively defined may be oriented in the same direction or different directions. For example, the in-plane direction along which the in-plane pitch of the first PBP grating 410a is defined may form an acute angle with respect to the in-plane direction along which the in-plane pitch of the second PBP grating 410b is defined. For discussion purposes, FIG. 4 shows that the first PBP grating 410a and the second PBP grating 410b have the same in-plane direction (e.g., an x-axis direction in FIG. 4), whereas the in-plane pitch of the first PBP grating 410a is smaller than the in-plane pitch of the second PBP grating 410b.

In some embodiments, the light source 301 may be coupled with the structured illumination generator 400 to provide an input light, and the structured illumination generator 400 may process the input light to generate a predetermined illumination pattern for a tracked object. In some embodiments, a lens (not shown) may be disposed between the light source 301 and the first polarizer 105a or between the first polarizer 105a and the polarization hologram stack 410. The lens (not shown) may be configured to expand the input light output from the light source 301.

In some embodiments, the controller 117 may be configured to control the light source 301 to emit the first light 322 and the second light 332 during a same time period (e.g., simultaneously) or during different time periods. In some embodiments, although not shown, two light sources (e.g., IR light sources) may be coupled with the structured illumination generator 400, and may provide the first light 322 and the second light 332, respectively. The controller 117 may control the two light sources to emit the first light 322 and the second light 332 during a same time period (e.g., simultaneously) or during different time periods.

For discussion purpose, FIG. 4 shows that the controller 117 is configured to control the light source 301 to emit the first light 322 and the second light 332 during the same time period (e.g., simultaneously). For discussion purpose, FIG. 4 shows the first light 322 along with the second light 332, which is for better illustration of the first light 322 and the second light 332. The first design wavelength range of the first PBP grating 410a may at least partially overlap with the first predetermined wavelength range and outside of the second predetermined wavelength range of the light source 301. The second design wavelength range of the second PBP grating 410b may at least partially overlap with the second predetermined wavelength range and outside of the first predetermined wavelength range of the light source 301.

The first polarizer 105a may transmit the first input light 322 and the second input light 332 as the p-polarized light 424 and the p-polarized light 434 propagating toward the polarization hologram stack 410, respectively. The first PBP grating 410a having the first design wavelength range may operate in the non-neutral state for the p-polarized light 424, thereby forwardly diffracting an RHCP component and an LHCP component of the p-polarized light 424, as an LHCP light 431 and an RHCP light 432 propagating toward the second PBP grating 410b, respectively. The LHCP light 431 and the RHCP light 432 may include a −1^{st} order diffracted light and a +1^{st} order diffracted light. The LHCP light 431 and the RHCP light 432 may interfere with one another in a spatial region to generate a superimposed wave (or light) 428, which may have a substantially uniform intensity (as denoted by the same grey color in 428) and a spatially varying linear polarization (as denoted by dash-dotted lines in 428). That is, the LHCP light 431 and the RHCP light 432 may interfere with one another in the spatial region to generate a first polarization interference pattern.

The second PBP grating 410b having the second design wavelength range may function as the full-wave plate for the superimposed wave (or light) 428, thereby transmitting, with zero or negligible diffraction, the superimposed wave (or light) 428 toward the second polarizer 105b. The second polarizer 105b may be configured to transmit the superimposed wave (or light) 428 as a p-polarized light 430. The p-polarized light 430 may have a substantially uniform linear polarization (i.e., p-polarization) and a spatially varying intensity (as denoted by different grey scales in 430, in which the darker grey indicates a higher intensity, and the lighter grey indicates a lower intensity). A pattern of the spatially varying intensity of the p-polarized light 430 may correspond to a first intensity interference pattern having a plurality of interference fringes of varying intensities. That is, the second polarizer 105b may be configured to convert the first polarization interference pattern generated by the interference (or superposition) of the LHCP light 431 and the RHCP light 432 into the first intensity interference pattern, which may provide the first illumination pattern for a tracked object. For example, FIG. 4 shows that the first illumination pattern may be a first structured light pattern (or fringe pattern, or structured illumination) including first striped lines (or fringes) of various intensities interposed according to a first predetermined pattern. The first structured light pattern may be in the wavelength range within the first predetermined wavelength range and outside of the second predetermined wavelength range.

The first PBP grating 410a having the first design wavelength range may function as the full-wave plate for the p-polarized light 434, thereby transmitting, with zero or negligible diffraction, the p-polarized light 434 toward the second PBP grating 410b. The second PBP grating 410b may operate in the non-neutral state for the p-polarized light 434, thereby forwardly diffracting an RHCP component and an LHCP component of the p-polarized light 434 as an LHCP light 441 and an RHCP light 442 propagating toward the second polarizer 105b, respectively. The LHCP light 441 and the RHCP light 442 may include a −1^{st} order diffracted light and a +1^{st} order diffracted light. The LHCP light 441 and the RHCP light 442 may interfere with one another in a spatial region to generate a superimposed wave (or light) 438, which may have a substantially uniform intensity (as denoted by the same grey color in 438) and a spatially varying linear polarization (as denoted by dash-dotted lines in 438). That is, the LHCP light 441 and the RHCP light 442 may interfere with one another in the spatial region to generate a second polarization interference pattern.

The second polarizer 105b may be configured to transmit the superimposed wave (or light) 438 as a p-polarized light 440. The p-polarized light 440 may have a substantially uniform linear polarization (i.e., p-polarization) and a spatially varying intensity (as denoted by different grey scales in 440, in which the darker grey indicates a higher intensity, and the lighter grey indicates a lower intensity). A pattern of the spatially varying intensity of the p-polarized light 440 may correspond to a second intensity interference pattern having a plurality of interference fringes of varying intensities. That is, the second polarizer 105b may be configured to convert the second polarization interference pattern generated by the interference (or superposition) of the LHCP light 441 and the RHCP light 442 into the second intensity interference pattern, which may provide the second illumination pattern for the tracked object. For example, FIG. 4 shows that the second illumination pattern may be a second structured light pattern (or fringe pattern, or structured illumination) including second striped lines (or fringes) of various intensities interposed according to a second predetermined pattern. The second structured light pattern may be in the wavelength range within the second predetermined wavelength range and outside of the first predetermined wavelength range.

The first structured light pattern associated with the p-polarized light 430 may be different from the second structured light pattern associated with the p-polarized light 440. For example, the first structured light pattern and the second structured light pattern may have striped lines (or fringes) arranged in different periods, and/or different patterns, or different orientations. For discussion purposes, FIG. 4 shows that the first fringes in the first structured light pattern and the second fringes in the second structured light pattern are arranged in grating (or periodic) patterns with different grating periods, e.g., the second structured light pattern has a greater grating period than the first structured light pattern. For discussion purposes, FIG. 4 shows that the first fringes and the second fringes are arranged in parallel in the same direction (e.g., an x-axis direction), and extend in the same direction (e.g., a y-axis direction). That is, a first extension direction of the first fringes may be parallel with a second extension direction of the second fringes. In some embodiments, although not shown, the first fringes and the second fringes may extend in different directions, e.g., a first extension direction of the first fringes may form an angle (e.g., 90° or another suitable angle) with respect to a second extension direction of the second fringes.

An overall structured light pattern 450 generated by the structured illumination generator 400 may be a superposition of the first structured light pattern and the second structured light pattern of different wavelength ranges. For example, the overall structured light pattern 450 may be a superposition of the first structured light pattern of the first IR wavelength range (e.g., 850 nm) and the second structured light pattern of the second IR wavelength range (e.g., 940 nm).

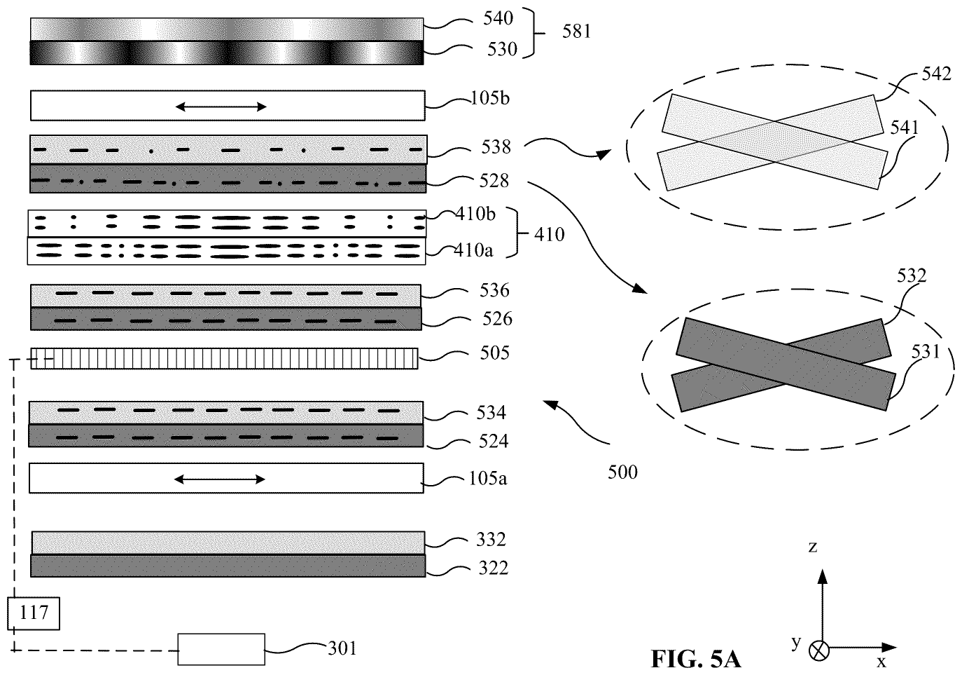

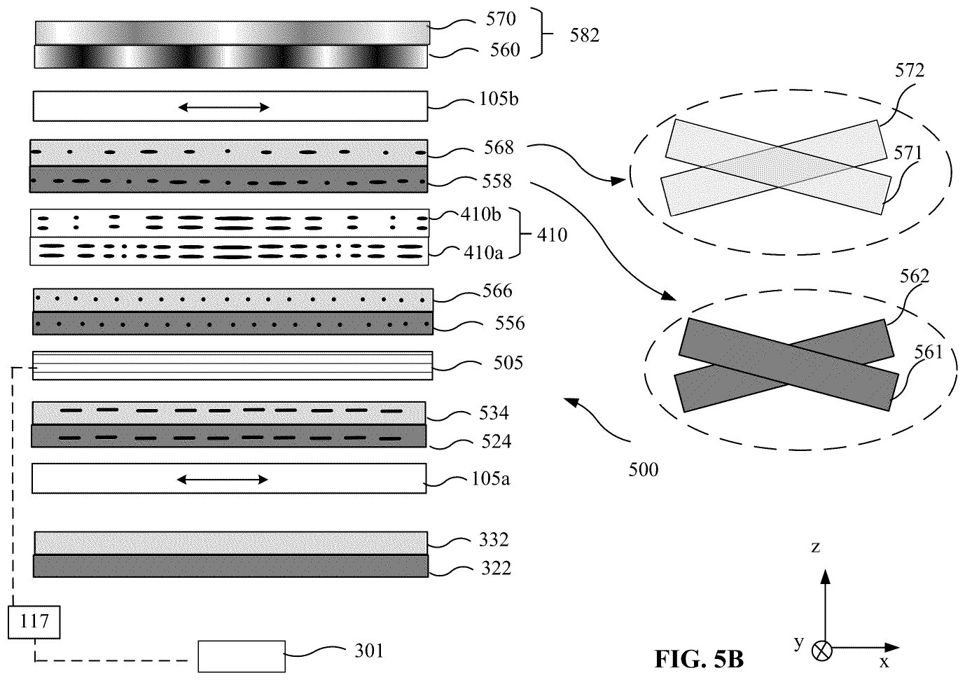

FIGS. 5A and 5B illustrate x-z sectional views of a switchable structured illumination generator 500, according to an embodiment of the present disclosure. The structured illumination generator 500 may include elements, structures, and/or functions that are the same as or similar to those included in the structured illumination generator 100 shown in FIGS. 1A and 1B, the structured illumination generator 200 shown in FIGS. 2A-2D, the structured illumination generator 300 shown in FIGS. 3A-3D, or the structured illumination generator 400 shown in FIG. 4. Detailed descriptions of the same or similar elements, structures, and/or functions may refer to the above descriptions rendered in connection with FIGS. 1A and 1B, FIGS. 2A-2D, FIGS. 3A-3D, or FIG. 4.

The structured illumination generator 500 may be wavelength multiplexed to generate structured illumination of different wavelengths or different wavelength ranges. As shown in FIG. 5A, the structured illumination generator 500 may include the first polarizer 105a, the polarization hologram stack 410, a polarization switch 505, and the second polarizer 105b arranged in an optical series. The polarization switch 505 may be disposed between the first polarizer 105a and the polarization hologram stack 410. The polarization hologram stack 410 may be disposed between the polarization switch 505 and the second polarizer 105b. For discussion purposes, FIG. 5A shows that the various elements included in the structured illumination generator 500 are spaced apart from one another with a gap. In some embodiments, the various elements included in the structured illumination generator 500 may be disposed without a gap therebetween.

The polarization switch 505 may be similar to the polarization switch 205 shown in FIGS. 2A-2D. The polarization switch 505 may be configured to control the polarization of an input light of the polarization hologram stack 410. In some embodiments, a design wavelength range (or an operation wavelength range) of the polarization switch 505 may at least partially overlap with the design wavelength range of the polarization hologram stack 410. In some embodiments, the operation wavelength range of the polarization switch 505 may substantially overlap with the design wavelength range of the polarization hologram stack 410. For example, when the polarization hologram stack 410 includes the first polarization hologram layer (e.g., the first PBP grating) 410a having the first design wavelength range and the second polarization hologram layer (e.g., the second PBP grating) 410b having the second design wavelength range, the design wavelength range of the polarization switch 505 may include both the first design wavelength range and the second design wavelength range.

The controller 117 may be communicatively connected with the polarization switch 505. The controller 117 may control an optical state of the polarization hologram stack 410 and an operation state of the polarization switch 505, thereby controlling an operation state of the structured illumination generator 500. In some embodiment, the controller 117 may control the polarization switch 505 to switch between operating in a switching state and a non-switching state. For a linearly polarized input light having a wavelength range within the first design wavelength range of the first PBP grating 410a or the second design wavelength range of the second PBP grating 410b, the polarization switch 505 operating in the switching state may change the polarization of the linearly polarized input light to an orthogonal polarization while transmitting the linearly polarized input light. That is, the linearly polarized input light and the linearly polarized output light of the polarization switch 505 may have orthogonal linear polarizations. The polarization switch 505 operating in the non-switching state may maintain the polarization of the linearly polarized input light while transmitting the linearly polarized input light. That is, the linearly polarized input light and the linearly polarized output light of the polarization switch 505 may have the same polarization.

In some embodiments, the light source 301 may be coupled with the structured illumination generator 500 to provide an input light, and the structured illumination generator 500 may process the input light to generate a predetermined illumination pattern for a tracked object. In some embodiments, a lens (not shown) may be disposed between the light source 301 and the first polarizer 105a or between the first polarizer 105a and the polarization switch 505. The lens (not shown) may be configured to expand the input light output from the light source 301.

In some embodiments, the controller 117 may be configured to control the light source 301 to emit the first light 322 and the second light 332 during a same time period (e.g., simultaneously) or during different time periods. In some embodiments, although not shown, two light sources (e.g., IR light sources) may be coupled with the structured illumination generator 500, and may provide the first light 322 and the second light 332, respectively. The controller 117 may control the two light sources to emit the first light 322 and the second light 332 during a same time period (e.g., simultaneously) or during different time periods.

FIG. 5A shows that the switchable structured illumination generator 500 is configured to operate at a first operation state to provide a first illumination pattern 581, and FIG. 5B shows that the switchable structured illumination generator 500 is configured to operate at a second operation state to provide a second illumination pattern 582. The structured illumination generator 500 may be switchable between operating in the first operation state and operating in the second operation state. The controller 117 may be configured to switch the structured illumination generator 500 between operating in the first operation state and operating in the second operation state via switching the polarization switch 505 between operating at the non-switching state and operating at the switching state.

For discussion purpose, FIGS. 5A and 5B show that the controller 117 is configured to control the light source 301 to emit the first light 322 and the second light 332 during the same sub-frame (e.g., simultaneously). For discussion purpose, FIGS. 5A and 5B show the first light 322 along with the second light 332, which is for better illustration of the first light 322 and the second light 332. As shown in FIG. 5A, during a first sub-frame of a frame, the controller 117 may control the polarization switch 505 to operate at the non-switching state, and control the light source 301 to output the first input light 322 and the second input light 332 toward the first polarizer 105a. The first polarizer 105a may transmit the first input light 322 and the second input light 332 as a p-polarized light 524 and a p-polarized light 534 propagating toward the polarization switch 505, respectively. The polarization switch 505 operating at the non-switching state may transmit the p-polarized light 524 and the p-polarized light 534 as a p-polarized light 526 and a p-polarized light 536 propagating toward the polarization hologram stack 410, respectively.

The first PBP grating 410a having the first operation wavelength range may forwardly diffract an RHCP component and an LHCP component of the p-polarized light 526, as an LHCP light 531 and an RHCP light 532 propagating toward the second PBP grating 410b, respectively. The LHCP light 531 and the RHCP light 532 may interfere with one another in a spatial region to generate a superimposed wave (or light) 528, which may have a substantially uniform intensity (as denoted by the same grey color in 528) and a spatially varying linear polarization (as denoted by dash-dotted lines in 528). That is, the LHCP light 531 and the RHCP light 532 may interfere with one another in the spatial region to generate a first polarization interference pattern.

The second PBP grating 410b having the second operation wavelength range may function as the full-wave plate for the superimposed wave (or light) 528, thereby transmitting, with zero or negligible diffraction, the superimposed wave (or light) 528 toward the second polarizer 105b. The second polarizer 105b may be configured to transmit the superimposed wave (or light) 528 as a p-polarized light 530. The p-polarized light 530 may have a substantially uniform linear polarization (i.e., p-polarization) and a spatially varying intensity (as denoted by different grey scales in 530, in which the darker grey indicates a higher intensity, and the lighter grey indicates a lower intensity). A pattern of the spatially varying intensity of the p-polarized light 530 may correspond to a first intensity interference pattern having a plurality of interference fringes of varying intensities interposed according to a first predetermined pattern.

The first PBP grating 410a having the first operation wavelength range may function as the full-wave plate for the p-polarized light 536, thereby transmitting, with zero or negligible diffraction, the p-polarized light 536 toward the second PBP grating 410b. The second PBP grating 410b may forwardly diffract an RHCP component and an LHCP component of the p-polarized light 536 as an LHCP light 541 and an RHCP light 542, respectively. The LHCP light 541 and the RHCP light 542 may interfere with one another in a spatial region to generate a superimposed wave (or light) 538, which may have a substantially uniform intensity (as denoted by the same grey color in 538) and a spatially varying linear polarization (as denoted by dash-dotted lines in 538). That is, the LHCP light 541 and the RHCP light 542 may interfere with one another in the spatial region to generate a second polarization interference pattern.

The second polarizer 105b may be configured to transmit the superimposed wave (or light) 538 as a p-polarized light 540. The p-polarized light 540 may have a substantially uniform linear polarization (i.e., p-polarization) and a spatially varying intensity (as denoted by different grey scales in 540, in which the darker grey indicates a higher intensity, and the lighter grey indicates a lower intensity). A pattern of the spatially varying intensity of the p-polarized light 540 may correspond to a second intensity interference pattern having a plurality of interference fringes of varying intensities interposed according to a second predetermined pattern.

The first intensity interference pattern associated with the p-polarized light 530 may be different from the second intensity interference pattern associated with the p-polarized light 540. For example, FIG. 5A shows that the first intensity interference pattern has a shorter grating period than the second intensity interference pattern. For discussion purpose, the first intensity interference pattern may be referred to as a positive fringe pattern, and the second intensity interference pattern may be referred to as a negative fringe pattern. An overall structured light pattern generated by the structured illumination generator 500 during the first sub-frame, i.e., the first illumination pattern 581, may be a superposition of the first intensity interference pattern and the second intensity interference pattern of different wavelength ranges. For example, the first illumination pattern 581 may be a superposition of the first intensity interference pattern of the first IR wavelength range (e.g., 850 nm) and the second intensity interference pattern of the second IR wavelength range (e.g., 940 nm).

As shown in FIG. 5B, during a second sub-frame of the frame, the controller 117 may control the polarization switch 505 to operate at the switching state, and control the light source 301 to output the first input light 322 and the second input light 332 toward the first polarizer 105a. The first polarizer 105a may transmit the first input light 322 and the second input light 332 as the p-polarized light 524 and the p-polarized light 534 propagating toward the polarization switch 505, respectively. The polarization switch 505 operating at the switching state may convert the p-polarized light 524 and the p-polarized light 534 into an s-polarized light 556 and an s-polarized light 566 propagating toward the polarization hologram stack 410, respectively.

The first PBP grating 410a having the first operation wavelength range may forwardly diffract an RHCP component and an LHCP component of the p-polarized light 556, as an LHCP light 561 and an RHCP light 562 propagating toward the second PBP grating 410b, respectively. The LHCP light 561 and the RHCP light 562 may interfere with one another in a spatial region to generate a superimposed wave (or light) 558, which may have a substantially uniform intensity (as denoted by the same grey color in 558) and a spatially varying linear polarization (as denoted by dash-dotted lines in 558). That is, the LHCP light 561 and the RHCP light 562 may interfere with one another in the spatial region to generate a third polarization interference pattern.

The second PBP grating 410b having the second operation wavelength range may function as the full-wave plate for the superimposed wave (or light) 558, thereby transmitting, with zero or negligible diffraction, the superimposed wave (or light) 558 toward the second polarizer 105b. The second polarizer 105b may be configured to transmit the superimposed wave (or light) 558 as a p-polarized light 560. The p-polarized light 560 may have a substantially uniform linear polarization (i.e., p-polarization) and a spatially varying intensity (as denoted by different grey scales in 560, in which the darker grey indicates a higher intensity, and the lighter grey indicates a lower intensity). A pattern of the spatially varying intensity of the p-polarized light 560 may correspond to a third intensity interference pattern having a plurality of interference fringes of varying intensities interposed according to a third predetermined pattern.

The first PBP grating 410a having the first operation wavelength range may function as the full-wave plate for the s-polarized light 566, thereby transmitting, with zero or negligible diffraction, the s-polarized light 566 toward the second PBP grating 410b. The second PBP grating 410b may forwardly diffract an RHCP component and an LHCP component of the s-polarized light 566 as an LHCP light 571 and an RHCP light 572, respectively. The LHCP light 571 and the RHCP light 572 may interfere with one another in a spatial region to generate a superimposed wave (or light) 568, which may have a substantially uniform intensity (as denoted by the same grey color in 568) and a spatially varying linear polarization (as denoted by dash-dotted lines in 568). That is, the LHCP light 571 and the RHCP light 572 may interfere with one another in the spatial region to generate a fourth polarization interference pattern.

The second polarizer 105b may be configured to transmit the superimposed wave (or light) 568 as a p-polarized light 570. The p-polarized light 570 may have a substantially uniform linear polarization (i.e., p-polarization) and a spatially varying intensity (as denoted by different grey scales in 570, in which the darker grey indicates a higher intensity, and the lighter grey indicates a lower intensity). A pattern of the spatially varying intensity of the p-polarized light 570 may correspond to a fourth intensity interference pattern having a plurality of interference fringes of varying intensities interposed according to a second predetermined pattern.

The third intensity interference pattern associated with the p-polarized light 560 may be different from the fourth intensity interference pattern associated with the p-polarized light 570. For discussion purpose, the third intensity interference pattern may be referred to as a positive fringe pattern, and the fourth intensity interference pattern may be referred to as a negative fringe pattern. An overall structured light pattern generated by the structured illumination generator 500 during the second sub-frame, i.e., the second illumination pattern 582, may be a superposition of the third intensity interference pattern and the fourth intensity interference pattern of different wavelength ranges. For example, the second illumination pattern 582 may be a superposition of the third intensity interference pattern of the first IR wavelength range (e.g., 850 nm) and the fourth intensity interference pattern of the second IR wavelength range (e.g., 940 nm).

In some embodiments, although not shown, the controller 117 may also be configured to control the first PBP grating 410a and the second PBP grating 410b to operate in the neutral state during the time period (e.g., simultaneously). For example, when the controller 117 is configured to control the first PBP grating 410a and the second PBP grating 410b to operate in the neutral state during the time period and control the polarization switch 505 to operate in the non-switching state, the structured illumination generator 500 may provide an overall flood pattern, which is a superposition of a first flood pattern of the first IR wavelength range (e.g., 850 nm) and a second flood pattern of the second IR wavelength range (e.g., 940 nm). In some embodiments, when the controller 117 is configured to control the first PBP grating 410a and the second PBP grating 410b to operate in the neutral state during the time period and control the polarization switch 505 to operate in the switching state, the structured illumination generator 500 may provide a black pattern.

In some embodiments, the controller 117 may be configured to control the first PBP grating 410a and the second PBP grating 410b to operate in the neutral state during different times periods. For example, the controller 117 may be configured to control one of the first PBP grating 410a and the second PBP grating 410b to operate in the neutral state and the other one of the first PBP grating 410a and the second PBP grating 410b to operate in the non-neutral state. The structured illumination generator 500 may provide a flood pattern superposed with a structured light pattern, or a black pattern superposed with a structured light pattern.

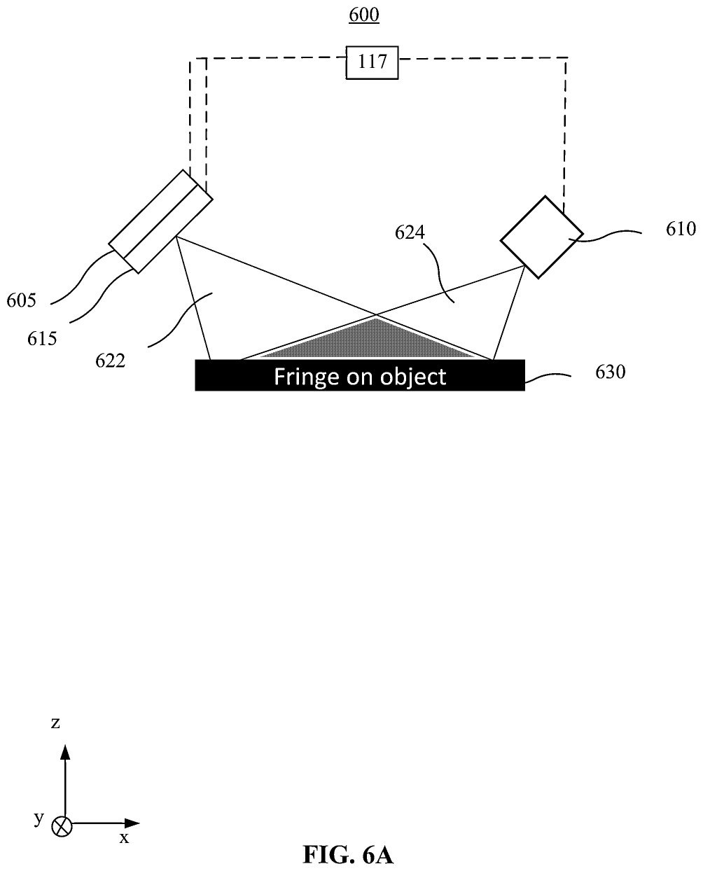

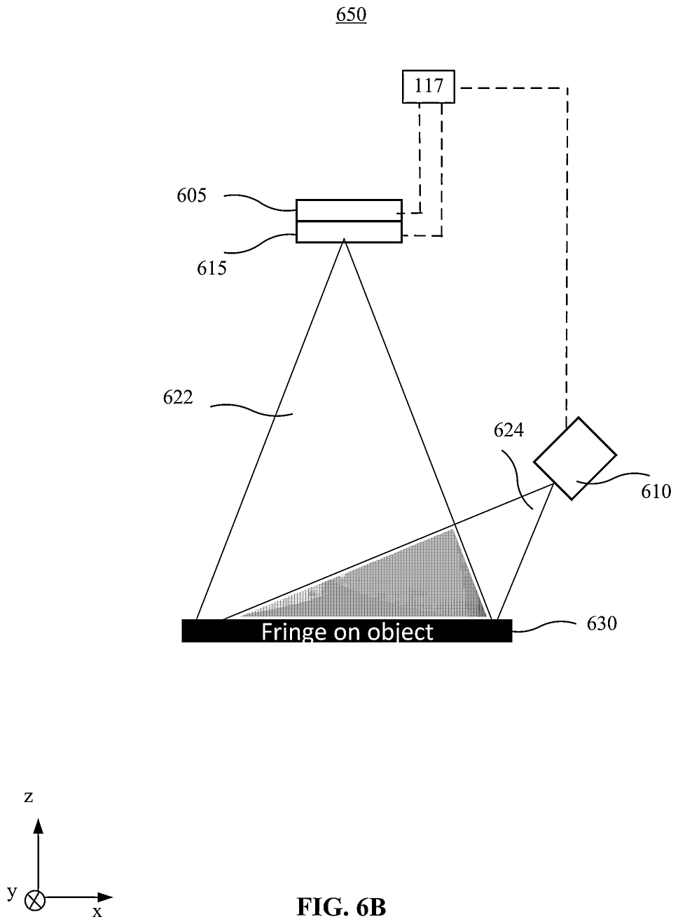

FIG. 6A illustrates an x-y sectional view of an object tracking system 600, according to an embodiment of the present disclosure. FIG. 6B illustrates an x-y sectional view of an object tracking system 650, according to an embodiment of the present disclosure. The object tracking system 600 or 650 may include a switchable structured illumination generator disclosed herein, such as the structured illumination generator 100 shown in FIGS. 1A and 1B, the structured illumination generator 200 shown in FIGS. 2A-2D, the structured illumination generator 300 shown in FIGS. 3A-3D, the structured illumination generator 400 shown in FIG. 4, or the structured illumination generator 500 shown in FIGS. 5A and 5B. The object tracking systems 600 and 650 shown in FIGS. 6A and 6B are for illustrative purposes, a switchable structured illumination generator disclosed herein may be implemented into another suitable object tracking system to enhance the tracking range and improve the tracking accuracy.

As shown in FIGS. 6A and 6B, the object tracking system 600 or 650 may include a light source assembly 605, a switchable structured illumination generator 615 coupled with the light source assembly 605, an optical sensor 610, and the controller 117. The controller 117 may be communicatively connected with and control the operations of the various elements included in the object tracking system 600 or 650, such as the light source assembly 605, the switchable structured illumination generator 615, and the optical sensor 610.

The light source assembly 605 may include one or more light sources, e.g., similar to the light source 310 shown in FIGS. 3A-5B. The light source assembly 605 may be configured to emit one or more infrared (“IR”) lights of different wavelengths or wavelength ranges toward the switchable structured illumination generator 615. The IR lights are invisible to the human eyes and thus, do not distract the user during operations. In some embodiments, the light source assembly 605 may include one or more IR LEDs, or one or more IR lasers, etc. In some embodiments, the light source assembly 605 may also include a lens configured to expand the IR light output from the one or more light sources.

The switchable structured illumination generator 615 may be an embodiment of the switchable structured illumination generator disclosed herein, such as the structured illumination generator 100 shown in FIGS. 1A and 1B, the structured illumination generator 200 shown in FIGS. 2A-2D, the structured illumination generator 300 shown in FIGS. 3A-3D, the structured illumination generator 400 shown in FIG. 4, or the structured illumination generator 500 shown in FIGS. 5A and 5B. The switchable structured illumination generator 615 may be configured to convert the one or more IR lights received from the light source assembly 605 into an IR light 622 for illuminating an object 630. The IR light 622 may provide an intensity-based structured light pattern for illuminating the object 630. In some embodiments, the IR light 622 may also be switched to provide a flood illumination pattern or a black illumination pattern. The object 630 may distort the structured light pattern, and reflect the IR light 622 as an IR light 624 including the distortions in the structured light pattern.

The optical sensor 610 may receive the IR light 624 reflected from the object 630, and generate one or more images of the object 630 illuminated by the IR light 622. In some embodiments, the depth information of the object 630 may be extracted from the one or more images. In some embodiments, the optical sensor 610 may include a camera, or a photodiode, etc., such as one or more of a charge-coupled device (“CCD”) camera, a complementary metal-oxide-semiconductor (“CMOS”) sensor, an N-type metal-oxide-semiconductor (“NMOS”) sensor, or any other optical sensors. In some embodiments, the optical sensor 610 may also be referred to as an imaging device.

In the embodiment shown in FIG. 6A, the light source assembly 605 may provide an off-axis illumination to the object 630. For example, the light source assembly 605 may be disposed off-axis with respect to the object 630, and the IR light 622 output from the switchable structured illumination generator 615 may be obliquely or off-axis incident onto the object 630. In the embodiment shown in FIG. 6B, the light source assembly 605 may provide an on-axis illumination to the object 630. For example, the light source assembly 605 may be disposed on-axis with respect to the object 630, and the IR light 622 output from the switchable structured illumination generator 615 may be on-axis incident onto the object 630.

In some embodiments, the object 630 may be an eye of a user, the light source assembly 605 may be positioned out of a line of sight of the user (e.g., above and in front of the eye), and the optical sensor 610 may be positioned out of a line of sight of the user. In some embodiments, the optical sensor 610 may include a processor configured to process the IR light 624 reflected from the eye to generate an image of the eye. In some embodiments, the optical sensor 610 may further analyze the generated image of the eye to obtain the depth information of the eye (and/or the face). In some embodiments, the optical sensor 610 may further analyze the generated image of the eye to obtain information that may be used for eye tracking and other purposes, such as for determining what information to present to the user, for configuring the layout of the presentation of the information, for addressing vergence-accommodation conflict, etc. In some embodiments, the optical sensor 610 may also include a non-transitory computer-readable storage medium (e.g., a computer-readable memory) configured to store data, such as the generated images. In some embodiments, the non-transitory computer-readable storage medium may store codes or instructions that may be executable by the processor to perform various steps of any methods disclosed herein.

FIG. 8A illustrates an x-z sectional view of a polarization hologram 800, according to an embodiment of the present disclosure. The polarization hologram 800 may be an embodiment of the polarization hologram 100 shown in FIGS. 1A-3D, and the polarization hologram 410a or 410b shown in FIGS. 4-5B. As shown in FIG. 8A, the polarization hologram 800 may include a first substrate 805a and a second substrate 805b, and a birefringent medium layer 815 disposed between the first and second substrates 805a and 805b. The polarization hologram 800 may include a first alignment structure 810a and a second alignment structure 810b, which may be disposed at two inner surfaces of the first and second substrates 805a and 805b that face each other, respectively. The birefringent medium layer 815 may be in contact with both of the first and second alignment structures 810a and 810b. The substrates 805a and 805b may be configured to provide support and/or protection to various layers, films, and/or structures disposed at (e.g., on or between) the substrate 805a and 805b. In some embodiments, at least one of the first substrate 805a or the second substrate 805b may be optically transparent in at least the IR spectrum. The substrates 805a and 805b may be rigid, semi-rigid, flexible, or semi-flexible. The polarization hologram 800 may be a passive element or an active element (e.g., an electrically tunable element).

When the polarization hologram 800 is an active element, as shown in FIG. 8A, the polarization hologram 800 may also include a first electrode layer 807a and a second electrode layer 807b. The first and second electrode layers 807a and 807b may be configured to apply a driving voltage provided by a power source 830 to the birefringent medium layer 815, thereby controlling an operation state of the polarization hologram 800. In some embodiments, the polarization hologram 800 may be a passive element, and the first electrode layer 807a and the second electrode layer 807b may be omitted. In some embodiments, as shown in FIG. 8A, the first electrode layer 807a may be disposed between the first substrate 805a and the first alignment structure 810a, and the second electrode layer 807b may be disposed between the second substrate 805b and the second alignment structure 810b. The first electrode layer 807a or the second electrode layer 807b may be a continuous planar electrode layer, a patterned planar electrode layer, a protrusion electrode layer, or any other suitable type of electrode layer. In some embodiments, both of the first electrode layer 807a and the second electrode layer 807b may be disposed at the same substrate (e.g., at the first substrate 805a or the second substrate 805b) with an electrical insulating layer disposed therebetween. The first electrode layer 807a or the second electrode layer 807b may include a suitable conductive material.

The birefringent medium layer 815 may have the first surface 815-1 and the opposing second surface 815-2. In some embodiments, the first surface 815-1 and the second surface 815-2 may be substantially parallel surfaces. Although the body of the birefringent medium layer 815 is shown as flat for illustrative purposes, the body of the birefringent medium layer 815 may have a curved shape. For example, at least one (e.g., each) of the first surface 815-1 and the second surface 815-2 may be curved. The birefringent medium layer 815 may include a birefringent medium, such as liquid crystals (e.g., active LCs, a liquid crystal polymer, etc.), an amorphous polymer, an organic solid crystal, or a combination thereof, etc. In some embodiments, the birefringent medium may include nematic LCs, twist-bend LCs, chiral nematic LCs, smectic LCs, ferroelectric LCs, etc., or any combination thereof. The birefringent medium layer 815 may have a uniform thickness or a varying thickness. The birefringent medium layer 815 may include optically anisotropic molecules 812. Calamitic (rod-like) LC molecules 812 are used as examples of optically anisotropic molecules 812. The rod-like LC molecule may have a longitudinal direction (or a length direction) and a lateral direction (or a width direction). The longitudinal direction of the LC molecule 812 may be referred to as a director of the LC molecule or an LC director. An orientation of the LC director may represent the orientation of the LC molecule. The orientation of the LC director may determine a local optic axis orientation (or an orientation of the optic axis) at a local point of the birefringent medium layer 815.

The first alignment structure 810a or the second alignment structure 810b may be configured to provide a surface alignment to the LC molecules 812 located in close proximity to a surface of the respective alignment structure. In some embodiments, the first alignment structure 810a and the second alignment structure 810b may be configured to provide parallel surface alignments, anti-parallel surface alignments, or hybrid surface alignments (e.g., one providing a homogeneous surface alignment and the other providing a homeotropic surface alignment) to the LC molecules 812 in contact with the alignment structures. The first and second alignment structures 810a and 810b shown in FIG. 8A may be any suitable alignment structures. For example, at least one (e.g., each) of the first alignment structure 810a or the second alignment structure 810b may include a polyimide layer, a photo-alignment material (“PAM”) layer, a plurality of nanostructures or microstructures, an alignment network, or any combination thereof.

The LC molecules 812 located in close proximity to a surface (e.g., at least one of the first surface 815-1 or the second surface 815-2) of the birefringent medium layer 815 may be aligned in a predetermined in-plane orientation pattern according to the predetermined surface alignment pattern. In some embodiments, the LC molecules 812 within a film plane (e.g., within a plane in close proximity to the surface of the birefringent medium layer 815 may also exhibit the predetermined in-plane orientation pattern. The predetermined in-plane orientation pattern may be non-uniform in-plane orientation pattern, etc. The non-uniform in-plane orientation pattern means that the orientations of the LC molecules 812 distributed along one or more in-plane directions may change in the one or more in-plane directions. Depending on the in-plane orientation pattern, the polarization hologram 800 may function as a circular reflective polarizer, a waveplate or phase retarder, a grating, a lens, a freeform phase plate, etc.

FIGS. 8B-8E schematically illustrate x-y sectional views of a portion of the polarization hologram 800 shown in FIG. 8A, showing in-plane orientations of the optically anisotropic molecules 812 in the polarization hologram 800, according to various embodiments of the present disclosure. In the embodiment shown in FIG. 8B, the directors of the LC molecules 812 located in close proximity to the surface of the birefringent medium layer 815 may exhibit a periodic, continuous rotation in a predetermined in-plane direction within the surface, e.g., the x-axis direction. The continuous rotation of the LC directors may form a periodic rotation pattern with a uniform (e.g., same) in-plane pitch Pᵢₙ. It is noted that the predetermined in-plane direction may be any other suitable direction within the surface, such as the y-axis direction, the radial direction, or the circumferential direction within the x-y plane. The in-plane pitch (or horizontal pitch) Pᵢₙ may be defined as a distance along the predetermined in-plane direction (e.g., the x-axis) over which the orientations of the LC directors exhibit a rotation by a predetermined angle (e.g., 180°). The periodically varying in-plane orientations of the LC directors shown in FIG. 8B may be referred to as a grating pattern.

In addition, within the surface of the birefringent medium layer 815, the orientations of the directors of the LC molecules 812 may rotate along the predetermined in-plane direction (e.g., the x-axis) in a predetermined rotation direction, e.g., a clockwise direction or a counter-clockwise direction. Accordingly, the rotation of the orientations of the directors of the LC molecules 812 along the predetermined in-plane direction (e.g., the x-axis) may exhibit a handedness, e.g., right handedness or left handedness. For discussion purposes, FIG. 8B shows that the orientations of the directors of the LC molecules 812 may rotate along the predetermined in-plane direction (e.g., the x-axis) in a clockwise direction, exhibiting a left handedness. Although not shown in FIG. 8B, in some embodiments, the orientations of the directors of the LC molecules 812 located in close proximity to the surface of the birefringent medium layer 815 may exhibit a rotation in a counter-clockwise direction. Accordingly, the rotation of the orientations of the directors of the LC molecules 812 may exhibit a right handedness.

In the embodiment shown in FIG. 8C, the in-plane orientation pattern of the LC directors may be referred to as a lens pattern (e.g., a spherical lens pattern). As shown in FIG. 8C, the orientations of the LC directors of LC molecules 812 located in close proximity to the surface of the birefringent medium layer 815 may exhibit a continuous rotation in at least two opposite in-plane directions from a lens pattern center 850 to opposite lens pattern peripheries 855 with a varying pitch. The orientations of the LC directors may exhibit a rotation in the same rotation direction (e.g., clockwise, or counter-clockwise) from the lens pattern center 850 to the opposite lens pattern peripheries 855.

The in-plane pitch A of the in-plane orientation pattern may be defined as a distance in the in-plane direction (e.g., a radial direction) over which the orientations of the LC directors (or azimuthal angles ϕ of the LC molecules 812) change by a predetermined angle (e.g., 180°) from a predetermined initial state. FIG. 8D illustrates a section of the in-plane orientation pattern taken along an x-axis in the birefringent medium layer 815 shown in FIG. 8C, according to an embodiment of the present disclosure. As shown in FIG. 8D, according to the LC director field along the x-axis direction, the pitch Λ may be a function of the distance from the lens pattern center 850. The pitch Λ may monotonically decrease from the lens pattern center 850 to the lens pattern peripheries 855 in the at least two opposite in-plane directions (e.g., two opposite radial directions) in the x-y plane, e.g., Λ₀>Λ₁> . . . >Λᵣ. Λ₀ is the pitch at a central region of the lens pattern, which may be the largest. The pitch Λᵣ is the pitch at a periphery region (e.g., lens pattern periphery 855) of the lens pattern, which may be the smallest. In some embodiments, the azimuthal angle ϕ of the LC molecule 812 may change in proportional to the distance from the lens pattern center 850 to a local point of the birefringent medium layer 815 at which the LC molecule 812 is located.

In the embodiment shown in FIG. 8E, the in-plane orientation pattern of the LC directors may be referred to as a lens pattern (e.g., a cylindrical lens pattern). As shown in FIG. 8E, the polarization hologram 800 is shown as having a rectangular shape (or a rectangular lens aperture). A width direction of polarization hologram 800 may be referred to as a lateral direction (e.g., an x-axis direction in FIG. 8E), and a length direction of the polarization hologram 800 may be referred to as a longitudinal direction (e.g., a y-axis direction in FIG. 8E). In the embodiment shown in FIG. 8E, the orientations of the LC molecules 812 located in close proximity to the surface of the birefringent medium layer 815 may be configured with an in-plane orientation pattern having a varying pitch in at least two opposite lateral directions, from the lens pattern center (“O_{L}”) 850 to the opposite lens pattern peripheries 855. The orientations of the LC directors of the LC molecules 812 located on the same side of an in-plane lens pattern center axis 863 and at a same distance from the in-plane lens pattern center axis 863 may be substantially the same. The rotations of the orientations of the LC directors from the lens pattern center 850 to the opposite lens pattern peripheries 855 in the two opposite lateral directions may exhibit a same handedness (e.g., right, or left handedness).

In the embodiment shown in FIG. 8E, the directors of the LC molecules 812 may be configured with a continuous in-plane rotation pattern with a varying pitch (Λ₀, Λ₁, . . . , Λᵣ) from the lens pattern center 850 to opposite lens pattern peripheries 855 in the two opposite lateral directions. As shown in FIG. 8E, the pitch of the lens pattern may vary with the distance to the in-plane lens pattern center axis 863 in the lateral direction. In some embodiments, the pitch of the lens pattern may monotonically decrease as the distance to the in-plane lens pattern center axis 863 in the lateral direction increases, i.e., Λ₀>Λ₁> . . . >Λᵣ, where Λ₀ is the pitch at a central portion of the lens pattern, which may be the largest. The pitch Λᵣ is the pitch at an edge or periphery region of the lens pattern, which may be the smallest. The cylindrical lens with the in-plane orientation pattern shown in FIG. 8E may be considered as a 1D example of the spherical lens with the in-plane orientation pattern shown in FIGS. 8C and 8D, and the at least two opposite in-plane directions in the polarization hologram 800 may include at least two opposite lateral directions (e.g., the +x-axis and −x-axis directions).

FIGS. 8F and 8G schematically illustrate x-z sectional views of a portion of the polarization hologram 800 shown in FIG. 8A, showing out-of-plane orientations of the optically anisotropic molecules 812 in the polarization hologram 800, according to various embodiments of the present disclosure. For discussion purposes, FIGS. 8F and 8G schematically illustrate out-of-plane (e.g., along z-axis direction) orientations of the LC directors of the LC molecules 812 when the in-plane (e.g., in a plane parallel to the x-y plane) orientation pattern is a periodic in-plane orientation pattern shown in FIG. 8B. In the embodiment shown in FIG. 8F, within a volume of the birefringent medium layer 815, along the thickness direction (e.g., the z-axis direction) of the birefringent medium layer 815, the directors (or the azimuth angles ϕ) of the LC molecules 812 may have a substantially same orientation (or value) from the first surface 815-1 to the second surface 815-2. In some embodiments, although not shown, within the volume of the birefringent medium layer 815, along the thickness direction (e.g., the z-axis direction) of the birefringent medium layer 815, the LC directors may twist to a certain degree from the first surface 815-1 to a certain height across the LC layer, then twist back to the second surface 815-2.

In the embodiment shown in FIG. 8E, within the volume of birefringent medium layer 815, the LC molecules 812 may be arranged in a plurality of helical structures 817 with a plurality of helical axes 818 and a helical pitch Pₕ. The orientations of the LC directors of the LC molecules 812 arranged along a single helical structure 817 may exhibit a continuous rotation around the helical axis 818 in a predetermined rotation direction. That is, the azimuthal angles associated with the LC directors may exhibit a continuous change around the helical axis in the predetermined rotation direction. Accordingly, the helical structure 817 may exhibit a handedness, e.g., right handedness or left handedness. The helical pitch Pₕ may be defined as a distance along the helical axis 818 over which the orientations of the LC directors exhibit a rotation around the helical axis 818 by 360°, or the azimuthal angles of the LC molecules vary by 360°.

In the embodiment shown in FIG. 8E, the helical axes 818 may be substantially perpendicular to the first surface 815-1 and/or the second surface 815-2 of the birefringent medium layer 815. In other words, the helical axes 818 of the helical structures 817 may be in a thickness direction (e.g., a z-axis direction) of the birefringent medium layer 815. In some embodiments, although not shown, the helical axes 818 may be tilted with respect to the first surface 815-1 and/or the second surface 815-2 of the birefringent medium layer 815.

As shown in FIG. 8E, the LC molecules 812 from the plurality of helical structures 817 having a first same orientation (e.g., same tilt angle and azimuthal angle) may form a first series of parallel refractive index planes 814 periodically distributed within the volume of the birefringent medium layer 815. Although not labeled, the LC molecules 812 with a second same orientation (e.g., same tilt angle and azimuthal angle) different from the first same orientation may form a second series of parallel refractive index planes periodically distributed within the volume of the birefringent medium layer 815. Different series of parallel refractive index planes may be formed by the LC molecules 812 having different orientations. In the same series of parallel and periodically distributed refractive index planes 814, the LC molecules 812 may have the same orientation and the refractive index may be the same. Different series of refractive index planes 814 may correspond to different refractive indices. When the number of the refractive index planes 814 (or the thickness of the birefringent medium layer) increases to a sufficient value, Bragg diffraction may be established according to the principles of volume gratings. Thus, the periodically distributed refractive index planes 814 may also be referred to as Bragg planes 814. Within the birefringent medium layer 815, there may exist different series of Bragg planes. A distance (or a period) between adjacent Bragg planes 814 of the same series may be referred to as a Bragg period P_{B}. The different series of Bragg planes formed within the volume of the birefringent medium layer 815 may produce a varying refractive index profile that is periodically distributed in the volume of the birefringent medium layer 815. The birefringent medium layer 815 may diffract an input light satisfying a Bragg condition through Bragg diffraction.

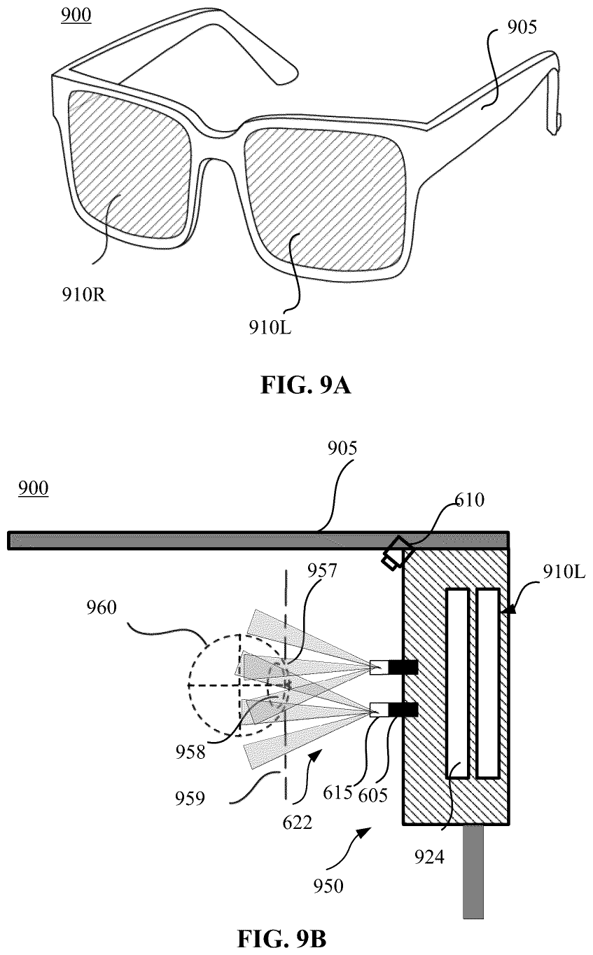

FIG. 9A illustrates a schematic diagram of an artificial reality device 900 according to an embodiment of the present disclosure. In some embodiments, the artificial reality device 900 may produce VR, AR, and/or MR content for a user, such as images, video, audio, or a combination thereof. The artificial reality device 900 may include one or more disclosed switchable structured illumination generators. In some embodiments, the artificial reality device 900 may be smart glasses. In one embodiment, the artificial reality device 900 may be a near-eye display (“NED”). In some embodiments, the artificial reality device 900 may be in the form of eyeglasses, goggles, a helmet, a visor, or some other type of eyewear. In some embodiments, the artificial reality device 900 may be configured to be worn on a head of a user (e.g., by having the form of spectacles or eyeglasses, as shown in FIG. 9A), or to be included as part of a helmet that is worn by the user. In some embodiments, the artificial reality device 900 may be configured for placement in proximity to an eye or eyes of the user at a fixed location in front of the eye(s), without being mounted to the head of the user. In some embodiments, the artificial reality device 900 may be in a form of eyeglasses which provide vision correction to a user's eyesight. In some embodiments, the artificial reality device 900 may be in a form of sunglasses which protect the eyes of the user from the bright sunlight. In some embodiments, the artificial reality device 900 may be in a form of safety glasses which protect the eyes of the user. In some embodiments, the artificial reality device 900 may be in a form of a night vision device or infrared goggles to enhance a user's vision at night.

For discussion purposes, FIG. 9A shows that the artificial reality device 900 includes a frame 905 configured to mount to a head of a user, and left-eye and right-eye display systems 910L and 910R mounted to the frame 905. FIG. 9B is a cross-sectional view of half of the artificial reality device 900 shown in FIG. 9A according to an embodiment of the present disclosure. For illustrative purposes, FIG. 9B shows the cross-sectional view associated with the left-eye display system 910L. The frame 905 is merely an example structure to which various components of the artificial reality device 900 may be mounted. Other suitable type of fixtures may be used in place of or in combination with the frame 905.

In some embodiments, the left-eye and right-eye display systems 910L and 910R each may include suitable image display components configured to generate an image light (representing a computer-generated virtual image), and guide the image light to propagate through one or more exit pupils 957 within an eyebox 959 of the artificial reality device 900. In some embodiments, the artificial reality device 900 may also include a viewing optics system 924 disposed between the left-eye display system 910L or right-eye display system 910R and the eyebox 959. The viewing optics system 924 may be configured to guide the image light (representing a computer-generated virtual image) output from the left-eye display system 910L or right-eye display system 910R to propagate through one or more exit pupils 957 within the eyebox 959. In some embodiments, the viewing optics system 924 may also be configured to perform a suitable optical adjustment of an image light output from the left-eye display system 910L or right-eye display system 910R, e.g., correct aberrations in the image light, adjust a position of the focal point of the image light in the eyebox 959, etc.

In some embodiments, as shown in FIG. 9B, the artificial reality device 900 may also include an object tracking system 950 (e.g., eye tracking system and/or face tracking system). The object tracking system 950 may be an object tracking system disclosed herein, such as the object tracking system 600 shown in FIG. 6A or the object tracking system 650 shown in FIG. 6B. For example, the object tracking system 950 may include one or more IR light sources 605, and one or more switchable structured illumination generators 615 coupled with the one or more IR light sources 605. The switchable structured illumination generator 615 may output the IR light 622 that provides an intensity-based structured light pattern for illuminating an eye 960 and/or a face of the user. In some embodiments, the IR light 622 may also be switched to provide a flood illumination pattern or a black illumination pattern. The eye 960 and/or the face may distort the structured light pattern, and reflect the IR light 622 as an IR light (not shown) including the distortions in the structured light pattern. The optical sensor 610 may receive the IR light deflected by the eye 960 and/or the face and generate a tracking signal (e.g., an eye tracking signal).

In some embodiments, the present disclosure provides an illumination system. The illumination system includes a polarization hologram configured to diffract an input light to output a first output light and a second output light, wherein the first output light and the second output light interfere with one another to generate a polarization interference pattern; and a polarizer coupled with the polarization hologram, and configured to convert the polarization interference pattern into an intensity interference pattern for illuminating a tracked object. In some embodiments, the input light is a linearly polarized light, and the first output light and the second output light are circularly polarized lights with opposite handednesses. In some embodiments, the illumination system further includes a controller configured to switch the polarization hologram between operating at a non-neutral state for the input light and operating at a neutral state for the input light. The polarization hologram operating at the non-neutral state for the input light is configured to diffract the input light into the first output light and the second output light, and the polarization hologram operating at the neutral state for the input light is configured to substantially transmit the input light with negligible diffraction.

In some embodiments, the illumination system further includes a polarization switch configured to control a polarization of the input light incident onto the polarization hologram, the polarization hologram being disposed between the polarization switch and the polarizer. In some embodiments, the controller is configured to switch the polarization switch between operating at a non-switching state to maintain the polarization of the input light and operating at a switching state to change the polarization of the input light. In some embodiments, the illumination system further includes a color-selective waveplate configure to function as a half-wave plate for a first wavelength range and a full-wave plate for a second, different wavelength range. In some embodiments, the input light includes a first input light having the first wavelength range and a second input light having the second wavelength range.

In some embodiments, the illumination system further includes a light source assembly configured to output the first input light and the second input light, and a controller configured to control the light source assembly to output the first input light and the second input light during the same time period or different time periods. In some embodiments, the controller is configured to switch the polarization hologram between operating at a non-neutral state for the first and second input lights and operating at a neutral state for the first and second input lights, the polarization hologram operating at the non-neutral state for the first and second input lights is configured to diffract the first and second input lights, and the polarization hologram operating at the neutral state for the first and second input lights is configured to substantially transmit the first and second input lights with negligible diffraction.

In some embodiments, the polarization hologram includes a stack of a first polarization hologram configured with a first operation wavelength range and a second polarization hologram configured with a second, different operation wavelength range. In some embodiments, the input light including a first input light having a first wavelength range and a second input light having a second wavelength range, the first wavelength range is configured to be at least partially within the first operation wavelength range of the first polarization hologram and outside of the second operation wavelength range of the second polarization hologram, and the second wavelength range is configured to be at least partially within the second operation wavelength range of the second polarization hologram and outside of the first operation wavelength range of the first polarization hologram. In some embodiments, the first polarization hologram is configured to diffract the first input light, and transmit the second input light with negligible diffraction, and the second polarization hologram is configured to diffract the second input light, and transmit the first input light with negligible diffraction.

In some embodiments, the illumination system further includes a light source assembly configured to output the first input light and the second input light, and a controller configured to control the light source assembly to output the first input light and the second input light during the same time period or different time periods. In some embodiments, the illumination system further includes a polarization switch configured to control a polarization of the first and second input lights incident onto the polarization hologram, the polarization hologram being disposed between the polarization switch and the polarizer.

In some embodiments, the controller is configured to switch the polarization switch between operating at a non-switching state to maintain the polarization of the first and second input lights and operating at a switching state to change the polarization of the first and second input lights. In some embodiments, the controller is configured to switch the first polarization hologram between operating at a non-neutral state for the first input light and operating at a neutral state for the first input light, the first polarization hologram operating at the non-neutral state for the first input light is configured to diffract the first input light, and the first polarization hologram operating at the neutral state for the first input light is configured to substantially transmit the first input light with negligible diffraction.

In some embodiments, the controller is configured to switch the second polarization hologram between operating at a non-neutral state for the second input light and operating at a neutral state for the second input light, the second polarization hologram operating at the non-neutral state for the second input light is configured to diffract the second input light, and the second polarization hologram operating at the neutral state for the second input light is configured to substantially transmit the second input light with negligible diffraction.

In some embodiments, the polarization hologram includes a Pancharatnam-Berry phase (“PBP”) element. In some embodiments, the PBP element includes a PBP grating configured to provide a grating phase profile, a PBP lens configured to provide a lens phase profile, or a PBP freeform plate configured to provide a freeform phase profile. In some embodiments, the PBP element is configured to have a varying thickness. In some embodiments, the polarization hologram is configured to correct an aberration in the input light.

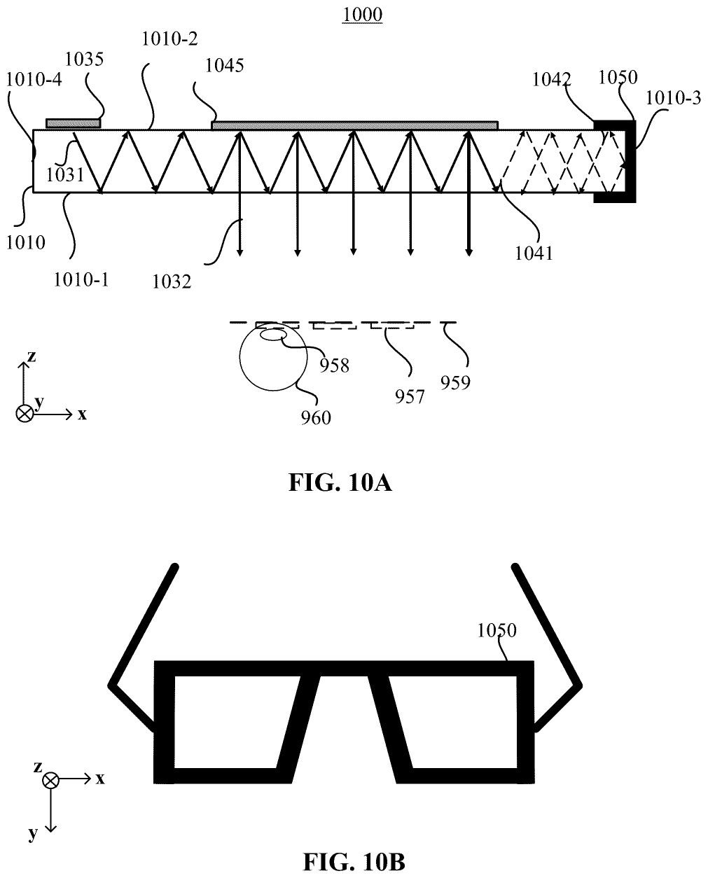

The present disclosure further provides a display system for reducing a stray light and enhancing a contrast ratio. FIG. 10A illustrates an x-z sectional view of a conventional light guide display system 1000 that may be implemented into an artificial reality device for VR, AR and/or MR applications. As shown in FIG. 10A, the system 1000 may include a display element (not shown), a light guide (or waveguide) 1010, an in-coupling grating 1035, and an out-coupling grating 1045. The light guide 1010 may have a first surface 1010-1 facing the eye-box region 959 where the eye 960 of a user of the system 1000 is located, a second surface 1010-2 opposite to the first surface 1010-1, and a third surface 1010-3 and a fourth surface 1010-4 located between the first surface 1010-1 and the second surface 1010-2. The in-coupling grating 1035 or the out-coupling grating 1045 may be disposed at the first surface 1010-1 or the second surface 1010-2.

The display element may emit an image light representing a virtual image toward the in-coupling grating 1035, and the in-coupling grating 1035 may couple the image light into the light guide 1010 as an in-coupled image light 1031 that propagates inside the light guide 1010 via total internal reflection (“TIR”). The out-coupling grating 1045 may diffract a portion of the in-coupled image light 1031 incident onto each portion the grating out of the light guide 1010 as an output (or out-coupled) image light 1032, while the rest portion of the in-coupled image light 1031 may continue propagating inside the light guide 1010 via TIR. Thus, the out-coupling grating 1045 may diffract the in-coupled image light 1031 incident onto different portions (or locations) of the out-coupling grating 1045 out of the light guide 1010 as multiple output image lights 1032, thereby expanding an effective pupil of the system 1000 along a pupil expansion direction (e.g., an x-axis direction shown in FIG. 10A). The output image lights 1032 may propagate toward the eye-box region 959, and the eye 960 located within the eye-box region 959 may perceive a virtual image formed by the output image lights 1032.

The size and the diffraction efficiency of the out-coupling grating 1045 may be designed based on the size of a field of view (“FOV”) of the system 1000, the size of the eye-box region 959, a desirable angular brightness uniformity over the FOV, and a desirable spatial brightness uniformity within the eye-box region 959. When the out-coupling grating 1045 provides a uniform or constant diffraction efficiency for the in-coupled image light 1031 incident onto different portions of the out-coupling grating 1045, as portions of the in-coupled image light 1031 are coupled out of the light guide 1010 at different portions of the out-coupling grating 1045, the intensity of the in-coupled image light 1031 propagating inside the light guide 1010 may naturally decrease from one portion to another. Thus, the intensity of the out-coupled image lights 1032 may naturally decrease in the pupil expansion direction (e.g., the x-axis direction shown in FIG. 10A).

Inventor has found that when the diffraction efficiency is spatially uniform for the entire out-coupling grating 1045, and the ratio between the maximum intensity of the out-coupled image light 1032 and the minimum intensity of the out-coupled image light 1032 is equal to or less than 5:1, about 45% of the in-coupled image light 1031 incident onto the out-coupling grating 1045 may not be coupled out of the light guide 1010. This unextracted image light may become a stray light 1041 (as illustrated by dashed arrows in FIG. 10A). The stray light 1041 may remain propagating inside the light guide 1010 via TIR, toward the third surface 1010-3 of the light guide 1010 along the +x-axis direction. The third surface 1010-3 may reflect the stray light 1041 into a stray light 1042 propagating inside the light guide 1010 via TIR along the −x-axis direction. The stray light 1042 may be incident onto the out-coupling grating 1045, and diffracted out of the light guide 1010 toward the eye-box region 959, reducing the image contrast of the virtual image perceived by the eye 960 located within the eye-box region 959.

In conventional technologies, a frame made of a light absorption material (referred to as a light absorptive frame) may be disposed around an edge of the light guide 1010 to absorb the stray lights 1041 and 1042 incident thereonto. For example, FIG. 10A shows a light absorptive frame 1050 is disposed at the third surface 1010-3, a portion of the first surface 1010-1 in close proximity to the third surface 1010-3, and a portion of the second surface 1010-2 in close proximity to the third surface 1010-3. The size of the frame 1050 may be designed based on the beam size of the stray light 1041 or 1042 (that is the same as the in-coupled image light 1031). Thus, as the beam size of the stray light 1041 or 1042 increases, a large frame may be desired to sufficiently absorb the stray lights 1041 and 1042, which may result in poor aesthetic effect. In some cases, as shown in FIG. 10B, the system 1000 may be implemented as an eyewear, where the light guide 1010 may be a portion of the lens, and the frame 1050 may be a portion of the eyewear frame that is mounted to a user's head. As the size of the frame 1050 increases, the weight and the form factor of the entire eyewear may be increased accordingly.

In view of the limitations in conventional technologies, the present disclosure provides various mechanisms to reduce the stray light and enhance the contrast ratio in a display system. The display system disclosed herein may be implemented into an artificial reality device for VR, AR and/or MR applications. The display system disclosed herein may be a suitable display system, such as a geometric light guide display system including one or more refractive and/or reflective type couplers, a diffractive light guide display system including one or more diffractive type couplers, a mixed light guide display system including one or more refractive and/or reflective type couplers and one or more diffractive type couplers. In the following, a diffractive light guide display system and a geometric light guide display system are used as examples for explaining the principles of reducing the stray light and enhancing the contrast ratio.

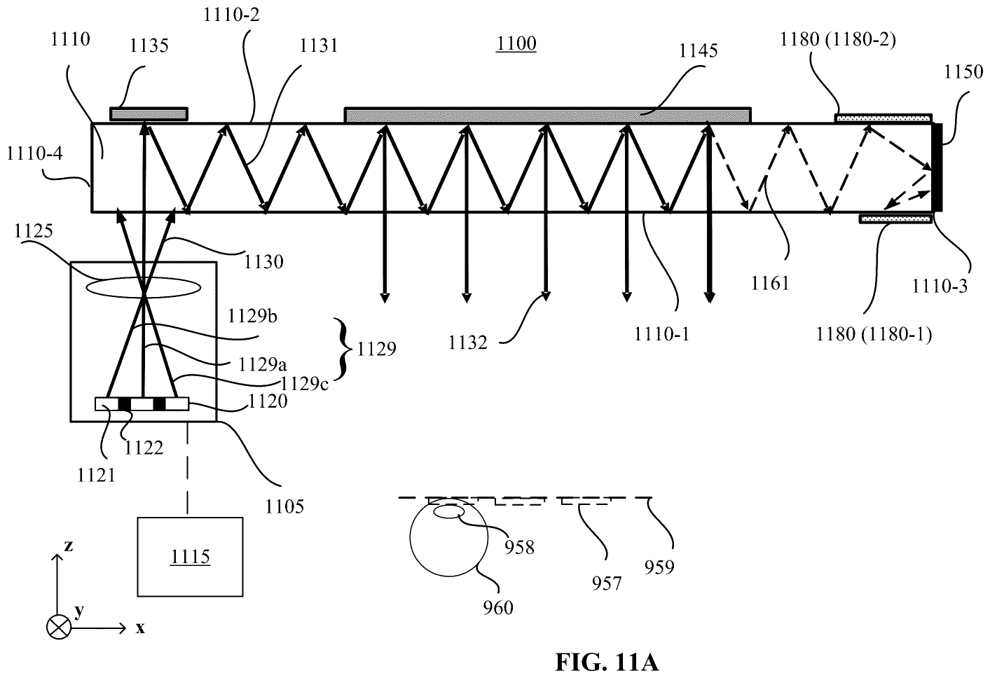

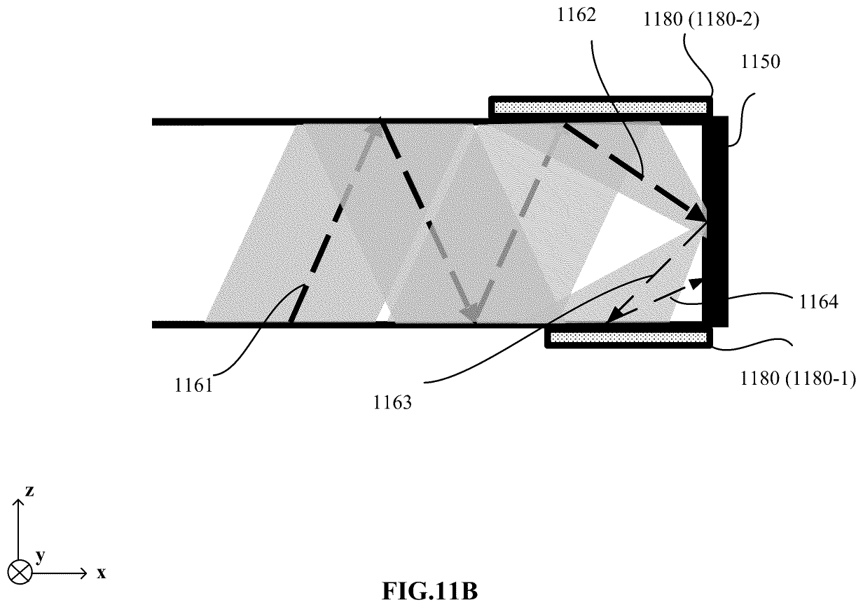

FIG. 11A illustrate an x-z sectional view of a display system 1100 configured to reduce the stray light and improve the contrast ratio, according to an embodiment of the present disclosure. As shown in FIG. 11A, the system 1100 may include a light source assembly 1105, a light guide (or waveguide) 1110, a plurality of couplers (or coupling elements) 1135 and 1145, a light absorptive layer 1150, and a first reflective lens 1180-1 and a second reflective lens 1180-2 (collectively referred to as reflective lenses 1180). The system 1100 may also include a controller 1115 that is communicatively coupled with the light source assembly 1105 to control the operation thereof. In some embodiments, at least one of the first reflective lens 1180-1 or the second reflective lens 1180-2 may be replaced by a diffractive lens.

The light source assembly 1105 may be configured to emit an image light (referred to as an input image light) 1130 representing a virtual image toward the light guide 1110. In some embodiments, the light source assembly 1105 may include a display element (e.g., a micro projector) 1120 and a collimating lens 1125. The input image light 1130 may have an input field of view (“FOV”). The display element 1120 may include a plurality of pixels 1121 arranged in a pixel array, in which neighboring pixels 1121 may be separated by, e.g., a black matrix 1122. The display element 1120 may output an image light 1129, which includes bundles of divergent rays output from the respective pixels 1121. The collimating lens 1125 may convert the bundles of divergent rays in the image light 1129 output from the display element into bundles of parallel rays in the input image light 1130 propagating toward the light guide 1110. The respective bundles of parallel rays may have different incidence angles at the light guide 1110. That is, the collimating lens 1125 may transform or convert a linear distribution of the pixels in the display element 1120 into an angular distribution of the pixels at the input side of the light guide 1110. For discussion purposes, FIG. 11A merely shows three pixels 1121, and a single ray (e.g., central ray) 1129a, 1129b or 1129c of the bundles of divergent rays output from each pixel 1121.

The couplers 1135 and 1145 may be disposed at one or more surfaces of the light guide 1110, or may be embedded inside the light guide 1110. Each coupler 1135 or 1145 may include one or more diffractive optical elements (e.g., gratings), one or more refractive optical elements (e.g., prisms), or one or more reflective optical elements (e.g., mirrors), etc. In some embodiments, the light guide 1110 including the couplers 1135 and 1145 may also be referred to as an image combiner or an optical combiner. The light guide 1110 may have a first surface 1110-1 facing the eye-box region 959, a second surface 1110-2 opposite to the first surface 1110-1, a third surface 1110-3, and a fourth surface 1110-4 opposite to the third surface 1110-3. The first surface 1110-1 may be parallel to the second surface 1110-2, and the third surface 1110-3 may be parallel to the fourth surface 1110-4. The third surface 1110-3 and the fourth surface 1110-4 may be located between the first surface 1110-1 and the second surface 1110-2. In some embodiments, each of the couplers 1135 and 1145 may be formed or disposed at (e.g., affixed to) the first surface 1110-1 or the second surface 1110-2 of the light guide 1110. In some embodiments, each of the couplers 1135 and 1145 may be integrally formed as a part of the light guide 1110, or may be a separate element coupled to the light guide 1110. For discussion purposes, FIG. 11A shows that the couplers 1135 and 1145 are disposed at the second side 1110-2 of the light guide 1110.

In some embodiments, the coupler 1135 may be an in-coupling element (e.g., an in-coupling grating) 1135 disposed at a first portion (e.g., an input portion) of the light guide 1110. The coupler 1145 may be an out-coupling element (e.g., an out-coupling grating) 1145 disposed at a second portion (e.g., an output portion) of the light guide 1110. The reflective lenses 1180 may be disposed at a third portion of the light guide 1110. The second portion of the light guide 1110 where the out-coupling element 1145 is disposed may be between the third portion of the light guide 1110 where the reflective lens 1180 is disposed and the first portion of the light guide 1110 where the in-coupling element 1135 is disposed.

The in-coupling element 1135 may be configured to couple the image light 1130 into the light guide 1110 as an in-coupled image light 1131, which may propagate inside the light guide 1110 via TIR from the first portion of the light guide 1110 to the third portion the light guide 1110. For example, the in-coupling element 1135 may be configured to couple the respective bundles of parallel rays in the image light 1130 into the light guide 1110 as respective bundles of parallel rays in the in-coupled image light 1131. Each bundle of the of parallel rays in the in-coupled image light 1131 may be associated with an TIR propagation angle, which is an angle of a ray with respect to the surface normal of the light guide 1110. The respective bundles of parallel rays in the in-coupled image light 1131 may be associated with respective, different TIR propagation angles, each of which may be within a TIR range of the light guide 1110. The TIR range of the light guide 1110 may be referred to as a range of an incidence angle of a light at the inner surface of the light guide 1110 where the light can be totally internally reflected. The TIR range of the light guide 1110 may be determined by the refractive index of the material of the light guide 1110.

The out-coupling element 1145 may be configured to couple the in-coupled image light 1131 out of the light guide 1110 as one or more output image lights 1132 propagating toward one or more exit pupils 957 located in the eye-box region 959. For example, the out-coupling grating 1145 may be configured to couple respective bundles of parallel rays of the in-coupled image light 1131 output of the light guide 1110 as respective bundles of parallel rays of the output image light 1132. For discussion purposes, FIG. 11A merely shows a single ray of the input image light 1130 (e.g., a center ray of the bundle of divergent rays output from the central pixel 1121) inside the light guide 1110. The exit pupil 957 may correspond to a spatial zone where an eye pupil 958 of the eye 960 of a user may be positioned in the eye-box region 959 of the system 1100 to perceive the virtual image represented by the input image light 1130.

In some embodiments, the system 1100 may provide a one-dimensional pupil expansion. For example, FIG. 11A shows that the out-coupling element 1145 expands the input image light 1130 at the output side of the light guide 1110, thereby expanding an effective pupil of the system 1100 along an x-axis direction in FIG. 11A. In some embodiments, the system 1100 may provide a two-dimensional pupil expansion, e.g., along both the x-axis direction and the y-axis direction in FIG. 11A. For example, the couplers may also include a folding or redirecting element (or folding or redirecting coupler) configured to receive the in-coupled image light 1131 from the in-coupling element 1135, and direct the in-coupled image light 1131 toward the out-coupling element 1145. The folding or redirecting element (not shown) may be configured to expand the input image light 1130 along a first direction (e.g., the y-axis direction in FIG. 11A), and the out-coupling element 1145 may be configured to expand the image light 1130 along a second direction (e.g., the x-axis direction in FIG. 11A). In some embodiments, multiple functions, e.g., redirecting, folding, and/or expanding the image light 1130 may be combined into a single element, e.g. the out-coupling element 1145. For example, the out-coupling element 1145 itself may be configured to provide a 2D expansion of the effective pupil of the system 1100. For example, the out-coupling grating 1145 may be a 2D grating including a single grating layer or a single layer of diffractive structure.

In some embodiments, the reflective lens 1180 may include one or more diffractive lenses configured to focus a light via backward diffraction. A diffractive lens may be considered as a diffraction grating having an optical power (that is a non-zero optical power). Examples of diffraction gratings may include a Pancharatnam-Berry phase (“PBP”) grating, a polarization volume hologram (“PVH”) grating, a volume Bragg grating (“VBG”), a holographic polymer-dispersed liquid crystal (“H-PDLC”) grating, a surface relief grating, a metasurface grating, etc. The reflective lens 1180 may be polarization sensitive (or polarization selective) or polarization insensitive (or polarization non-selective). The reflective lens 1180 may be configured to focus, via backward diffraction, a light having an incidence angle within the TIR region of the light guide 1110. In some embodiments, the reflective lens 1180 may be an on-axis reflective lens. In some embodiments, the reflective lens 1180 may be an off-axis reflective lens.

The first reflective lens 1180-1 and the second reflective lens 1180-2 may be disposed at two different surfaces of the light guide 1110, facing one another. In some embodiments, each of the first reflective lens 1180-1 and the second reflective lens 1180-2 may be formed or disposed at (e.g., affixed to) the first surface 1110-1 or the second surface 1110-2 of the light guide 1110. In some embodiments, each of the first reflective lens 1180-1 and the second reflective lens 1180-2 may be integrally formed as a part of the light guide 1110, or may be a separate element coupled to the light guide 1110. For discussion purposes, FIG. 11A shows that the first reflective lens 1180-1 and the second reflective lens 1180-2 are disposed at the first surface 1110-1 and the second surface 1110-2 of the light guide 1110, respectively.

The light absorptive layer 1150 may be disposed at the third surface 1110-3 of the light guide 1110, and may be configured to absorb or attenuate a light having a specific range of wavelengths, e.g., a visible wavelength range. The light absorptive layer 1150 may not be disposed at the first surface 1110-1 and the second surface 1110-2 of the light guide 1110. The light absorptive layer 1150 may include any suitable light absorptive material, such as a black paint or ink, carbon black, organic dyes, or carbon nanotubes, etc. In some embodiments, as shown in FIG. 11A, the out-coupling element 1145 may couple a first portion of the in-coupled image light 1131 out of the light guide 1110 as the output image lights 1132 propagating toward the eye-box region 959, whereas a second portion of the in-coupled image light 1131 that is not coupled out of the light guide 1110 via the out-coupling element 1145 may become a stray light 1161 (denoted by dashed arrows in FIG. 11A), which continues propagating inside the light guide 1110 toward the reflective lens 1180 via TIR. The reflective lens 1180 may be configured to substantially backwardly diffract the stray light 1161 toward the light absorptive layer 1150. The light absorptive layer 1150 may be configured to substantially absorb the stray light 1161 diffracted by the reflective lens 1180. That is, the stray light 1161, which otherwise would be reflected at the third surface 1110-3 back to be incident onto the out-coupling element 1145 again and being coupled out of the light guide 1110 via the out-coupling element 1145 toward the eye-box region 959, may be substantially absorbed by the light absorptive layer 1150. Thus, the amount to the stray light 1161 that is incident onto the out-coupling element 1145 again and coupled out of the light guide 1110 via the out-coupling element 1145 toward the eye-box region 959 may be significantly reduced. Accordingly, the image contrast of the virtual image perceived by the eye 960 located within the eye-box region 959 may be enhanced.

FIG. 11B illustrates an x-z sectional view of a portion of the light guide 1110, showing the optical path of the stray light 1161 inside the light guide 1110. As shown in FIGS. 11A and 11B, the stray light 1161 may propagate inside the light guide 1110 via TIR, and may be incident onto the second reflective lens 1180-2. The second reflective lens 1180-2 may be configured to reflect and focus the stray light 1161 as a stray light 1162 propagating toward the light absorptive layer 1150. A diffraction angel of the stray light 1162 may be configured, such that the stray light 1162 does not satisfy the TIR condition at the third surface 1110-3, e.g., an incidence angle of the stray light 1162 at the third surface 1110-3 may be smaller than a TIR critical angle of the light guide 1110. Thus, the stray light 1162 may be refracted at the third surface 1110-3 toward the light absorptive layer 1150. The light absorptive layer 1150 may be configured to absorb the stray light 1162 incident thereon. In some embodiments, the light absorptive layer 1150 may be configured to substantially absorb the stray light 1162 incident thereon, e.g., absorb all of the stray light 1162, and the first reflective lens 1180-1 may be omitted.

In some embodiments, the light absorptive layer 1150 may absorb a first portion of the stray light 1162 (not all of the stray light 1162), and a second portion of the stray light 1162 may be reflected at the third surface 1110-3 as a stray light 1163 propagating toward the first reflective lens 1180-1. The first reflective lens 1180-1 may be configured to reflect and focus the stray light 1163 as a stray light 1164 propagating toward the light absorptive layer 1150. A diffraction angel of the stray light 1164 may be configured, such that the stray light 1164 does not satisfy the TIR condition at the third surface 1110-3, e.g., an incidence angle of the stray light 1162 at the third surface 1110-3 may be smaller than a TIR critical angle of the light guide 1110. Thus, the stray light 1162 may be refracted at the third surface 1110-3 toward the light absorptive layer 1150, and absorbed by the light absorptive layer 1150.

In some embodiments, the size of the light absorptive layer 1150 may be configured to be comparable with the beam size of the stray light 1162 output from the second reflective lens 1180-2 and the beam size of the stray light 1164 output from the first reflective lens 1180-1. For example, the size of the light absorptive layer 1150 may be configured to be equal to or slightly greater than the beam size of the stray light 1162 output from the second reflective lens 1180-2 and the beam size of the stray light 1164 output from the first reflective lens 1180-1. In some embodiments, the first reflective lens 1180-1 and the second reflective lens 1180-2 may have the same size. In some embodiments, the first reflective lens 1180-1 and the second reflective lens 1180-2 may have different sizes, e.g., the size of the second reflective lens 1180-2 may be greater than the first reflective lens 1180-1.

In some embodiments, although not shown, the system 1100 may also include an anti-reflection (“AR”) coating disposed at the third surface 1110-3 of the light guide 1110, and the stray light 1162 output from the second reflective lens 1180-2 and the stray light 1164 output from the first reflective lens 1180-1 may be incident onto the AR coating first then incident onto the light absorptive layer 1150. Thus, the reflection of the stray light 1162 and the stray light 1164 at the third surface 1110-3 of the light guide 1110 may be further reduced.

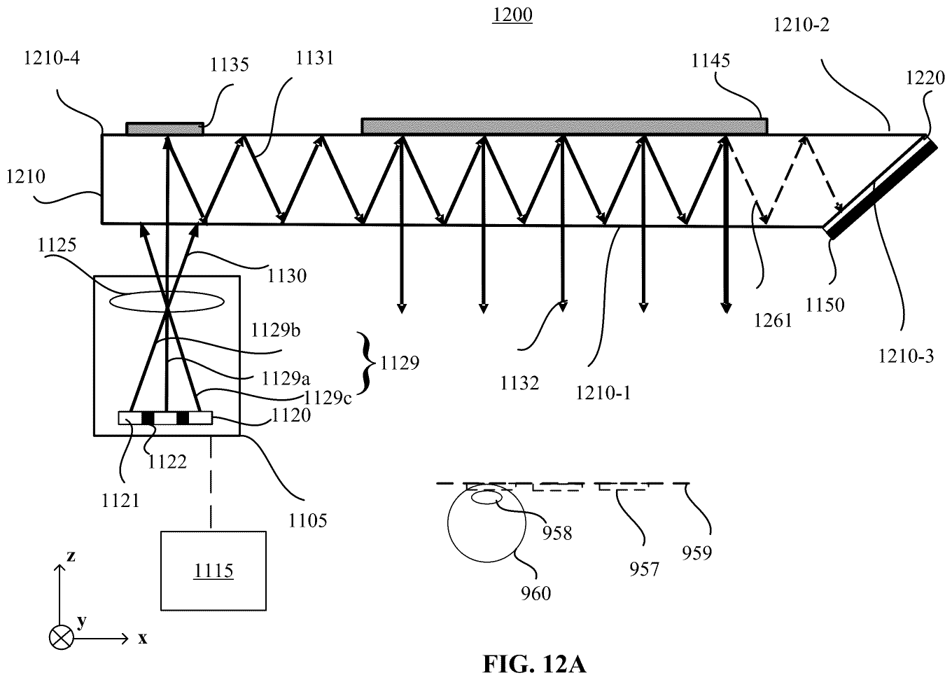

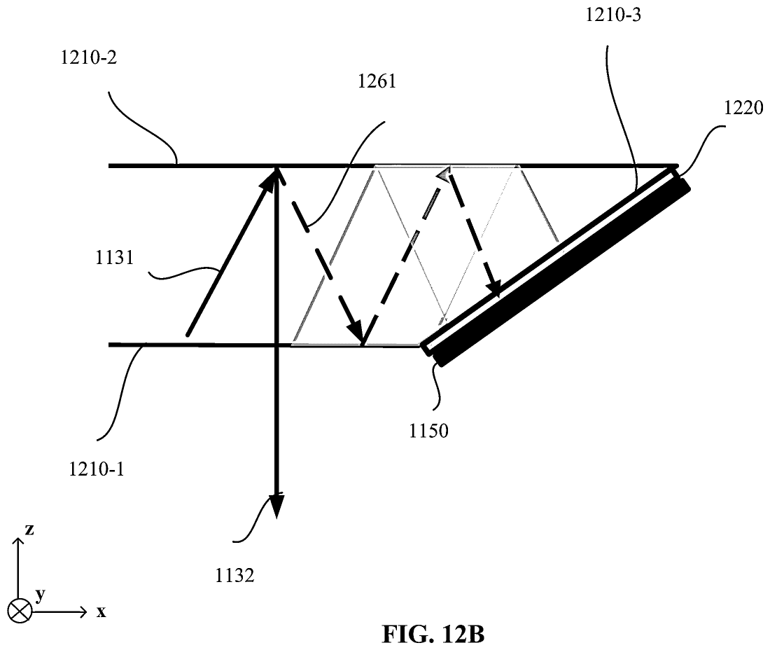

FIG. 12A illustrate an x-z sectional view of a display system 1200 configured to reduce the stray light and improve the contrast ratio, according to an embodiment of the present disclosure. FIG. 12B illustrates an x-z sectional view of a portion of a light guide 1210 included in the system 1200, showing the optical path of the stray light 1161 inside the light guide 1210. The system 1200 shown in FIGS. 12A and 12B may include elements, structures, and/or functions that are the same as or similar to those included in the system 1100 shown in FIGS. 11A and 11B. Descriptions of the same or similar elements, structures, and/or functions can refer to the above descriptions rendered in connection with FIGS. 11A and 11B.

As shown in FIG. 12A, the system 1200 may include the light source assembly 1105, a light guide (or waveguide) 1210, the in-coupling element 1135 and the out-coupling element 1145, an AR coating 1220, the light absorptive layer 1150, and the controller 1115. The light guide 1210 may have a first surface 1210-1 facing the eye-box region 1259, a second surface 1210-2 opposite to the first surface 1210-1, a third surface 1210-3, and a fourth surface 1210-4 opposite to the third surface 1210-3. The third surface 1210-3 and the fourth surface 1210-4 may be located between the first surface 1210-1 and the second surface 1210-2. In some embodiments, the first surface 1210-1 may be parallel to the second surface 1210-2, whereas the third surface 1210-3 may not be parallel to the fourth surface 1210-4. The third surface 1210-3 may be slanted with respect to the first surface 1210-1 or the second surface 1210-2, forming a tilt angle (or slant angle) with respect to the first surface 1210-1 and the second surface 1210-2. For example, the third surface 1210-3 may form an acute angle with one of the first surface 1210-1 and the second surface 1210-2, and an obtuse angle with the other of the first surface 1210-1 and the second surface 1210-2. For discussion purposes, FIG. 12A shows that the third surface 1210-3 forms an acute angle with the second surface 1210-2, and an obtuse angle with the first surface 1210-1.

In some embodiments, the in-coupling element 1135 may be disposed at a first portion (e.g., an input portion) of the light guide 1210. The out-coupling element 1145 may be disposed at a second portion (e.g., an output portion) of the light guide 1210. The AR coating 1220 and the light absorptive layer 1150 may be disposed at a third portion of the light guide 1210. The second portion of the light guide 1210 where the out-coupling element 1145 is disposed may be between the third portion of the light guide 1210 where the AR coating 1220 and the light absorptive layer 1150 are disposed and the first portion of the light guide 1210 where the in-coupling element 1135 is disposed.

As shown in FIG. 12A, the out-coupling element 1145 may couple a first portion of the in-coupled image light 1131 out of the light guide 1210 as one or more output image lights 1132 propagating toward the eye-box region 959, whereas a second portion of the in-coupled image light 1131 that is not coupled out of the light guide 1210 via the out-coupling element 1145 may become a stray light 1261 (denoted by dashed arrows in FIG. 12A), which continues propagating inside the light guide 1210 toward the third surface 1210-3 of the light guide 1210 via TIR. FIG. 12B illustrates an x-z sectional view of a portion of the light guide 1210, showing the optical path of the stray light 1261 inside the light guide 1210. As shown ins FIGS. 12A and 12B, the AR coating 1220 and the light absorptive layer 1150 may be disposed at the third surface 1210-3 of the light guide 1210. The AR coating 1220 may be positioned before the light absorptive layer 1150 in the optical path of the stray light 1261. That is, the stray light 1261 may be firstly incident onto the AR coating 1220, and transmitted through the AR coating 1220 toward the light absorptive layer 1150. The tilt angle (or slant angle) of the third surface 1210-3 with respect to the first surface 1210-1 and the second surface 1210-2 may be configured, such that the stray light 1261 does not satisfy the TIR condition at the third surface 1210-3 of the light guide 1210. That is, the stray light 1261 may be transmitted through third surface 1210-3 of the light guide 1210 toward the AR coating 1220 and the light absorptive layer 1150, rather than being totally internally reflected at the third surface 1210-3 to propagate inside the light guide 1210 toward the out-coupling element 1145.

The AR coating 1220 may be configured to reduce the reflection of the stray light 1261 and, thus, increase the transmission of the stray light 1261. For example, the AR coating 1220 may be configured to substantially transmit the stray light 1261 toward the light absorptive layer 1150. The light absorptive layer 1150 may be configured to substantially absorb the stray light 1261 received from the AR coating 1220. That is, the stray light 1261, which otherwise would be reflected at the third surface 1210-3 back to be incident onto out-coupling element 1145 again and being coupled out of the light guide 1210 via the out-coupling element 1145 toward the eye-box region 959, may be substantially absorbed by the light absorptive layer 1150. Thus, the amount to the stray light 1261 that is incident onto the out-coupling element 1145 again and coupled out of the light guide 1210 via the out-coupling element 1145 toward the eye-box region 959 may be significantly reduced. Accordingly, the image contrast of the virtual image perceived by the eye 960 located within the eye-box region 959 may be enhanced.

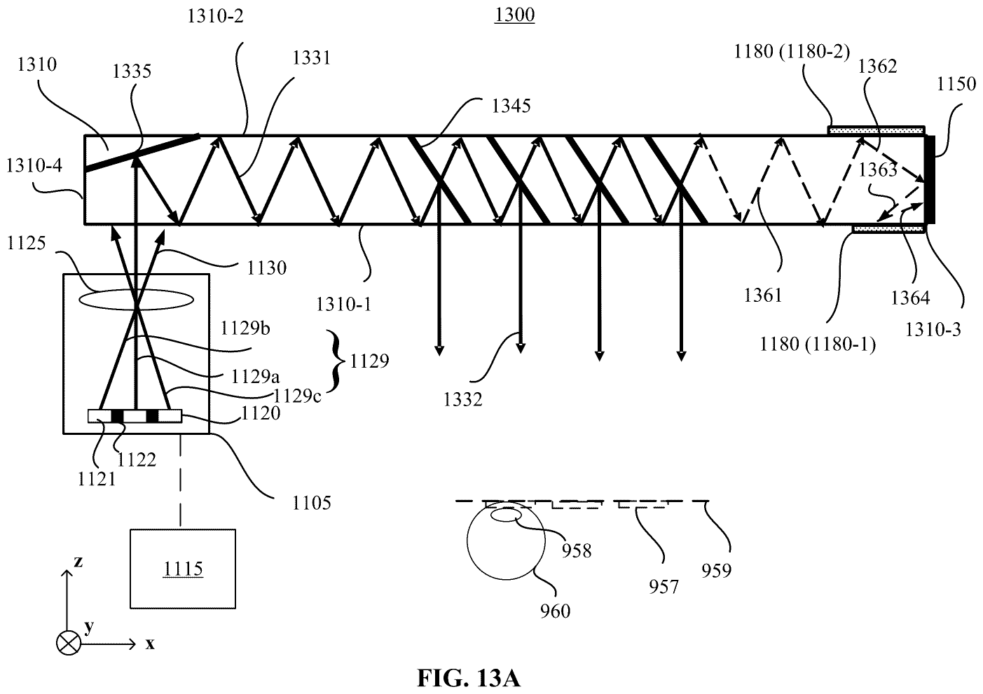

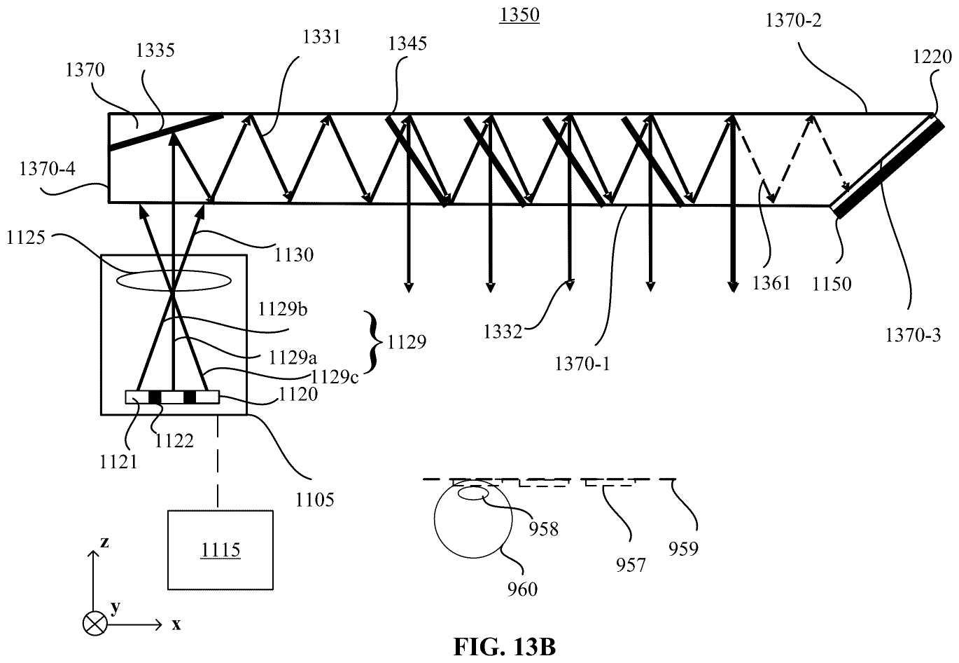

FIG. 13A illustrates an x-z sectional views of a display system 1300 configured to reduce a stray light and improve a contrast ratio, according to an embodiment of the present disclosure. The display system 1300 may include elements, structures, and/or functions that are the same as or similar to those included in the display system 1100 shown in FIGS. 11A and 11B, or the display system 1200 shown in FIGS. 12A and 12B. Descriptions of the same or similar elements, structures, and/or functions can refer to the above descriptions rendered in connection with FIGS. 11A and 11B, or FIGS. 12A and 12B.

As shown in FIG. 13A, the display system 1300 may include the light source assembly 1105, a light guide 1310, an in-coupling element 1335, an out-coupling element 1345, the controller 1115, the first reflective lens 1180-1, the second reflective lens 1180-2, and the light absorptive layer 1150. The light guide 1310 may have a first surface 1310-1 facing the eye-box region 959, a second surface 1310-2 opposite to the first surface 1310-1, a third surface 1310-3, and a fourth surface 1310-4 opposite to the third surface 1310-3. The first surface 1310-1 may be parallel to the second surface 1310-2, and the third surface 1310-3 may be parallel to the fourth surface 1310-4. The third surface 1310-3 and the fourth surface 1310-4 may be located between the first surface 1310-1 and the second surface 1310-2.

In some embodiments, the in-coupling element 1335 may be embedded at a first portion (e.g., input portion) of the light guide 1310, and the out-coupling element 1345 may be embedded at a second portion of the light guide 1310. In some embodiments, the in-coupling element 1335 may include a highly reflective mirror. In some embodiments, the in-coupling element 1335 may not be embedded in the light guide 1310, instead, may be disposed at a surface of the light guide 1310. For example, the in-coupling element 1335 may include a prism disposed at a surface of the light guide 1310. The out-coupling element 1345 may include an array of transflective elements, referred to as out-coupling mirrors 1345 for discussion purposes. A transflective element may reflect a first portion of an incident light and transmit a second portion of the incident light. The transmittance and the reflectance of the transflective element may be configurable depending on different applications. For example, in some embodiments, the transmittance and the reflectance of the out-coupling mirror 1345 may be configured to be about 85% and 15%, respectively. In some embodiments, the light guide 1310 including the in-coupling element 1335 and the out-coupling element 1345 may also be referred to as an image combiner or an optical combiner.

The first reflective lens 1180-1 and the second reflective lens 1180-2 may be disposed at disposed at a third portion of the light guide 1310. The second portion of the light guide 1310 where the out-coupling element 1345 is embedded may be between the third portion of the light guide 1310 where the first reflective lens 1180-1 and the second reflective lens 1180-2 are disposed and the first portion of the light guide 1310 where the in-coupling element 1335 is embedded. Further, the first reflective lens 1180-1 and the second reflective lens 1180-2 may be disposed at two different surfaces of the light guide 1310, facing one another. In some embodiments, each of the first reflective lens 1180-1 and the second reflective lens 1180-2 may be formed or disposed at (e.g., affixed to) the first surface 1310-1 or the second surface 1310-2 of the light guide 1310. In some embodiments, each of the first reflective lens 1180-1 and the second reflective lens 1180-2 may be integrally formed as a part of the light guide 1310, or may be a separate element coupled to the light guide 1310. For discussion purposes, FIG. 13A shows that the first reflective lens 1180-1 and the second reflective lens 1180-2 are disposed at the first surface 1310-1 and the second surface 1310-2 of the light guide 1310, respectively. The light absorptive layer 1150 may be disposed at the third surface 1110-3 of the light guide 1310.

The in-coupling element 1335 may be configured to couple the input image light 1130 as an in-coupled image light 1332 propagating inside the light guide 1310 via TIR from the first portion of the light guide 1310 to the third portion the light guide 1310. The out-coupling element 1345 may couple, via reflection, a first portion of the in-coupled image light 1331 out of the light guide 1310 as the output image lights 1332 propagating toward the eye-box region 1359, whereas a second portion of the in-coupled image light 1331 that is not coupled out of the light guide 1310 via the out-coupling element 1345 may become a stray light 1361 (denoted by dashed arrows in FIG. 13A), which continues propagating inside the light guide 1310 toward the third surface 1310-3 via TIR, and incident onto the second reflective lens 1180-2.

The second reflective lens 1180-2 may be configured to reflect and focus the stray light 1361 as a stray light 1362 propagating toward the light absorptive layer 1150. A diffraction angel of the stray light 1362 may be configured, such that the stray light 1362 does not satisfy the TIR condition at the third surface 1110-3, e.g., an incidence angle of the stray light 1362 at the third surface 1110-3 may be smaller than a TIR critical angle of the light guide 1110. Thus, the stray light 1362 may be refracted at the third surface 1110-3 toward the light absorptive layer 1150. The light absorptive layer 1150 may be configured to absorb the stray light 1362 incident thereon. In some embodiments, the light absorptive layer 1150 may be configured to substantially absorb the stray light 1362 incident thereon, e.g., absorb all of the stray light 1362, and the first reflective lens 1180-1 may be omitted.

In some embodiments, the light absorptive layer 1150 may absorb a first portion of the stray light 1362 (not all of the stray light 1362), and a second portion of the stray light 1362 may be reflected at the third surface 1310-3 as astray light 1363 propagating toward the first reflective lens 1180-1. The first reflective lens 1180-1 may be configured to reflect and focus the stray light 1363 as a stray light 1364 propagating toward the light absorptive layer 1150. A diffraction angel of the stray light 1364 may be configured, such that the stray light 1364 does not satisfy the TIR condition at the third surface 1310-3, e.g., an incidence angle of the stray light 1362 at the third surface 1310-3 may be smaller than a TIR critical angle of the light guide 1110. Thus, the stray light 1362 may be refracted at the third surface 1310-3 toward the light absorptive layer 1150. The stray light 1164 may be absorbed by the light absorptive layer 1150.

Thus, the stray light 1361, which otherwise would be reflected at the third surface 1310-3 back to be incident onto out-coupling element 1345 again and being coupled out of the light guide 1310 via the out-coupling element 1345 toward the eye-box region 959, may be substantially absorbed by the light absorptive layer 1150. In other words, the amount to the stray light 1361 that is incident onto the out-coupling element 1345 again and coupled out of the light guide 1310 via the out-coupling element 1345 toward the eye-box region 959 may be significantly reduced. Accordingly, the image contrast of the virtual image perceived by the eye 960 located within the eye-box region 959 may be enhanced.

In some embodiments, although not shown, the system 1300 may also include an AR coating (e.g., the AR coating 1220 shown in FIGS. 12A and 12B) disposed at the third surface 1310-3 of the light guide 1310, and the stray light 1362 output from the second reflective lens 1180-2 and the stray light 1364 output from the first reflective lens 1180-1 may be incident onto the AR coating first then incident onto the light absorptive layer 1150. Thus, the reflection of the stray light 1362 and the stray light 1364 at the third surface 1310-3 of the light guide 1310 may be further reduced.

FIG. 13B illustrates an x-z sectional views of a display system 1350 configured to reduce a stray light and improve a contrast ratio, according to an embodiment of the present disclosure. The display system 1350 may include elements, structures, and/or functions that are the same as or similar to those included in the display system 1100 shown in FIGS. 11A and 11B, the display system 1200 shown in FIGS. 12A and 12B, or the display system 1300 shown in FIG. 13A. Descriptions of the same or similar elements, structures, and/or functions can refer to the above descriptions rendered in connection with FIGS. 11A and 11B, FIGS. 12A and 12B, or FIG. 13A.

As shown in FIG. 13B, the system 1350 may include the light source assembly 1105, a light guide (or waveguide) 1370, the in-coupling element 1335 and the out-coupling element 1345, the AR coating 1220, the light absorptive layer 1150, and the controller 1115. The in-coupling element 1335 and the out-coupling element 1345 may be embedded inside the light guide 1210. The light guide 1370 may have a first surface 1370-1 facing the eye-box region 1359, a second surface 1370-2 opposite to the first surface 1370-1, a third surface 1370-3, and a fourth surface 1370-4 opposite to the third surface 1370-3. The third surface 1370-3 and the fourth surface 1370-4 may be located between the first surface 1370-1 and the second surface 1370-2. In some embodiments, the first surface 1370-1 may be parallel to the second surface 1370-2, whereas the third surface 1370-3 may not be parallel to the fourth surface 1370-4. The third surface 1370-3 may be slanted with respect to the first surface 1370-1 or the second surface 1370-2, forming an acute angle with one of the first surface 1370-1 and the second surface 1370-2, and an obtuse angle with the other of the first surface 1370-1 and the second surface 1370-2. For discussion purposes, FIG. 13B shows that the third surface 1370-3 forms an acute angle with one of the second surface 1370-2, and an obtuse angle with the first surface 1370-1.

The AR coating 1220 and the light absorptive layer 1150 may be disposed at the third surface 1370-3 of the light guide 1370. The AR coating 1220 may be positioned before the light absorptive layer 1150 in the optical path of the stray light 1361. That is, the stray light 1361 may be firstly incident onto the AR coating 1220, and transmitted through the AR coating 1220 toward the light absorptive layer 1150. In some embodiments, the in-coupling element 1335 may be embedded inside a first portion (e.g., an input portion) of the light guide 1370. The out-coupling element 1345 may be embedded inside a second portion (e.g., an output portion) of the light guide 1370. The AR coating 1220 and the light absorptive layer 1150 may be disposed at a third portion of the light guide 1370. The second portion of the light guide 1370 where the out-coupling element 1345 is embedded may be between the third portion of the light guide 1370 where the AR coating 1220 and the light absorptive layer 1150 are disposed and the first portion of the light guide 1370 where the in-coupling element 1335 is embedded.

The out-coupling element 1345 may couple a first portion of the in-coupled image light 1331 out of the light guide 1370 as one or more output image lights 1332 propagating toward the eye-box region 959, whereas a second portion of the in-coupled image light 1331 that is not coupled out of the light guide 1370 via the out-coupling element 1345 may become the stray light 1361 (denoted by dashed arrows in FIG. 13B), which continues propagating inside the light guide 1370 toward the AR coating 1220. The AR coating 1220 may be configured to reduce the reflection of the stray light 1361 and, thus, increase the transmission of the stray light 1361. For example, the AR coating 1220 may be configured to substantially transmit the stray light 1361 toward the light absorptive layer 1150. The light absorptive layer 1150 may be configured to substantially absorb the stray light 1361 received from the AR coating 1220. That is, the stray light 1361, which otherwise would be reflected at the third surface 1370-3 back to be incident onto out-coupling element 1345 again and being coupled out of the light guide 1370 via the out-coupling element 1345 toward the eye-box region 959, may be substantially absorbed by the light absorptive layer 1150. Thus, the amount to the stray light 1361 that is incident onto the out-coupling element 1345 again and coupled out of the light guide 1370 via the out-coupling element 1345 toward the eye-box region 959 may be significantly reduced. Accordingly, the image contrast of the virtual image perceived by the eye 960 located within the eye-box region 959 may be enhanced.

The configuration of the display system 1100 shown in FIGS. 11A and 11B, the display system 1200 shown in FIGS. 12A and 12B, the display system 1300 shown in FIG. 13A, and the display system 1150 shown in FIG. 13B are used as example display systems in illustrating and explaining the operation principles of reducing the stray light and improving the contrast ratio. The operation principles of using the reflective lens 1180, the light absorption layer 1150, and the AR coating 1220 to reduce the stray light and improve the contrast ratio may be applicable to any suitable display systems, other than the display systems disclosed herein.

Referring back to FIGS. 9A and 9B, in some embodiments, the left-eye and right-eye display systems 910L and 910R each may include a display system configured to generate an image light representing a virtual image, and direct the image light toward the eye-box region 959, such as the display system 1100 shown in FIGS. 11A and 11B, the display system 1200 shown in FIGS. 12A and 12B, the display system 1300 shown in FIG. 13A, or the display system 1350 shown in FIG. 13B. The left-eye and right-eye display systems 910L and 910R each may reduce the stray light and improve the contrast ratio. Thus, the image quality of the left-eye and right-eye display systems 910L and 910R may be improved.

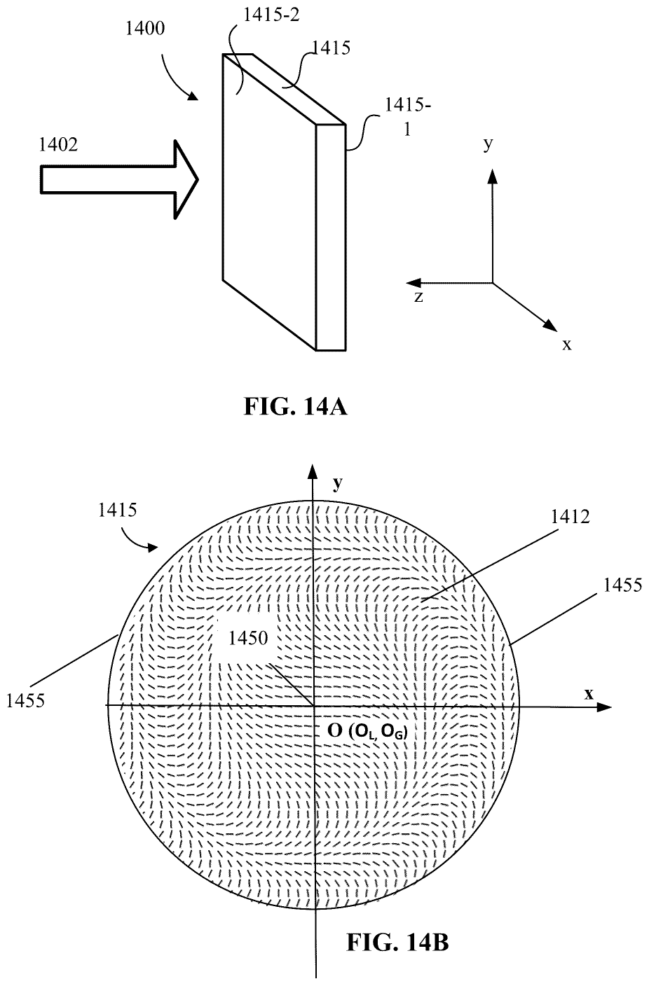

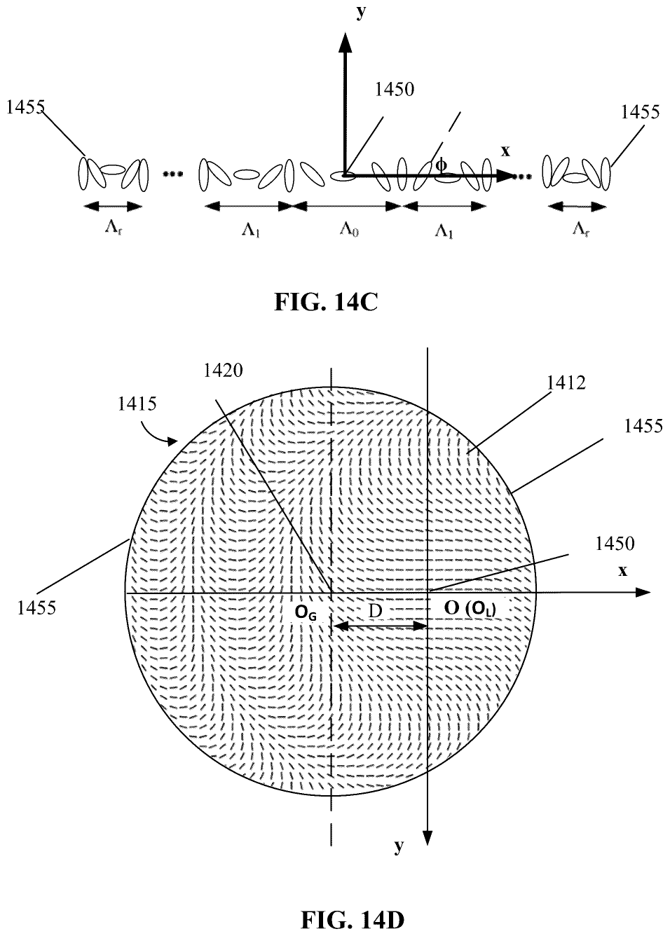

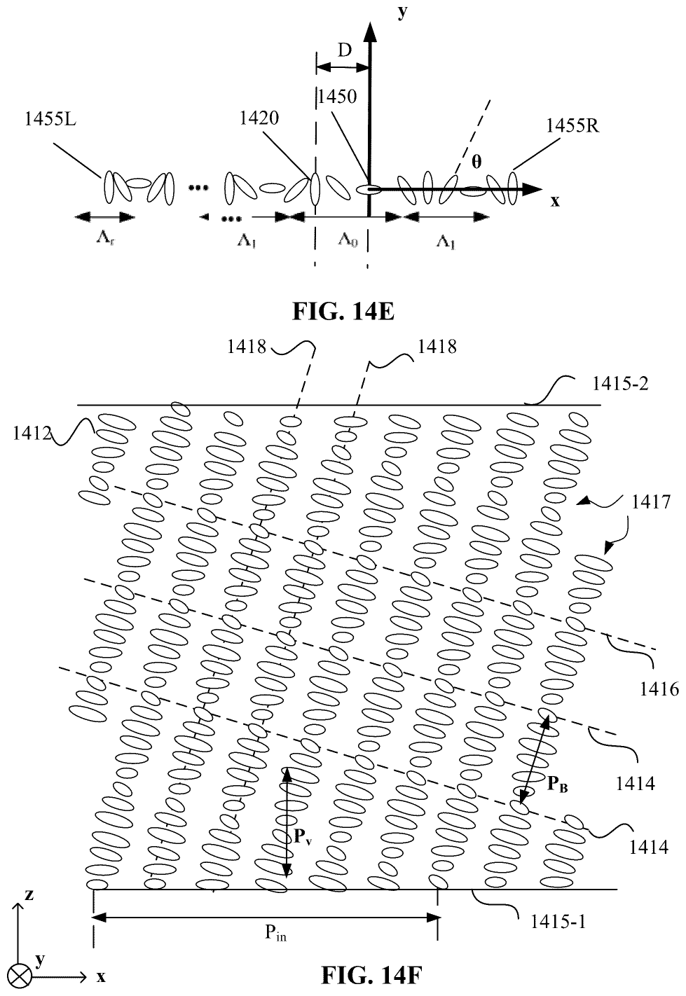

FIG. 14A illustrates a schematic three-dimensional (“3D”) view of a PVH element 1400 with a light 1402 incident onto the PVH element 1400 along a −z-axis, according to an embodiment of the present disclosure. The PVH element 1400 may be an embodiment of the reflective lens 1180 shown in FIGS. 11A and 11B. As shown in FIG. 14A, although the PVH element 1400 is shown as a rectangular plate shape for illustrative purposes, the PVH element 1400 may have any suitable shape, such as a circular shape. In some embodiments, one or both surfaces along the light propagating path of the light 1402 may have curved shapes. In some embodiments, the PVH element 1400 may be fabricated based on a birefringent medium, e.g., liquid crystal (“LC”) materials, which may have an intrinsic orientational order of optically anisotropic molecules that may be locally controlled during the fabrication process. In some embodiments, the PVH element 1400 may be fabricated based on a photosensitive polymer, such as an amorphous polymer, an LC polymer, etc., which may generate an induced (e.g., photo-induced) optical anisotropy and/or an induced (e.g., photo-induced) optic axis orientation. In some embodiments, the PVH element 1400 may be fabricated based on meta materials.

In some embodiments, the PVH element 1400 may include a birefringent medium (e.g., an LC material) in a form of a layer, which may be referred to as a birefringent medium layer (e.g., an LC layer) 1415. The birefringent medium layer 1415 may have a first surface 1415-1 on one side and a second surface 1415-2 on an opposite side. The first surface 1415-1 and the second surface 1415-2 may be surfaces along the light propagating path of the incident light 1402. The birefringent medium layer 1415 may include optically anisotropic molecules (e.g., LC molecules) configured with a three-dimensional (“3D”) orientational pattern to provide a polarization selective optical response.

FIGS. 14B-14E schematically illustrate x-y sectional views of a portion of the PVH element 1400 shown in FIG. 14A, showing in-plane orientations of the optically anisotropic molecules 1412 in the PVH element 1400, according to various embodiments of the present disclosure. For discussion purposes, rod-like LC molecules 1412 are used as examples of the optically anisotropic molecules 1412 of the birefringent medium layer 1415. The rod-like LC molecule 1412 may have a longitudinal axis (or an axis in the length direction) and a lateral axis (or an axis in the width direction). The longitudinal axis of the LC molecule 1412 may be referred to as a director of the LC molecule 1412 or an LC director. An orientation of the LC director may determine a local optic axis orientation or an orientation of the optic axis at a local point of the birefringent medium layer 1415. For illustrative purposes, the LC directors of the LC molecules 1412 shown in FIGS. 14B-14F are presumed to be at the surface of the birefringent medium layer 1415 or in a plane parallel with the surface with substantially small tilt angle (or slant angle)s with respect to the surface.

FIG. 14B schematically illustrate an x-y sectional view of a portion of the PVH element 1400, showing a radially varying in-plane orientation pattern of the orientations of the LC directors of the LC molecules 1412 located in close proximity to or at a surface (e.g., at least one of the first surface 1415-1 or the second surface 1415-2) of the birefringent medium layer 1415 shown in FIG. 14A. FIG. 14C illustrates a section of the in-plane orientation pattern taken along a y-axis in the birefringent medium layer 1415 shown in FIG. 14C, according to an embodiment of the present disclosure. In some embodiments, the PVH element 1400 with the LC director orientations shown in FIGS. 14B and 14C may function as an on-axis focusing PVH lens.

As shown in FIG. 14B, the orientations of the LC molecules 1412 located in close proximity to or at a surface (e.g., at least one of the first surface 1415-1 or the second surface 1415-2) of the birefringent medium layer 1415 may be configured with an in-plane orientation pattern having a varying pitch in at least two opposite in-plane directions from a lens center (“O”) 1450 to opposite lens peripheries 1455. For example, the orientations of the LC directors of LC molecules 1412 located in close proximity to or at the surface of the birefringent medium layer 1415 may exhibit a continuous rotation in at least two opposite in-plane directions (e.g., a plurality of opposite radial directions) from the lens center 1450 to the opposite lens peripheries 1455 with a varying pitch. The orientations of the LC directors from the lens center 1450 to the opposite lens peripheries 1455 may exhibit a rotation in the same rotation direction (e.g., clockwise, or counter-clockwise). A pitch Λ of the in-plane orientation pattern may be defined as a distance in the in-plane direction (e.g., a radial direction) over which the orientations of the LC directors (or azimuthal angles ϕ of the LC molecules 1412) change by a predetermined angle (e.g., 180°) from a predetermined initial state.

As shown in FIG. 14C, according to the LC director field along the x-axis direction, the pitch Λ may be a function of the distance from the lens center 1450. The pitch Λ may monotonically decrease from the lens center 1450 to the lens peripheries 1455 in the at least two opposite in-plane directions (e.g., two opposite radial directions) in the x-y plane, e.g., Λ₀>Λ₁> . . . >Λᵣ. Λ₀ is the pitch at a central region of the lens pattern, which may be the largest. The pitch Λᵣ is the pitch at a periphery region (e.g., periphery 1455) of the lens pattern, which may be the smallest. In some embodiments, the azimuthal angle ϕ of the LC molecule 1412 may change in proportional to the distance from the lens center 1450 to a local point of the birefringent medium layer 1415 at which the LC molecule 1412 is located. In some embodiments, the in-plane orientation pattern of the orientations of the LC directors shown in FIGS. 14B and 14C may also be referred to as a lens pattern (e.g., a spherical lens pattern).

As shown in FIGS. 14B and 14C, a lens pattern center (O_{L}) and a geometry center (O_{G}) (e.g., a center of lens aperture) of the PVH element 1400 functioning as an on-axis focusing PVH lens may substantially overlap with one another, at the lens center (“O”) 1450. The lens pattern center (O_{L}) may be a center of the lens pattern of an on-axis focusing PVH lens, and may also be a symmetry center of the lens pattern. The geometry center (O_{G}) may be defined as a center of a shape of the effective light receiving area (i.e., an aperture) of an on-axis focusing PVH lens.

FIG. 14D schematically illustrates an x-y sectional view of a portion of the PVH element 1400, showing a radially varying in-plane orientation pattern of the orientations of the LC directors of the LC molecules 1412 located in close proximity to or at a surface (e.g., at least one of the first surface 1415-1 or the second surface 1415-2) of the birefringent medium layer 1415 shown in FIG. 14A. FIG. 14E illustrates a section of the in-plane orientation pattern taken along a y-axis in the birefringent medium layer 1415 shown in FIG. 14D, according to an embodiment of the present disclosure. In some embodiments, the PVH element 1400 with the LC director orientations shown in FIGS. 14D and 14E may function as an off-axis focusing PVH lens.

As shown in FIGS. 14D and 14E, the orientations of the LC molecules 1412 located in close proximity to or at a surface (e.g., at least one of the first surface 1415-1 or the second surface 1415-2) of the birefringent medium layer 1415 may be configured with an in-plane orientation pattern having a varying pitch in at least two opposite in-plane directions from a lens pattern center (O_{L}) 1450 to opposite lens peripheries 1455. The lens pattern center (O_{L}) 1450 and a geometry center (O_{G}) 1420 of an off-axis focusing PVH lens may not overlap with one another. Instead, the lens pattern center (O_{L}) 1450 may be shifted by a predetermined distance D in a predetermined direction (e.g., the x-axis direction in FIGS. 14D and 14E) from the geometry center (O_{G}) 1420. An off-axis focusing PVH lens may be considered as a lens obtained by shifting the lens pattern center of a corresponding on-axis focusing PVH lens with respect to the geometry center of the on-axis focusing PVH lens. The lens pattern center of the corresponding on-axis focusing PVH lens may also be a lens pattern center of the off-axis focusing PVH lens. That is, the off-axis focusing PVH lens may have an on-axis focusing counterpart with the same lens pattern center.

The in-plane orientation patterns of the LC directors shown in FIGS. 14B-14E are for illustrative purposes. The PVH element 1400 may have any suitable in-plane orientation patterns of the LC directors. For example, in some embodiments, the PVH element 1400 may be configured with an in-plane orientation pattern corresponding to a cylindrical lens, an aspheric lens, or a freeform lens, and the PVH element 1400 may function as a cylindrical lens, an aspheric lens, or a freeform lens, etc.

FIG. 14F schematically illustrates an x-z sectional views of a portion of the PVH element 1400, showing out-of-plane orientations of the LC directors of the LC molecules 1412 in the PVH element 1400, according to an embodiment of the present disclosure. As shown in FIG. 14F, within a volume of the birefringent medium layer 1415, the LC molecules 1412 may be arranged in a plurality of helical structures 1417 with a plurality of helical axes 1418 and a helical pitch Ph along the helical axes. The azimuthal angles of the LC molecules 1412 arranged along a single helical structure 1417 may continuously vary around a helical axis 1418 in a predetermined rotation direction, e.g., clockwise direction or counter-clockwise direction. In other words, the orientations of the LC directors of the LC molecules 1412 arranged along a single helical structure 1417 may exhibit a continuous rotation around the helical axis 1418 in a predetermined rotation direction. Accordingly, the helical structure 1417 may exhibit a handedness, e.g., right handedness or left handedness. The helical pitch Pₕ may be defined as a distance along the helical axis 1418 over which the orientations of the LC directors exhibit a rotation around the helical axis 1418 by 360°, or the azimuthal angles of the LC molecules vary by 360°. The helical axes 1418 of helical structures 1417 may be tilted with respect to the first surface 1415-1 and/or the second surface 1415-2 of the birefringent medium layer 1415 (or with respect to the thickness direction of the birefringent medium layer 1415). For example, the helical axes 1418 of the helical structures 1417 may have an acute angle or obtuse angle with respect to the first surface 1415-1 and/or the second surface 1415-2 of the birefringent medium layer 1415.

Within the volume of the birefringent medium layer 1415, the LC molecules 1412 from the plurality of helical structures 1417 having a first same orientation (e.g., same tilt angle (or slant angle) and azimuthal angle) may form a first series of parallel refractive index planes 1414 periodically distributed. Although not labeled, the LC molecules 1412 with a second same orientation (e.g., same tilt angle (or slant angle) and azimuthal angle) different from the first same orientation may form a second series of parallel refractive index planes periodically distributed within the volume of the birefringent medium layer 1415. Different series of parallel refractive index planes may be formed by the LC molecules 1412 having different orientations. In the same series of parallel and periodically distributed refractive index planes 1414, the LC molecules 1412 may have the same orientation and the refractive index may be the same. Different series of refractive index planes 1414 may correspond to different refractive indices. When the number of the refractive index planes 1414 (or the thickness of the birefringent medium layer) increases to a sufficient value, Bragg diffraction may be established according to the principles of volume gratings. Thus, the periodically distributed refractive index planes 1414 may also be referred to as Bragg planes 1414. Within the birefringent medium layer 1415, there may exist different series of Bragg planes. A distance (or a period) between adjacent Bragg planes 1414 of the same series may be referred to as a Bragg period P_{B}.

The PVH element 1400 may be configured with an operating wavelength range (or band). For discussion purposes, a light having a wavelength range within the designed operating wavelength range (or band) of the PVH element 1400 may also be referred to as a light associated with the operating wavelength range (or band) of the PVH element 1400. A light having a wavelength outside of the operating wavelength band of the PVH element 1400 may be referred to as a light not associated with the operating wavelength range (or band) of the PVH element 1400.

For a circularly polarized light associated with the operating wavelength range, the PVH element 1400 may selectively backwardly diffract or transmit (with negligible diffraction) the circularly polarized light, depending on the handedness of the circularly polarized light. In some embodiments, referring to FIG. 14F, the handedness of the helical structures 1417 may define the polarization selectivity of the PVH element 1400 for a circularly polarized light associated with the operating wavelength range. In some embodiments, the PVH element 1400 may substantially backwardly diffract the circularly polarized light, when the circularly polarized light has a handedness that is the same as the handedness of the helical structures 1417, and substantially transmit (e.g., with negligible diffraction) the circularly polarized light, when the circularly polarized light has a handedness that is opposite to the handedness of the helical structures 1417.

In some embodiments, depending on the handedness of the helical structures 1417 within the PVH element 1400, the PVH element 1400 may be referred to as a left-handed or right-handed R-PVH grating. For example, a left-handed R-PVH element may be configured to substantially backwardly diffract a left-handed circularly polarized (“LHCP”) light associated with the operating wavelength band, and substantially transmit (e.g., with negligible diffraction) a right-handed circularly polarized (“RHCP”) light associated with the operating wavelength band. A right-handed R-PVH element may be configured to substantially backwardly diffract an RHCP light associated with the operating wavelength band, and substantially transmit (e.g., with negligible diffraction) an LHCP light associated with the operating wavelength band.

In some embodiments, for a light (e.g., circularly polarized light) having a wavelength outside of the operating wavelength band (or not associated with the operating wavelength band) of the PVH element 1400, the PVH element 1400 may substantially transmit the light, for example, independent of the polarization of the light (e.g., independent of the handedness of the circularly polarized light).

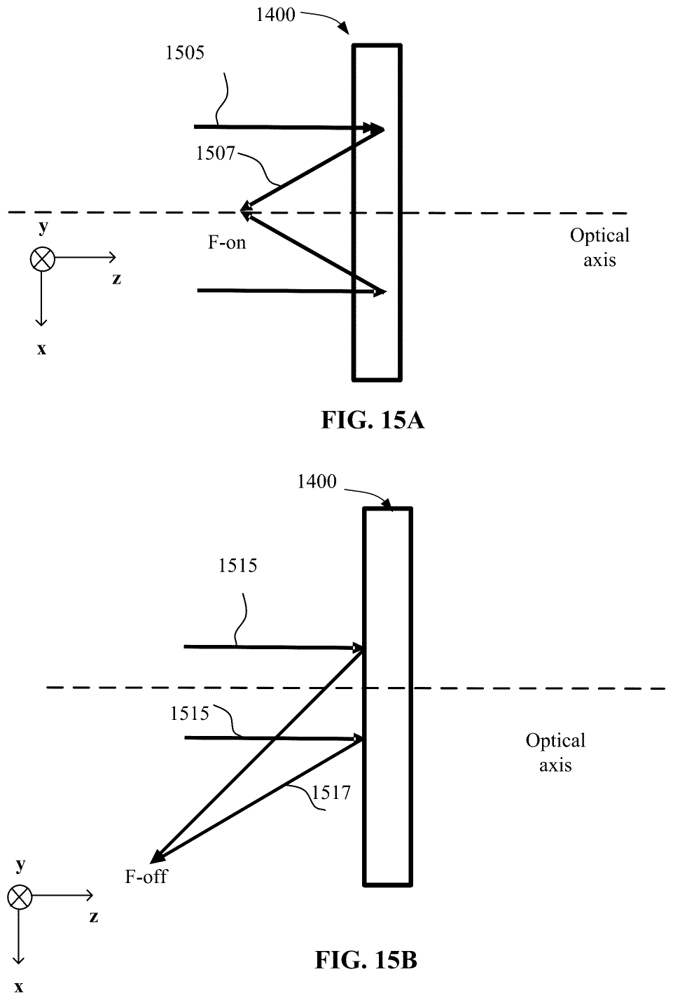

FIG. 15A schematically illustrates diffraction and transmission of the PVH element 1400 shown in FIG. 14A functioning as an on-axis focusing PVH lens, according to an embodiment of the present disclosure. FIG. 15B schematically illustrates diffraction and transmission of the PVH element 1400 shown in FIG. 14A functioning as an off-axis focusing PVH lens, according to an embodiment of the present disclosure. For discussion purposes, the PVH element 1400 may be a left-handed and reflective PVH element, with the operating wavelength band in the visible spectrum.

In the embodiment shown in FIG. 15A, the PVH element 1400 may function as an on-axis focusing PVH lens (also referred to as 1400). For discussion purposes, an LHCP light (e.g., LHCP visible light) 1505 associated with the operating wavelength band may be an on-axis light, and may be normally incident onto the on-axis focusing PVH lens 1400. As shown in FIG. 15A, the on-axis focusing PVH lens 1400 may substantially backwardly diffract and converge the LHCP light (e.g., LHCP IR light) 1505 as a convergent light 1507. The rays of the convergent light 1517 may intersect at an on-axis focal point F-on. The on-axis focal point F-off may be located within a focal plane of the on-axis focusing PVH lens 1400, and may be substantially at an intersecting point between the focal plane and the optical axis of the on-axis focusing PVH lens 1400.

In the embodiment shown in FIG. 15B, the PVH element 1400 may function as an off-axis focusing PVH lens (also referred to as 1400). For discussion purposes, the off-axis focusing PVH lens 1400 shown in FIG. 15B may be an off-axis converging lens. For discussion purposes, an LHCP light (e.g., LHCP visible light) 1515 associated with the operating wavelength band may be an on-axis light, and may be normally incident onto the off-axis focusing PVH lens 1400. As shown in FIG. 15B, the off-axis focusing PVH lens 1400 may substantially backwardly diffract and converge the LHCP light (e.g., LHCP IR light) 1515 as a convergent light 1517. The rays of the convergent light 1517 may intersect at an off-axis focal point F-off. The off-axis focal point F-off may be located within a focal plane of the off-axis focusing PVH lens 1400, and may be offset from an intersecting point between the focal plane and the optical axis of the off-axis focusing PVH lens 1400.

In some embodiments, the present disclosure provides a device. The device includes a light guide configured to guide a light to propagate inside the light guide via total internal reflection; a reflective lens disposed at a first surface of the light guide; a light absorption layer disposed at a second surface of the light guide that is non-parallel to the first surface; and an out-coupling element configured to couple a first portion of the light out of the light guide as one or more output lights, a second portion of the light that is not coupled out of the light guide becoming a stray light propagating inside the light guide toward the second surface. The reflective lens is configured to reflect the stray light toward the light absorption layer, and the light absorption layer is configured to substantially absorb the stray light.

In some embodiments, the out-coupling element is located at a first portion of the light guide, and the reflective lens and the light absorption layer are located at a second portion of the light guide. In some embodiments, the device further includes an in-coupling element located at a third portion of the light guide and configured to couple an input light into the light guide as the light propagating inside the light guide via total internal reflection, the first portion of the light guide being located between the second portion of the light guide and the third portion of the light guide. In some embodiments, the reflective lens includes a diffractive lens configured to reflect and focus the second portion of the light toward the light absorption layer. In some embodiments, the stray light is a first stray light, the reflective lens is configured to reflect and focus the first stray light as a second stray light propagation toward the light absorption layer, and a diffraction angle of the second stray light is configured to render the second stray light refracted at the second surface of the light guide toward the light absorption layer.

In some embodiments, the reflective lens is a first reflective lens, and the device further comprises a second reflective lens disposed at a third surface that is opposite to the first surface. In some embodiments, each of the first reflective lens and the second reflective lens includes a diffractive lens. In some embodiments, the second portion of the light is a first stray light, the first reflective lens is configured to reflect and focus the first stray light as a second stray light propagation toward the light absorption layer, the light absorption layer is configured to absorb a first portion of the second stray light, and reflect a second portion of the second stray light as a third stray light propagation toward the second reflective lens, and the second reflective lens is configured to reflect and focus the third stray light as a fourth stray light propagation toward the light absorption layer, and the light absorption layer is configured to absorb the fourth stray light.

In some embodiments, the device further includes an anti-reflection coating disposed at the second surface of the light guide, wherein the reflective lens is configured to reflect the second portion of the light toward the anti-reflection coating, the anti-reflection coating is configured to reduce a reflection of the second portion of the light and increase a transmission of the second portion of the light toward the light absorption layer, and the light absorption layer is configured to substantially absorb the second portion of the light received from the anti-reflection coating. In some embodiments, the light guide has a third surface opposite to the first surface of the light guide, and the out-coupling element is disposed at the first surface or the third surface. In some embodiments, the out-coupling element is embedded inside the light guide.

In some embodiments, the present disclosure provides a device. The device includes a light guide configured to guide a light to propagate inside the light guide via total internal reflection, the light guide having a first surface and a second surface having a predetermined tilt angle with respect to the first surface; an out-coupling element disposed at the first surface and configured to couple a first portion of the light out of the light guide as one or more output lights, a second portion of the light that is not coupled out of the light guide becoming a stray light propagating inside the light guide toward the second surface; and an anti-reflection coating and a light absorption layer disposed at the second surface of the light guide. The anti-reflection coating is configured to substantially transmit the stray light toward the light absorption layer, and the light absorption layer is configured to substantially absorb the stray light received from the anti-reflection coating.

In some embodiments, the predetermined tilt angle is configured to render the stray light refracted at the second surface of the light guide toward the anti-reflection coating. In some embodiments, the out-coupling element is located at a first portion of the light guide, and the anti-reflection coating and the light absorption layer are located at a second portion of the light guide. In some embodiments, the device further includes an in-coupling element located at a third portion of the light guide and configured to couple an input light into the light guide as the light propagating inside the light guide via total internal reflection, the first portion of the light guide being located between the second portion of the light guide and the third portion of the light guide. In some embodiments, the light absorptive layer includes at least one of a black paint or ink, carbon black, organic dyes, or carbon nanotubes.

The present disclosure further provides optical devices and fabrication methods and, more specifically, to a stress-neutral optical coating, an optical device including the stress-neutral optical coating, and a fabrication method thereof. Optical films and coatings are thin layers of materials that are applied to a surface of optical components, such as lenses, mirrors, and prisms, to modify their optical properties. Optical films and coatings may improve the optical performance of the optical components by controlling the reflection, transmission, and/or absorption of light. Common types of optical coatings include anti-reflection coatings, which reduce surface reflection and increase transmission, and mirror coatings, and reflect light with high efficiency. Optical films and coatings play a critical role in many applications, including displays, cameras, and telescopes.

The fabrication of optical films and coatings typically involves a multi-step process including depositing thin layers of material onto an optical substrate using various techniques. The most common methods for depositing optical films and coatings include evaporation, sputtering, chemical vapor deposition, physical vapor deposition, Sol-Gel, etc. The choice of deposition method depends on the material being deposited, the desired film thickness, and the desired optical properties of the film. After deposition, the film may undergo additional processing steps, such as annealing, to improve its optical and mechanical properties. The deposition process is controlled in order to produce films with uniform thickness, small stress, and the desired optical properties.

An optical device or element may include a substrate and one or more optical films formed on the substrate. In many applications, a plurality of optical films may be formed on the substrate in a stack. The optical films are typically thin film coatings. The thin film coatings deposited on a plastic substrate through physical vapor deposition may undergo exposure to high temperature and high humidity cyclic environment. In such an environment, certain films may experience water vapor ingression and egression issues, causing degradation in the optical performance and physical performance of the final product. In addition, when one or more thin film layers are deposited on a substrate, stress generated in the deposited films may adversely affect the optical performance and physical performance of the final product. In the ophthalmic industry, the deposition of the thin film coatings on the plastic substrate can lack robust and reliable performance. Spectral performance of ophthalmic coatings are generally limited by the number of coating layers and stress properties of the deposited films.

The present disclosure provides a coating deposition process (or method) for fabricating a stress-neutral optical coating. The present disclosure provides a high-layer count optical coating of superior optical performance since a large number of layers can be deposited without compromise of physical properties. The present disclosure also provides a substrate system on which the stress-neutral optical coating may be fabricated via the coating deposition process (or method) disclosed herein. The present disclosure also provides an optical device that includes the substrate system disclosed herein and the stress-neutral optical coating fabricated via the coating deposition process (or method) disclosed herein. The stress-neutral optical coating and the optical device can provide excellent optical performance, with reliability performance that meets or exceeds standard ophthalmic industry requirements.

Unlike convention ophthalmic coating processes, the coating deposition method disclosed herein may be used to fabricate any suitable optical coating including high layer count thin film stacks, such as a high-performance anti-reflection coating with a broadened bandwidth, a beam splitter, a solar reflector stack, a UV attenuation filter, a brightness enhancement film, and a privacy film, etc. The substrate system may include a 3D printed material, and other low Tg-type substrates, (here Tg is the glass transition temperature) along with standard ophthalmic industry substrates such as polycarbonate, cyclo olefin polymer (“COP”), cyclic olefin copolymer (“COC”), and etc. The coating process also has shown excellent reliability on a substrate system without standard hard coatings normally required for environmental robustness. The coating process and substrate system disclosed herein may be tunable, using a variety of coating materials and buffer layers, to achieve specific stress properties that are unique for different types of substrate systems used, such as those including a 3D printed substrate (e.g., functioning as a lens) using Poly(methyl methacrylate) (“PMMA”), COP, COC, Polycarbonates (“PC”), etc., a diamond-turned plastic substrate, an injection molded plastic substrate, a cast-molded plastic substrate, etc., with or without hard coating. By tuning or optimizing the coating deposition process parameters or variables and the materials, the stress level in the fabricated multi-layer film stack may be controlled or tuned to a specific level or to be below a specific level.

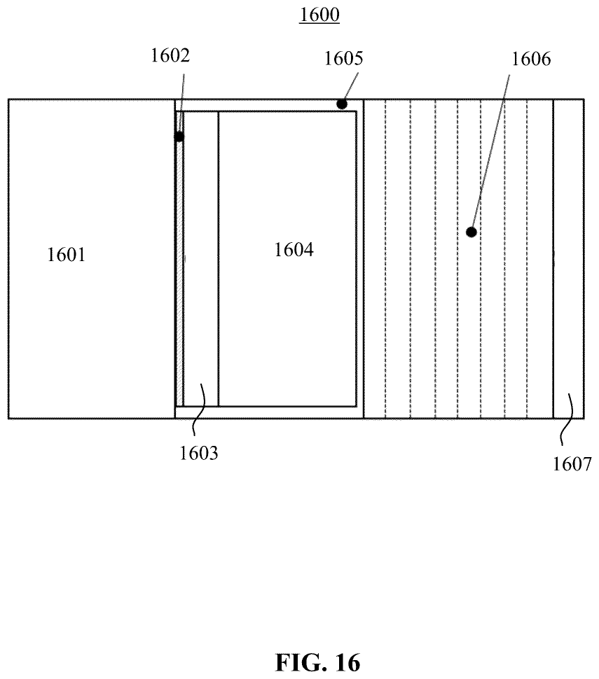

FIG. 16 schematically illustrates an optical device 1600 including an optical coating fabricated via a coating deposition method disclosed herein, according to an embodiment of the present disclosure. In the following descriptions, physical vapor deposition (“PVD”) is used as an example of the coating deposition process. It is understood that any suitable process other than PVD may also be used for fabricating the coating. For illustrative purposes, the various elements included in the optical device 1600 are shown as having flat surfaces. In some embodiments, although not shown, at least one element included in the optical device 1600 may have a curved surface.

The optical device 1600 may include a first element 1601. The first element 1601 may be a substrate. The substrate may be made of any suitable material, such as glass, plastic, silicon carbide, etc. In some embodiments, the first element 1601 may function as or include a waveguide, a surface relief grating (“SRG”), a volume Bragg grating (“VBG”), a display (e.g., an AR or VR display), etc. In some embodiments, the waveguide may be coupled with one or more gratings disposed on one or more surfaces of the waveguide. In some embodiments, the waveguide may be a geometric waveguide with embedded mirrors. In some embodiments, the optical device 1600 may include a second element 1602 formed on a surface of the first element 1601 using any suitable method or process. In some embodiments, the second element 1602 may include a low refractive index matching layer fabricated based on a material having a low refractive index (e.g., lower than the refractive index of the first element 1601). In some applications, for example, when the first element 1601 function as a waveguide, the low refractive index layer may enable total internal reflection of a light at the interface between the waveguide and the low refractive index matching layer. The low refractive index layer may be optional.

The optical device 1600 may include a third element 1603 formed on the second element 1602, or may be directly formed on the first element 1601 if the second element 1602 is omitted. The third element 1603 may be fabricated using any suitable method or process. In some embodiments, the third element 1603 may include a buffer layer that may be a compliant stress-balancing layer. For example, the buffer layer may include an optically clear adhesive layer, a liquid optically clear adhesive layer, or a 3D printed soft optical material layer. The optical device 1600 may include a fourth element 1604 formed on the third element 1603. The fourth element 1604 may include an optical element providing a suitable optical function. For example, the fourth element 1604 may function as a lens, a prims, a mirror, a grating, or a combination thereof, etc. In some embodiments, the fourth element 1604 may include a 3D-printed optical element, a diamond-turned plastic optical element, an injection molded optical element, a cast-molded plastic optical element, or an optical element fabricated via other suitable method.

Water vapor ingression and egression may cause the optical performance and the reliability of the fourth element 1604 to degrade. To reduce the degradation caused by the water vapor, the optical device 1600 may include a fifth element 1605. The fifth element 1605 may include a water vapor transport barrier layer configured to seal the second element 1602 (if included), the third element 1603, and the fourth element 1604 disposed on the first element 1601. The water vapor transport barrier layer may block water vapor ingression and egression into and from the layers being sealed, including the fourth element 1604. The fifth element 1605 may include an amorphous material, which may be capable of being deposited using a coating deposition process, such as a standard physical vapor deposition process. The fifth element 1605 may be configured with a thickness that is sufficient to provide moisture (or vapor) barrier capability, and may not substantially worsen the overall stress condition of the entire optical device 1600. In some embodiments, the fifth element 1605 may be configured for achieving overall stress balance of the optical device 1600. The fifth element 1605 may be fabricated via a suitable process, such as a deposition process with or without ion-assisted technique.

In some embodiments, the first element 1601 provided with the second element 1602 (if included), the third element 1603, the fourth element 1604, and the fifth element 1605 may also be referred to as a substrate system. For example, when the fourth element 1604 includes a 3D-printed optical element, a diamond-turned plastic optical element, an injection molded optical element, or a cast-molded plastic optical element, the first element 1601 provided with the fourth element 1604 may be referred to as 3D-printed substrate system, a diamond-turned substrate system, an injection molded substrate system, or a cast-molded substrate system.

The optical device 1600 may include a sixth element 1606 formed at the fifth element 1605 via a coating process disclosed herein. The sixth element 1606 may include a multilayer thin film stack (also referred to as 1606) that includes a plurality of thin layers (or films). The sixth element 1606 formed at the fifth element 1605 via a coating process disclosed herein may be stress-neutral or stress-balanced. In some embodiments, the optical device 1600 may include a seventh element 1607 formed at the sixth element 1606. The seventh element 1607 may include a hydrophobic layer (also referred to as 1607) disposed on the multilayer thin film stack 1606. The hydrophobic layer 1607 may protect the multilayer thin film stack 1606 from water, while providing an improved cleanability. In some embodiments, the optical device 1600 may include additional elements that are not shown in FIG. 16.

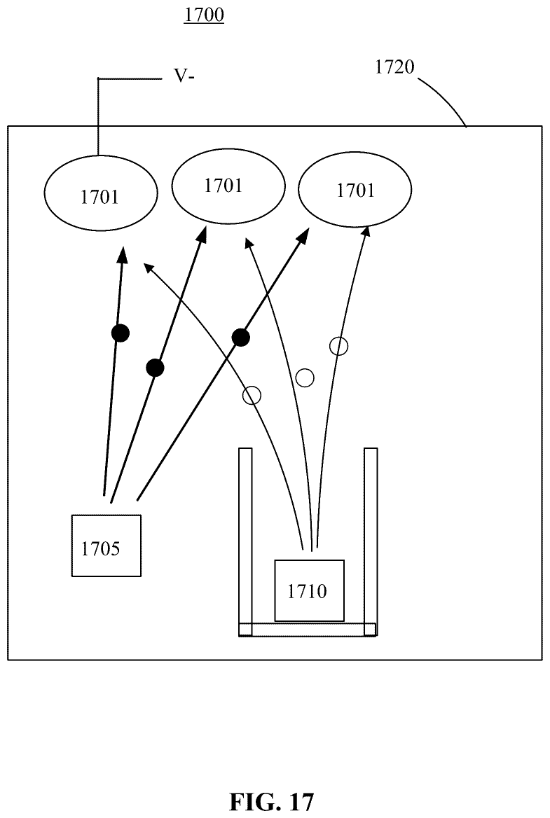

FIG. 17 schematically illustrates a physical vapor deposition chamber system 1700, which may be used to fabricate a disclosed stress-neutral optical coating on a substrate via a disclosed coating deposition process. The physical vapor deposition chamber system 1700 may be used in a coating process disclosed herein. As shown in FIG. 17, inside a coating chamber 1720, a solid target material (“target”) 1710 may be vaporized through a suitable method into a vapor phase. The atoms of the target material 1710 may be ionized, or compacted through collisions by ions generated by a plasma generating device 1705. A bias voltage (V) may be applied to a substrate or a plurality of substrates 1701 (that may be the substrate system shown in FIG. 16), or to the target material 1710. Under the electrical field, the ionized atoms of the target material 1710 may accelerate toward and be deposited onto the surface of the substrate 1701 to form a thin film (referred to as a deposited film).

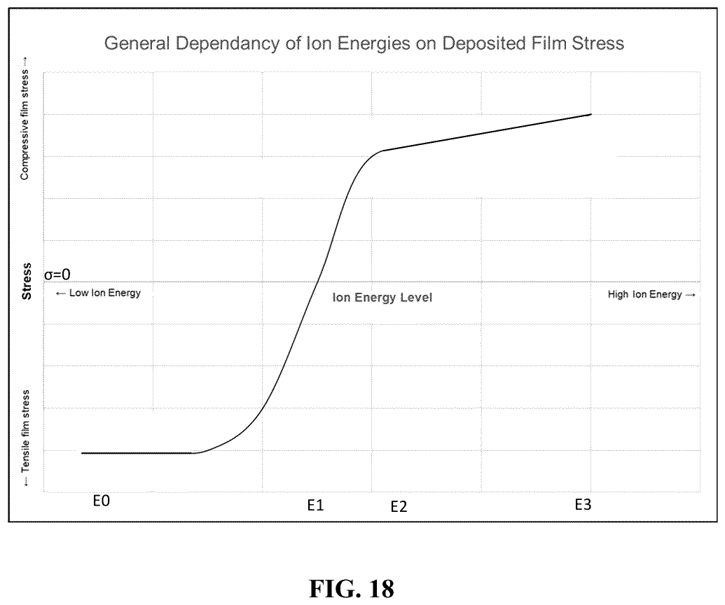

The inventors have observed that various process variables or parameters of the physical vapor deposition may affect the stress and/or the refractive index of the deposited film. For example, in ion-augmented deposition (involving advanced plasma source (“APS”) or ion-assisted deposition (“IAD”)), the ion energy level may affect the stress in the deposited film. FIG. 18 shows a relationship between the ion energy level and the stress (compressive stress and tensile stress) in the deposited film. As shown in FIG. 18, when the ion energy level decreases from E1 to E0, the tensile stress increases. When the energy level is at E1, the stress is substantially zero (or lower than a predetermined threshold value which is substantially close to zero). At this point, the film may be at a “stress free” or “stress-neutral” state. When the ion energy level increases from E1 to E2, the compressive stress increases. When the ion energy level increases from E2 to E3, the compressive stress continues to increase. Thus, the ion energy level may be controlled to be at or around E1, such that the stress in the deposited film may be at minimum or lower than a predetermined threshold value. The term “stress-free” or “stress-neutral” means that the stress is either zero or close to zero, e.g., at a very low level lower than a predetermined threshold value that is substantially close to zero. In the coating process, the ion energy level may be controlled to be within a small range around E1, such that the stress within the deposited film may be controlled to be within a small range around zero stress. For example, the ion energy level may be controlled within a range of [E1−ΔE, E1+ΔE], where ΔE is a predetermined small amount of ion energy. Correspondingly, the fabricated film may have a stress level lower than a small predetermined threshold value σ1 for compressive stress, and lower than a small predetermined threshold value σ2 for tensile stress, where σ1 and σ2 may have different or the same value. It is implicit from the above discussion that the “controlled” nature of the stress value allow for tunability to a particular stress value that is suitable for the film substrate combination.

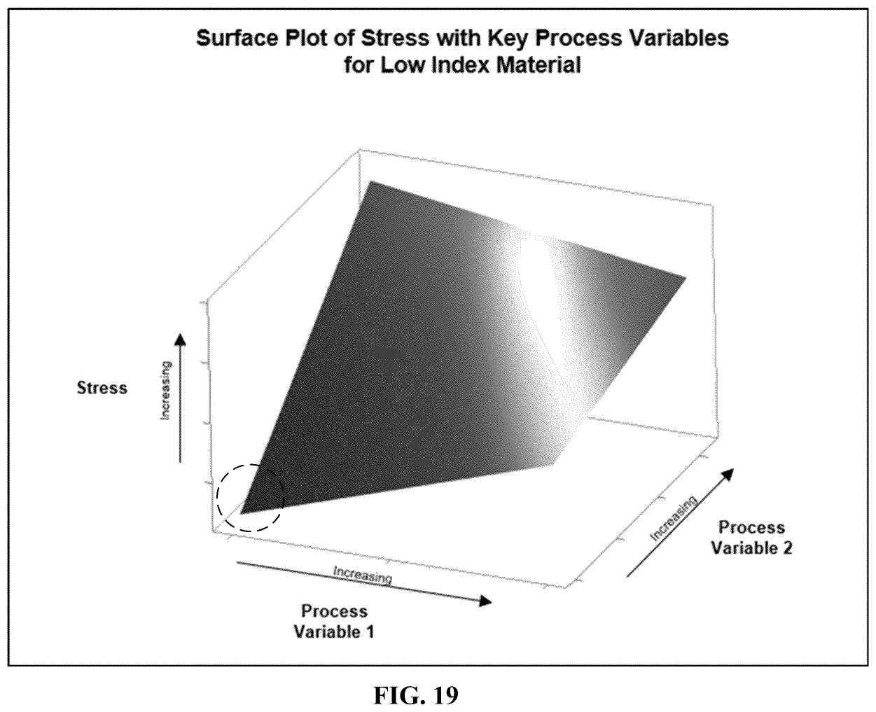

FIG. 19 shows the simulation results for design of experiments (“DOE”) work related to the measured thin film stress versus two process variables, Process Variable 1 and Process Variable 2, for a low refractive index target material (e.g., SiO₂) that forms the thin film (or deposited film), according to an embodiment of the present disclosure. The plot shown in FIG. 19 is a surface plot or 3D plot. In some embodiments, Process Variable 1 and Process Variable 2 may be the deposition rate and the bias voltage, respectively along with other process variable such as temperature. As shown in FIG. 19, the deposition rate and the bias voltage affect the stress in the deposited film. As the deposition rate (unit: nm/s) increases, the stress may increase. As the bias voltage increases, the stress in the deposited film may increase. There is a zone indicated by the dashed circle, where the stress in the deposited film may be minimum (i.e., smaller than a predetermined threshold value that is substantially close to zero).

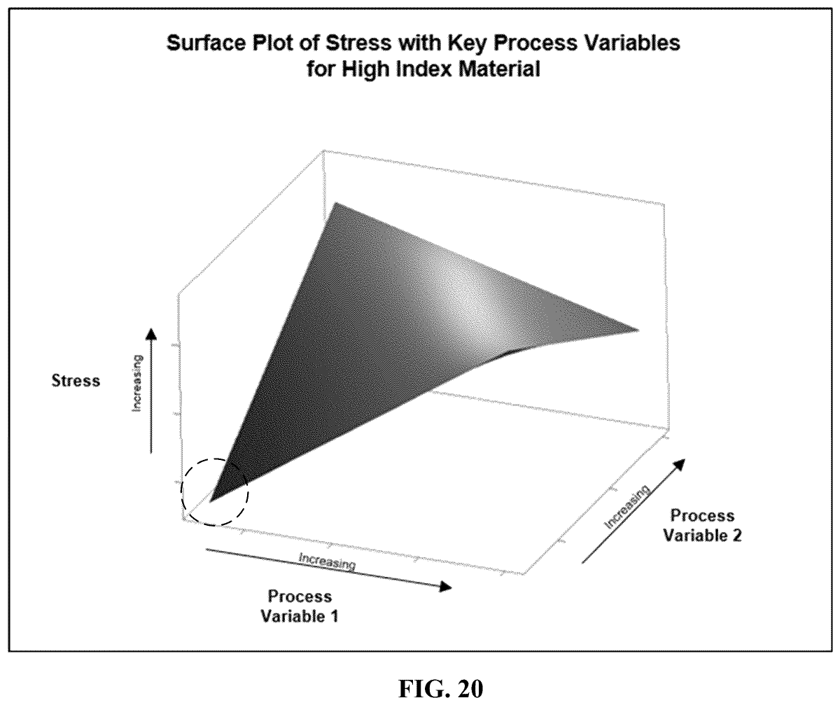

FIG. 20 shows the simulation results for experimental DOE work related to the measured thin film stress, Process Variable 1 and Process Variable 2, for a high refractive index target material (e.g., Nb₂O₅) that forms the thin film (or deposited film). The plot shown in FIG. 20 is a surface plot or 3D plot. In some embodiments, Process Variable 1 and Process Variable 2 may be the deposition rate and the bias voltage, respectively. As shown in FIG. 20, the deposition rate and the bias voltage affect the stress in the deposited film. As the deposition rate (nm/s) increases, the stress may increase. As the bias voltage increases, the stress in the deposited film may increase. There is a zone indicated by the dashed circle, where the stress in the deposited film may be minimum.

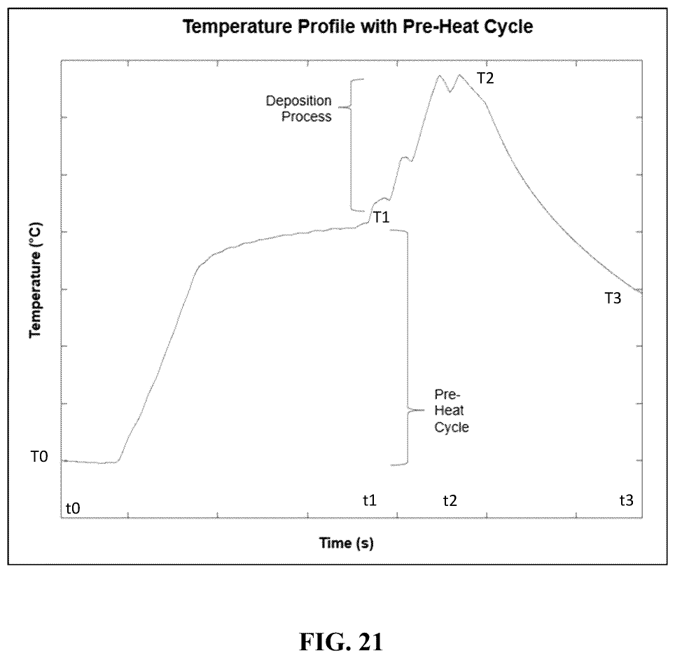

The temperature inside the coating chamber may also affect the stress in the deposited film. Thus, temperature may be optimized to minimize the stress. Factors that may affect the temperature includes emission characteristics of deposition sources, ion source, and special chamber setup, etc. FIG. 21 shows a temperature profile with pre-heat cycle. As shown in FIG. 21, during the pre-heat cycle, the temperature may be controlled to increase from T0 to T1 according to the profile shown in FIG. 21 from time t0 to t1. During the deposition process, from time t1 to time t2, the temperature may be controlled to increase from T1 to T2 according to the profile shown in FIG. 21. From time t2 to t3, the temperature in the coating chamber may be reduced from T2 to T3. The deposition temperature may be controlled by optimizing heat cycle parameters. The specifically configured pre-heat cycle may be beneficial to some plastic materials (of the substrate) having a higher Tg.

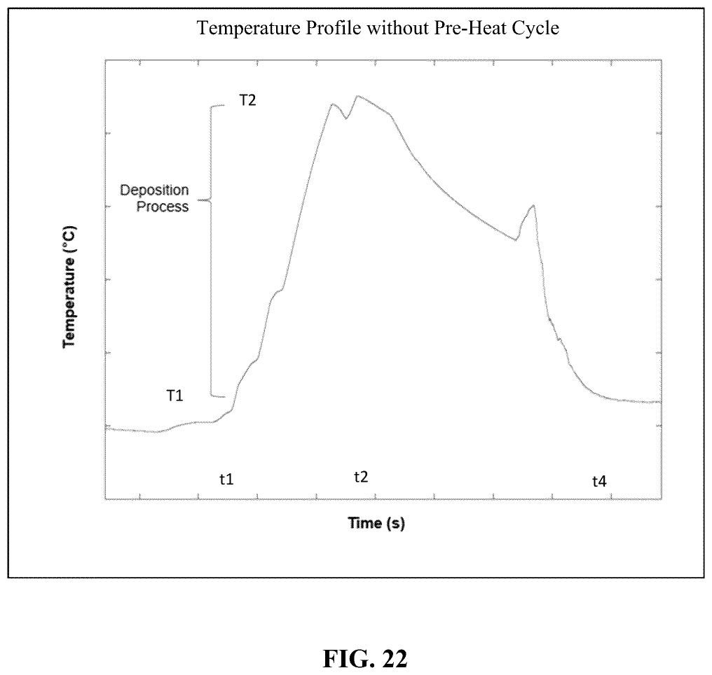

FIG. 22 shows a temperature profile without a pre-heat cycle. As shown in FIG. 22, during the deposition process, the temperature may be controlled to increase from about T1 to about T2 from time t1 to time t2, and then gradually reduce from about T2 back to about T1 from time t2 to time t4. The temperature profile may be suitable when the substrate has a lower Tg. Although there is some difference, the temperature profile for the deposition process shown in FIG. 22 (without pre-heat) may be substantially similar to the temperature profile for the deposition process shown in FIG. 21 (with pre-heat). The elimination of the pre-heat cycle allows for reducing the temperature of the overall system.

Other process variables that may affect the stress of the deposited film include the chamber pressure. Material properties can be modified optically and mechanically through the use of total chamber pressure. Another process variable is the cool down rate. Cooling rate of the substrate 1701 affects volumetric change and moisture take-up of the substrate materials. In some embodiments, the cool down rate may be controlled to be <0.5° C./min to reduce the stress in the deposited film.

Referring to FIG. 16 and FIG. 17, in some embodiments, the multilayer thin film stack 106 may be an anti-reflection coating, which may be formed by alternately depositing multiple layers of a low refractive index material (e.g., SiO₂, or MgF₂, etc.) and multiple layers of a high refractive index material (e.g., from the family of refractory oxides such as ZrO₂, TiO₂, Nb₂O₅, or Ta₂O₅, etc.) on the substrate 1701 (or on the fifth element 1605), using the physical vapor deposition process with various process variables optimized to reduce the stress in the deposited films. The deposited multilayer thin film stack 1606 can provide excellent optical performance.

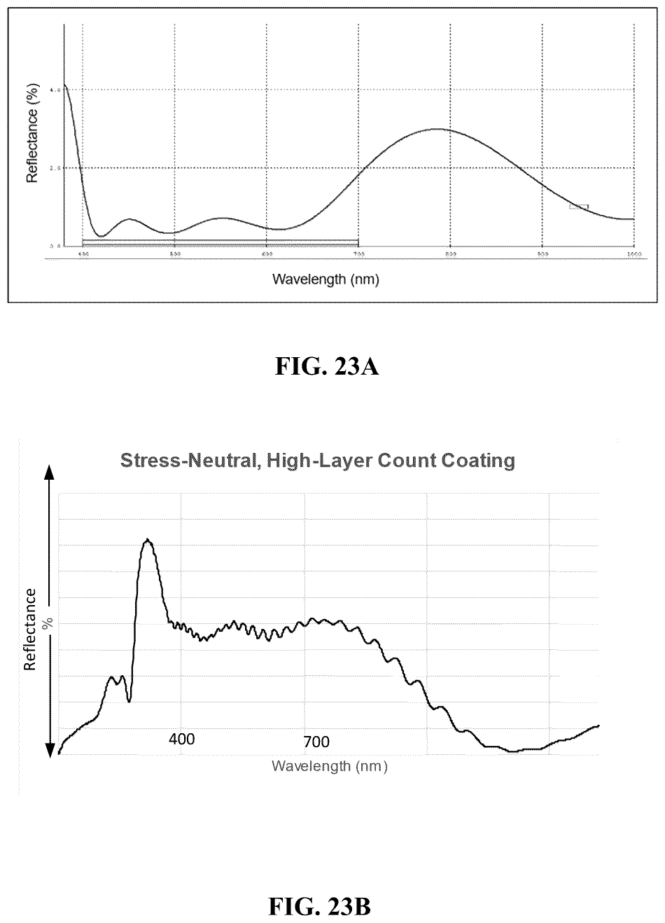

FIG. 23A illustrates a curve showing a relationship between a reflectance and a wavelength of an incident light of the multilayer thin film stack 1606 when the multilayer thin film stack 1606 is an anti-reflection coating fabricated based on the disclosed fabrication method, according to an embodiment of the present disclosure. As shown in FIG. 23A, the vertical axis is the reflectance, and the horizontal axis is the wavelength (unit: nm). As shown in FIG. 23A, the reflectance of the fabricated multilayer thin film stack 1606 is substantially low (e.g., lower than 0.5%) over a visible wavelength range from about 400 nm to about 700 nm.

In some embodiments, the multilayer thin film stack 1606 may be a beam splitting coating (or a beam splitter), which may be formed by alternately depositing multiple layers of a low refractive index material (e.g., SiO₂, or MgF₂, etc.) and multiple layers of a high refractive index material (e.g., from the family of refractory oxides such as ZrO₂, TiO₂, Nb₂O₅, or Ta₂O₅, etc.) on the substrate 1701 (or on the fifth element 1605), using the physical vapor deposition process with various process variables optimized to reduce the stress in the deposited films. The deposited multilayer thin film stack 1606 can provide excellent optical performance. FIG. 23B illustrates a curve showing a relationship between a reflectance and a wavelength of an incident light of the multilayer thin film stack 1606 when the multilayer thin film stack 1606 is a beam splitting coating (or a beam splitter) fabricated based on the disclosed method, according to an embodiment of the present disclosure. The beam splitter may split or separate an incoming light beam into two or more individual beams by reflecting or transmitting a portion of the incident light. By designing the thickness and refractive indices of the films, the multilayer thin film stack 1606 may reflect a specific percentage of the incident light, such as 50% or 70%, and transmit the remaining light. As shown in FIG. 23B, the vertical axis is the reflectance, and the horizontal axis is the wavelength (unit: nm). The reflectance of the fabricated multilayer thin film stack 1606 is substantially 50% over a visible wavelength range from about 400 nm to about 700 nm.

In some embodiments, the present disclosure provides a method for fabricating a multilayer thin film stack using physical vapor deposition. The method includes performing an optimization to identify a bias voltage and an operating point for a key process variable that are associated with a minimum stress in the multilayer thin film stack. The method also includes fabricating the multilayer thin film stack using the physical vapor deposition with the identified bias voltage and the identified operating point for the key process variable.

In some embodiments, the method further includes configuring a temperature profile to include a temperature segment for a pre-heat cycle and a temperature segment for a deposition process when a substrate on which the multilayer thin film stack is deposited has a high glass transition temperature. In some embodiments, the method further includes configuring a temperature profile to not include a pre-heat cycle when a substrate on which the multilayer thin film stack is deposited has a low glass transition temperature. In some embodiments, the method further includes controlling a cool down rate of a substrate used in the physical vapor deposition to be less than 0.5° C. per minute. In some embodiments, the key process variable is a deposition rate.

In some embodiments, the present disclosure provides an optical device. The optical device includes a substrate, a buffer layer disposed on the substrate, and an optical material layer deposited on the buffer layer. The optical device also includes a water vapor transport barrier layer deposited over the optical material layer and the buffer layer to seal the optical material layer and the buffer layer to reduce transportation of water vapor into and out of the optical material layer and the buffer layer. The optical device also includes a multilayer thin film stack including a plurality of layers formed by at least two different materials, wherein the multilayer thin film stack has a stress lower than a predetermined threshold level. The optical device further includes a hydrophobic layer disposed over the multilayer thin film stack. In some embodiments, the optical material layer includes a 3D-printed optical element, a diamond-turned optical element, an injection molded optical element, or a cast-molded optical element.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Further, when an embodiment illustrated in a drawing shows a single element, it is understood that the embodiment or another embodiment not shown in the figures but within the scope of the present disclosure may include a plurality of such elements. Likewise, when an embodiment illustrated in a drawing shows a plurality of such elements, it is understood that the embodiment or another embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
a light guide configured to guide a light to propagate inside the light guide via total internal reflection;
a reflective lens disposed at a first surface of the light guide;
a light absorption layer disposed at a second surface of the light guide that is non-parallel to the first surface; and
an out-coupling element configured to couple a first portion of the light out of the light guide as one or more output lights, a second portion of the light that is not coupled out of the light guide becoming a stray light propagating inside the light guide toward the second surface;
wherein the reflective lens is configured to reflect the stray light toward the light absorption layer, and
wherein the light absorption layer is configured to substantially absorb the stray light.

2. The device of claim 1, wherein the out-coupling element is located at a first portion of the light guide, and the reflective lens and the light absorption layer are located at a second portion of the light guide.

3. The device of claim 2, further comprising an in-coupling element located at a third portion of the light guide and configured to couple an input light into the light guide as the light propagating inside the light guide via total internal reflection, the first portion of the light guide being located between the second portion of the light guide and the third portion of the light guide.

4. The device of claim 1, wherein the reflective lens includes a diffractive lens configured to reflect and focus the second portion of the light toward the light absorption layer.

5. The device of claim 1, wherein
the stray light is a first stray light, the reflective lens is configured to reflect and focus the first stray light as a second stray light propagating toward the light absorption layer, and
a diffraction angle of the second stray light is configured to render the second stray light refracted at the second surface of the light guide toward the light absorption layer.

6. The device of claim 1, wherein the reflective lens is a first reflective lens, and the device further comprises a second reflective lens disposed at a third surface that is opposite to the first surface.

7. The device of claim 6, wherein each of the first reflective lens and the second reflective lens includes a diffractive lens.

8. The device of claim 6, wherein
the second portion of the light is a first stray light, the first reflective lens is configured to reflect and focus the first stray light as a second stray light propagating toward the light absorption layer,
the light absorption layer is configured to absorb a first portion of the second stray light, and reflect a second portion of the second stray light as a third stray light propagating toward the second reflective lens, and
the second reflective lens is configured to reflect and focus the third stray light as a fourth stray light propagation toward the light absorption layer, and
the light absorption layer is configured to absorb the fourth stray light.

9. The device of claim 1, further comprising an anti-reflection coating disposed at the second surface of the light guide, wherein
the reflective lens is configured to reflect the second portion of the light toward the anti-reflection coating,
the anti-reflection coating is configured to reduce a reflection of the second portion of the light and increase a transmission of the second portion of the light toward the light absorption layer, and
the light absorption layer is configured to substantially absorb the second portion of the light received from the anti-reflection coating.

10. The device of claim 1, wherein
the light guide has a third surface opposite to the first surface of the light guide, and
the out-coupling element is disposed at the first surface or the third surface.

11. The device of claim 1, wherein the out-coupling element is embedded inside the light guide.

12. A device, comprising:
a light guide configured to guide a light to propagate inside the light guide via total internal reflection, the light guide having a first surface and a second surface having a predetermined tilt angle with respect to the first surface;
an out-coupling element disposed at the first surface and configured to couple a first portion of the light out of the light guide as one or more output lights, wherein a second portion of the light that is not coupled out of the light guide is a stray light propagating inside the light guide toward the second surface; and
an anti-reflection coating and a light absorption layer disposed at the second surface of the light guide,
wherein the anti-reflection coating is configured to substantially transmit the stray light toward the light absorption layer, and the light absorption layer is configured to substantially absorb the stray light received from the anti-reflection coating.

13. The device of claim 12, wherein the predetermined tilt angle is configured to render the stray light refracted at the second surface of the light guide toward the anti-reflection coating.

14. The device of claim 12, wherein the out-coupling element is located at a first portion of the light guide, and the anti-reflection coating and the light absorption layer are located at a second portion of the light guide.

15. The device of claim 14, further comprising an in-coupling element located at a third portion of the light guide and configured to couple an input light into the light guide as the light propagating inside the light guide via total internal reflection, the first portion of the light guide being located between the second portion of the light guide and the third portion of the light guide.

16. The device of claim 12, wherein the light absorptive layer includes at least one of a black paint or ink, carbon black, organic dyes, or carbon nanotubes.
